(19) United States
(12) Patent Application Publication
(10) Pub. No.: US 2026/0095916 A1
(43) Pub. Date: Apr. 2, 2026

(54) UL CONTROL INFORMATION TRANSMISSION AND MULTIPLEXING

(71) Applicant: Samsung Electronics Co., Ltd., Suwon-si (KR)

(72) Inventors: Emad Nader Farag, Flanders, NJ (US); Eko Onggosanusi, Coppell, TX (US); Md. Saifur Rahman, Plano, TX (US); Dalin Zhu, Allen, TX (US)

(21) Appl. No.: 19/332,018

(22) Filed: Sep. 17, 2025

Related U.S. Application Data
(60) Provisional application No. 63/702,468, filed on Oct. 2, 2024.
(60) Provisional application No. 63/704,341, filed on Oct. 7, 2024.
(60) Provisional application No. 63/713,876, filed on Oct. 30, 2024.

(51) Int. Cl. H04W 72/21; H04L 5/00

(52) U.S. Cl. CPC H04W 72/21; H04L 5/0044

(57) ABSTRACT

In yet another embodiment, method of operating a user equipment (UE) is provided. The method includes receiving first information for a list of uplink control information (UCI) payload sizes and corresponding code points, receiving second information for a configured grant (CG) physical uplink shared channel (PUSCH), and receiving third information for two demodulation reference signal (DMRS) sequences. The CG PUSCH is based on a first DMRS sequence when there is no UCI multiplexed in the CG PUSCH and a second DMRS sequence when there is. The method further includes determining, for the CG PUSCH, first UCI for transmission and a first UCI payload size and corresponding first code point. The method further includes transmitting the CG PUSCH including a first DMRS based on the second DMRS sequence, information indicating the first code point, the first UCI, and a first transport block of an uplink shared channel (UL-SCH).

### CROSS-REFERENCE TO RELATED AND CLAIM OF PRIORITY

The present application claims priority under 35 U.S.C. § 119 (e) to U.S. Provisional Patent Application No. 63/702,468 filed on Oct. 2, 2024; U.S. Provisional Patent Application No. 63/704,341 filed on Oct. 7, 2024; and U.S. Provisional Patent Application No. 63/713,876 filed on Oct. 30, 2024, which are hereby incorporated by reference in their entirety.

### TECHNICAL FIELD

The present disclosure relates generally to wireless communication systems and, more specifically, the present disclosure relates to methods and apparatuses for uplink (UL) control information transmission and multiplexing.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to UL control information transmission and multiplexing.

In one embodiment, a user equipment (UE) is provided. The UE includes a transceiver configured to receive first information for a list of uplink control information (UCI) payload sizes and corresponding code points, receive second information for a configured grant (CG) physical uplink shared channel (PUSCH), and receive third information for two demodulation reference signal (DMRS) sequences. The CG PUSCH is based on a first DMRS sequence when there is no UCI multiplexed in the CG PUSCH and a second DMRS sequence when there is UCI multiplexed in the CG PUSCH. The UE further includes a processor operably coupled to the transceiver. The processor is configured to determine, for the CG PUSCH, first UCI for transmission and a first UCI payload size and corresponding first code point. The transceiver is further configured to transmit the CG PUSCH including a first DMRS based on the second DMRS sequence, information indicating the first code point, the first UCI, and a first transport block of an uplink shared channel (UL-SCH).

In another embodiment, a base station (BS), is provided the BS includes a transceiver configured to transmit first information for a list of UCI payload sizes and corresponding code points, transmit second information for a CG PUSCH, transmit third information for two DMRS sequences. The CG PUSCH is based on a first DMRS sequence when there is no UCI multiplexed in the CG PUSCH and a second DMRS sequence when there is UCI multiplexed in the CG PUSCH. The transceiver is further configured to receive a CG PUSCH including a first DMRS based on the second DMRS sequence, information indicating a first code point, a first UCI, and a first transport block of an UL-SCH. The BS further includes a processor operably coupled to the transceiver. The processor is configured to, for the CG PUSCH, determine a presence of the first UCI based on second DMRS sequence, determine a first UCI payload size based on first code point, and decode the first UCI based on the first UCI payload size.

In yet another embodiment, method of operating a UE is provided. The method includes receiving first information for a list of UCI payload sizes and corresponding code points, receiving second information for a CG PUSCH, and receiving third information for two DMRS sequences. The CG PUSCH is based on a first DMRS sequence when there is no UCI multiplexed in the CG PUSCH and a second DMRS sequence when there is UCI multiplexed in the CG PUSCH. The method further includes determining, for the CG PUSCH, first UCI for transmission and a first UCI payload size and corresponding first code point. The method further includes transmitting the CG PUSCH including a first DMRS based on the second DMRS sequence, information indicating the first code point, the first UCI, and a first transport block of an UL-SCH.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example base station (BS) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates example physical uplink control channel (PUCCH) resource sets according to embodiments of the present disclosure;

FIGS. 6A and 6B illustrate an example downlink (DL) medium access control (MAC) protocol data unit (PDU) and UL MAC PDU according to embodiments of the present disclosure;

FIG. 7 illustrates an example channel coding according to embodiments of the present disclosure;

FIG. 8 illustrates an example channel coding according to embodiments of the present disclosure;

FIG. 9 illustrates an example of physical uplink shared channel (PUSCH) processing according to embodiments of the present disclosure;

FIG. 10 illustrates an example multiplexing configuration according to embodiments of the present disclosure;

FIG. 11 illustrates an example multiplexing configuration according to embodiments of the present disclosure;

FIG. 12 illustrates an example of physical layer processing according to embodiments of the present disclosure;

FIG. 13 illustrates examples of transport block (TB) layers according to embodiments of the present disclosure;

FIG. 14 illustrates an example PUSCH configuration according to embodiments of the present disclosure;

FIGS. 15A, 15B, 15C, 15D, 15E, and 15F illustrate an example multiplexing configuration according to embodiments of the present disclosure;

FIG. 16 illustrates an example pre-notification (PN) and PUSCH configuration according to embodiments of the present disclosure;

FIG. 17 illustrates a flowchart of an example UE procedure for determining the UL-SCH payload size according to embodiments of the present disclosure;

FIG. 18 illustrates a flowchart of an example UE procedure for determining the UL-SCH payload size according to embodiments of the present disclosure;

FIG. 19 illustrates an example transmission and retransmissions according to embodiments of the present disclosure;

FIG. 20 illustrates an example transmission and retransmissions according to embodiments of the present disclosure;

FIG. 21 illustrates an example transmission and retransmissions according to embodiments of the present disclosure;

FIG. 22 illustrates an example transmission and retransmission(s) according to embodiments of the present disclosure;

FIG. 23 illustrates an example transmission and retransmission according to embodiments of the present disclosure;

FIG. 24 illustrates an example transmission and retransmission according to embodiments of the present disclosure;

FIG. 25 illustrates a flowchart of an example UE procedure for determining the number of code blocks (CBs)/code block groups (CBGs) according to embodiments of the present disclosure;

FIG. 26 illustrates a flowchart of an example UE procedure for determining the number of CBs/CBGs according to embodiments of the present disclosure;

FIGS. 27A and 27B illustrate an example UL resource configuration according to embodiments of the present disclosure;

FIG. 28 illustrates an example UL resource configuration according to embodiments of the present disclosure;

FIG. 29 illustrates an example available frequency resource configuration according to embodiments of the present disclosure;

FIGS. 30A and 30B illustrate an example UL transmission resource configuration according to embodiments of the present disclosure;

FIGS. 31A and 31B illustrate an example UL transmission resource configuration according to embodiments of the present disclosure;

FIGS. 32A and 32B illustrate an example UL transmission resource configuration according to embodiments of the present disclosure;

FIGS. 33A and 33B illustrate an example UL transmission resource configuration according to embodiments of the present disclosure;

FIG. 34 illustrates an example UL transmission resource configuration according to embodiments of the present disclosure;

FIG. 35 illustrates an example available time resource configuration according to embodiments of the present disclosure;

FIG. 36 illustrates an example UL transmission resource configuration according to embodiments of the present disclosure;

FIG. 37 illustrates an example UL transmission resource configuration according to embodiments of the present disclosure; and

FIG. 38 illustrates an example method performed by a UE in a wireless communication system according to embodiments of the present disclosure.

### DETAILED DESCRIPTION

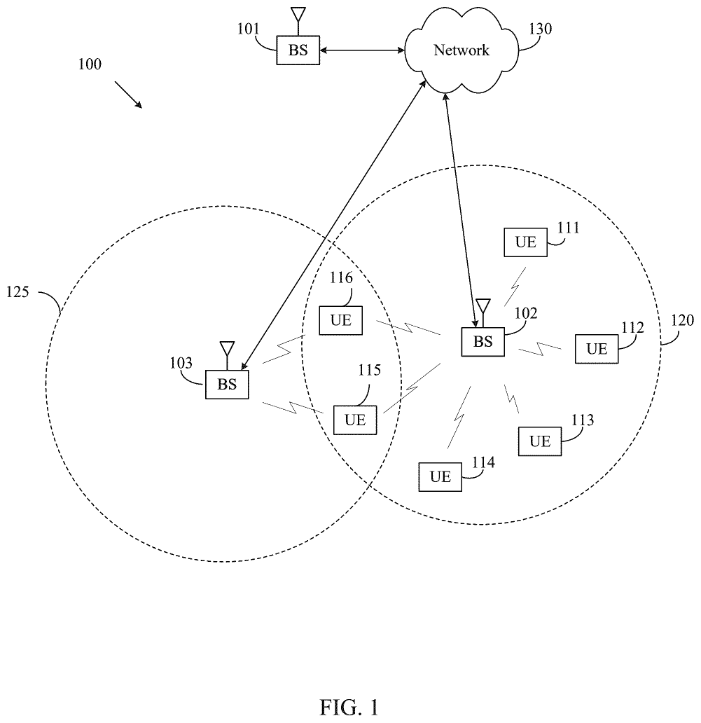

FIGS. 1-38, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF 1] 3GPP TS 38.211 v18.3.0-v18.4.0, “NR; Physical channels and modulation;” [REF 2] 3GPP TS 38.212 v18.3.0-v18.4.0, “NR; Multiplexing and Channel coding;” [REF 3] 3GPP TS 38.213 v18.3.0-v18.4.0, “NR; Physical Layer Procedures for Control;” [REF 4] 3GPP TS 38.214 v18.3.0-v18.4.0, “NR; Physical Layer Procedures for Data;” [REF 5] 3GPP TS 38.321 v18.2.0-v18.3.0, “NR; Medium Access Control (MAC) protocol specification;” and [REF 6] 3GPP TS 38.331 v18.2.0-v18.3.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a BS 101, a BS 102, and a BS 103. The BS 101 communicates with the BS 102 and the BS 103. The BS 101 also communicates with at least one network 130, such as the Internet, a proprietary Internet Protocol (IP) network, or other data network.

The BS 102 provides wireless broadband access to the network 130 for a first plurality of user equipments (UEs) within a coverage area 120 of the BS 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The BS 103 provides wireless broadband access to the network 130 for a second plurality of UEs within a coverage area 125 of the BS 103. The second plurality of UEs includes the UE 115 and the UE 116. In some embodiments, one or more of the BSs 101-103 may communicate with each other and with the UEs 111-116 using 6GR, 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a 6GR base station, a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with BSs, such as the coverage areas 120 and 125, may have other shapes, including irregular shapes, depending upon the configuration of the BSs and variations in the radio environment associated with natural and man-made obstructions.

As described in more detail below, one or more of the UEs 111-116 include circuitry, programing, or a combination thereof for performing UL control information transmission and multiplexing. In certain embodiments, one or more of the BSs 101-103 include circuitry, programing, or a combination thereof to support UL control information transmission and multiplexing.

Although FIG. 1 illustrates one example of a wireless network, various changes may be made to FIG. 1. For example, the wireless network 100 could include any number of BSs and any number of UEs in any suitable arrangement. Also, the BS 101 could communicate directly with any number of UEs and provide those UEs with wireless broadband access to the network 130. Similarly, each BS 102-103 could communicate directly with the network 130 and provide UEs with direct wireless broadband access to the network 130. Further, the BSs 101, 102, and/or 103 could provide access to other or additional external networks, such as external telephone networks or other types of data networks.

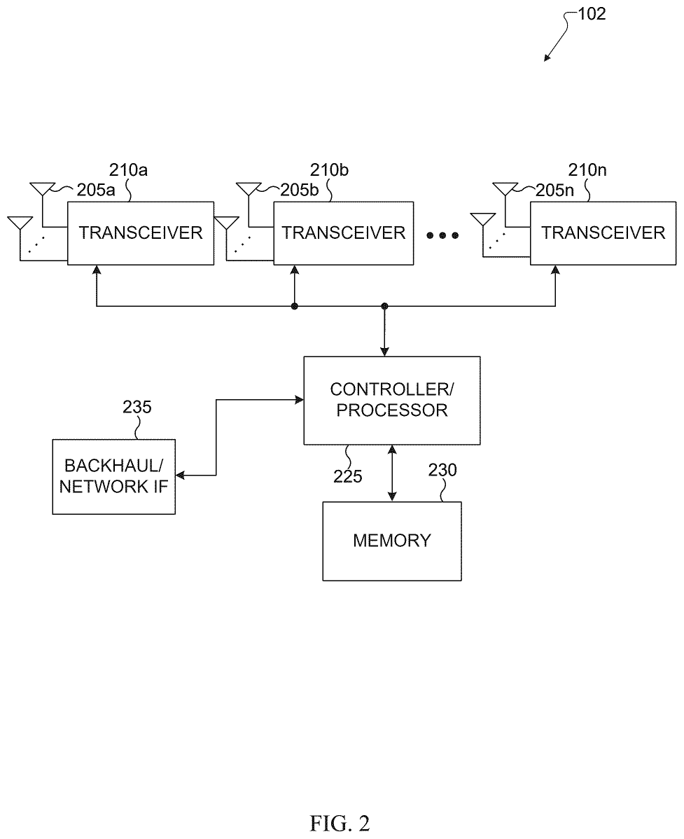

FIG. 2 illustrates an example BS 102 according to embodiments of the present disclosure. The embodiment of the BS 102 illustrated in FIG. 2 is for illustration only, and the BSs 101 and 103 of FIG. 1 could have the same or similar configuration. However, BSs come in a wide variety of configurations, and FIG. 2 does not limit the scope of this disclosure to any particular implementation of a BS.

As shown in FIG. 2, the BS 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the BS 102. For example, the controller/processor 225 could control the reception of uplink (UL) channels or signals and the transmission of downlink (DL) channels or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the BS 102 by the controller/processor 225.

The controller/processor 225 is also capable of executing programs and other processes resident in the memory 230, such as supporting UL control information transmission and multiplexing. The controller/processor 225 can move data into or out of the memory 230 as required by an executing process.

The controller/processor 225 is also coupled to the backhaul or network interface 235. The backhaul or network interface 235 allows the BS 102 to communicate with other devices or systems over a backhaul connection or over a network. The interface 235 could support communications over any suitable wired or wireless connection(s). For example, when the BS 102 is implemented as part of a cellular communication system (such as one supporting 5G/NR, LTE, or LTE-A), the interface 235 could allow the BS 102 to communicate with other BSs over a wired or wireless backhaul connection. When the BS 102 is implemented as an access point, the interface 235 could allow the BS 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of BS 102, various changes may be made to FIG. 2. For example, the BS 102 could include any number of each component shown in FIG. 2. Also, various components in FIG. 2 could be combined, further subdivided, or omitted and additional components could be added according to particular needs.

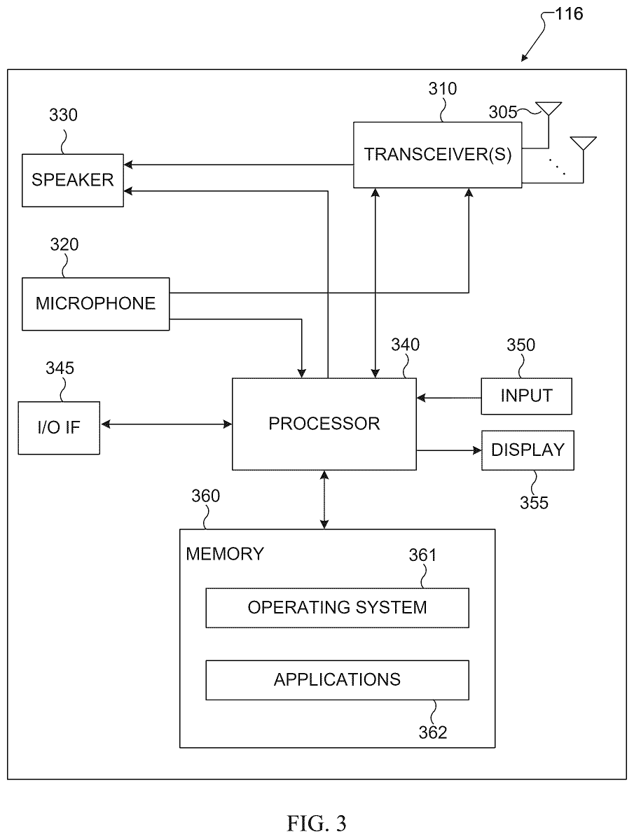

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a BS of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels or signals and the transmission of UL channels or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for UL control information transmission and multiplexing as described in embodiments of the present disclosure. The processor 340 can move data into or out of the memory 360 as required by an executing process. In some embodiments, the processor 340 is configured to execute the applications 362 based on the OS 361 or in response to signals received from BSs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

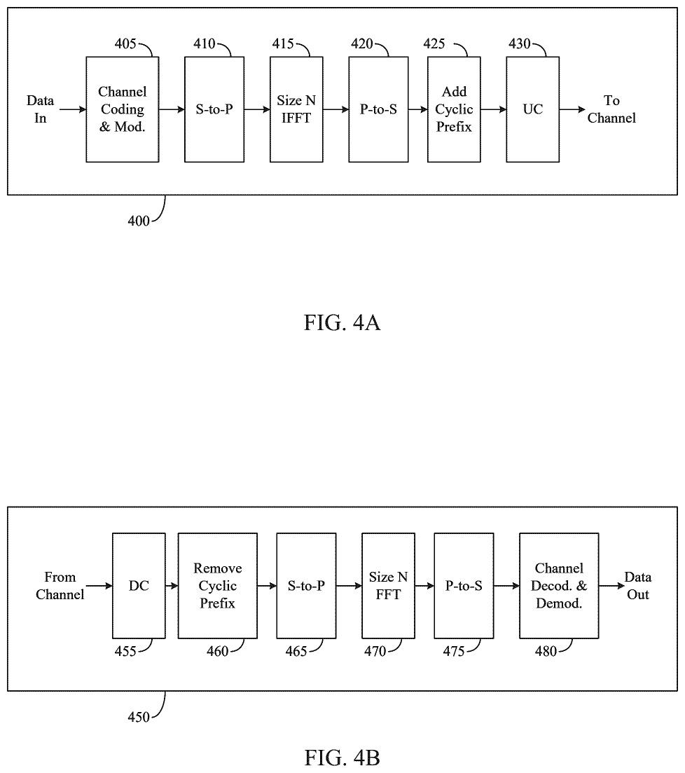

FIG. 4A and FIG. 4B illustrate an example of wireless transmit and receive paths 400 and 450, respectively, according to embodiments of the present disclosure. For example, a transmit path 400 may be described as being implemented in a BS (such as BS 102), while a receive path 450 may be described as being implemented in a UE (such as UE 116). However, it will be understood that the receive path 450 can be implemented in a BS and that the transmit path 400 can be implemented in a UE. In some embodiments, the transmit path 400 is configured for UL control information transmission and multiplexing as described in embodiments of the present disclosure. In some embodiments, the receive path 450 is configured for UL control information transmission and multiplexing as described in embodiments of the present disclosure.

As illustrated in FIG. 4A, the transmit path 400 includes a channel coding and modulation block 205, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 250 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the BS 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the BSs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to BSs 101-103 and may implement a receive path 450 for receiving in the downlink from BSs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 KHz and include 12 SCs with inter-SC spacing of 15 KHz. A slot can be either full DL slot, or full UL slot, or hybrid slot similar to a special subframe in time division duplex (TDD) systems (see also REF 1).

DL signals include data signals conveying information content, control signals conveying DL control information (DCI), and reference signals (RS) that are also known as pilot signals. A BS transmits data information or DCI through respective physical DL shared channels (PDSCHs) or physical DL control channels (PDCCHs). A PDSCH or a PDCCH can be transmitted over a variable number of slot symbols including one slot symbol. A UE can be indicated a spatial setting for a PDCCH reception based on a configuration of a value for a transmission configuration indication state (TCI state) of a control resource set (CORESET) where the UE receives the PDCCH. The UE can be indicated a spatial setting for a PDSCH reception based on a configuration by higher layers or based on an indication by a DCI format scheduling the PDSCH reception of a value for a TCI state. The BS can configure the UE to receive signals on a cell within a DL bandwidth part (BWP) of the cell DL BW.

A BS transmits one or more of multiple types of RS including channel state information RS (CSI-RS) and demodulation RS (DMRS)—see also REF 1. A CSI-RS is primarily intended for UEs to perform measurements and provide channel state information (CSI) to a BS. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used (see also REF 3). A CSI process includes NZP CSI-RS and CSI-IM resources. A UE can determine CSI-RS transmission parameters through DL control signaling or higher layer signaling, such as radio resource control (RRC) signaling from a BS (see also REF 5). Transmission instances of a CSI-RS can be indicated by DL control signaling or configured by higher layer signaling. A DMRS is transmitted only in the BW of a respective PDCCH or PDSCH and a UE can use the DMRS to demodulate data or control information.

UL signals also include data signals conveying information content, control signals conveying UL control information (UCI), DMRS associated with data or UCI demodulation, sounding RS (SRS) enabling a BS to perform UL channel measurement, and a random access (RA) preamble enabling a UE to perform random access (see also REF 1). A UE transmits data information or UCI through a respective physical UL shared channel (PUSCH) or a physical UL control channel (PUCCH). A PUSCH or a PUCCH can be transmitted over a variable number of slot symbols including one slot symbol. The BS can configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in its buffer, link recovery request (LRR) for beam failure recovery, CSI reports enabling a BS to select appropriate parameters for PDSCH or PDCCH transmissions to a UE, and UE initiated report indicator (UEI-RI) indicating a request to transmit a UE initiated measurement report. A CSI report can include a single part, or for two parts (e.g., part 1 CSI and part 2 CSI). HARQ-ACK information can be configured to be with a smaller granularity than per TB and can be per data code block (CB) or per group of data CBs where a data TB includes a number of data CBs. A CSI report from a UE can include a channel quality indicator (CQI) informing a BS of a largest modulation and coding scheme (MCS) for the UE to detect a data TB with a predetermined block error rate (BLER), such as a 10% BLER (see also REF 3), of a precoding matrix indicator (PMI) informing a BS how to combine signals from multiple transmitter antennas in accordance with a multiple input multiple output (MIMO) transmission principle, and of a rank indicator (RI) indicating a transmission rank for a PDSCH. UL RS includes DMRS and SRS. DMRS is transmitted only in a BW of a respective PUSCH or PUCCH transmission. A BS can use a DMRS to demodulate information in a respective PUSCH or PUCCH. SRS is transmitted by a UE to provide a BS with an UL CSI and, for a TDD system, an SRS transmission can also provide a PMI for DL transmission. Additionally, in order to establish synchronization or an initial higher layer connection with a BS, a UE can transmit a physical random access channel (physical random access channel (PRACH), see also REF 3 and REF 4).

The UL control information UCI, can be multiplexed on physical uplink control channel (PUCCH). There are 5 PUCCH formats, depending of the length of the PUCCH format (number of symbols of the PUCCH format), and the UCI payload size as illustrated in Table 1.

TABLE 1

| | UCI payload 1 or 2 bit | UCI payload more than 2 bits |
|---|---|---|
| PUCCH length 1 or 2 symbols | PUCCH Format 0 | PUCCH Format 2 |
| PUCCH length 4 to 14 symbols | PUCCH Format 1 | PUCCH Format 3 or 4 |

PUCCH Format 4, has 1 resource block (RB), and multiplexes 2 or 4 users on the same physical resource using different spreading codes.

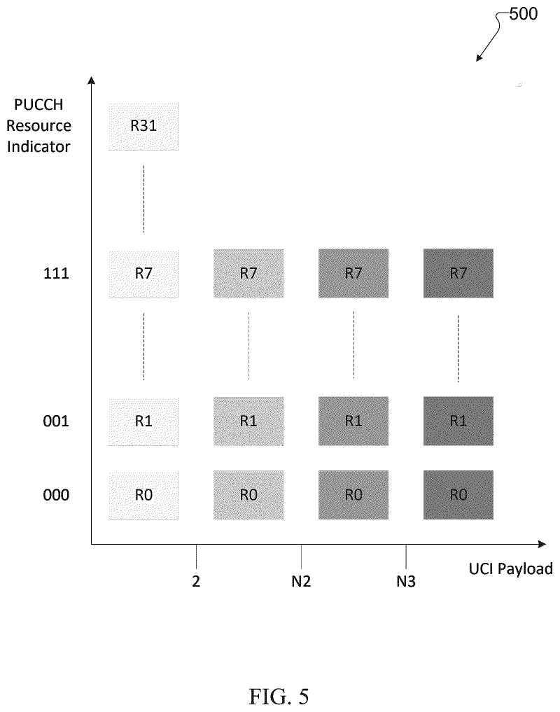

FIG. 5 illustrates example PUCCH resource sets 500 according to embodiments of the present disclosure. For example, PUCCH resource sets 500 can be utilized by any of the UEs 111-116 of FIG. 1. This example is for illustration only and other embodiments can be used without departing from the scope of the present disclosure.

The network (e.g., the network 130) can configure 4 PUCCH resource sets, where each PUCCH resource set is associated with a UCI payload size. The first PUCCH resource set is used for payload size≤2 bits and can have up to 32 PUCCH resources. The second PUCCH resource set is used for 2<payload size≤N₂. The third PUCCH resource set is used for N₂<payload size≤N₃. The fourth PUCCH resource set is used for payload size>N₃. Each of the second, third and fourth PUCCH resource sets can have 8 PUCCH resources. This is illustrated in FIG. 5. A PUCCH resource is determined by PUCCH resource index (PRI), channel control element (CCE) index (when payload size is 1 or 2 bits) and payload size.

When the CSI report is a single part, the UE (e.g., the UE 116) multiplexes, the HARQ-ACK information, the scheduling request, the UEI-RI and the CSI information into a single UCI message, this message is then encoded, rate-matched, scrambled, modulated, and mapped to the resource elements of PUCCH not used for DMRS. When the CSI report has two parts, a first part CSI and a second part CSI. The first part UCI information includes HARQ-ACK information, scheduling request and first part CSI. The second part UCI information includes second part CSI. The mapping of UCI information to PUCCH resource element is performed as follows:
First, the first part UCI information is mapped to PUCCH OFDM symbols that are closest to DMRS symbols.
Next, the second part UCI information is mapped to the remaining PUCCH resource elements.

When a PUCCH transmission overlaps with a PUSCH transmission, the UCI information is multiplexed onto the PUSCH channel:
First HARQ-ACK information is multiplexed into PUSCH starting from the first OFDM symbol after the first DMRS symbol in each frequency hop.
Next, the first part CSI is multiplexed into PUSCH starting from the first non-DMRS OFDM symbol of each frequency hop.
Next, the second part CSI is multiplexed into PUSCH after the first part CSI.
Finally, the transport block from higher layers is multiplexed into the remaining PUSCH resource elements not used for other purposes.

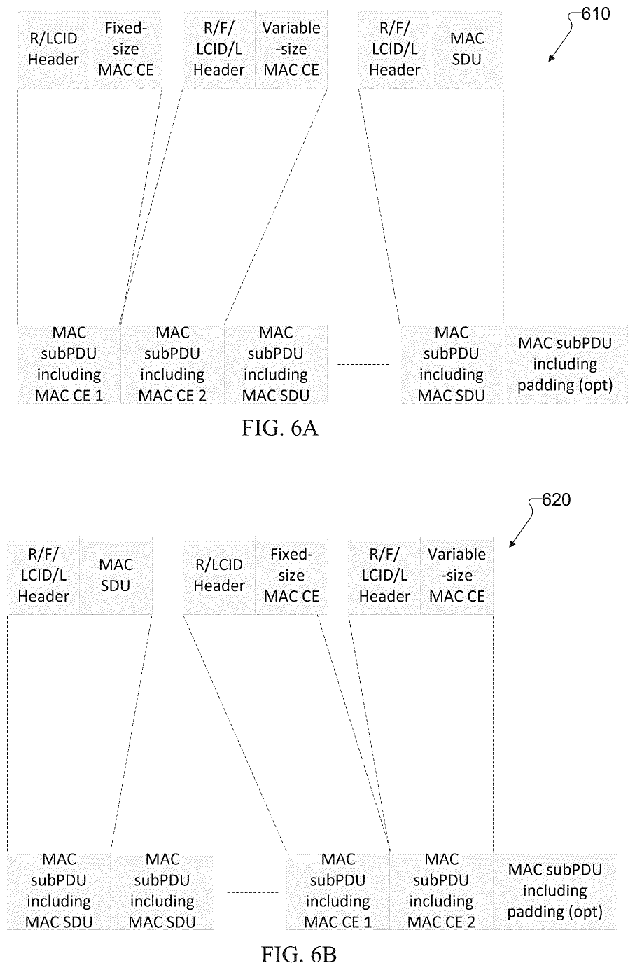

FIGS. 6A and 6B illustrate an example DL MAC PDU 610 and UL MAC PDU 620, respectively, according to embodiments of the present disclosure. For example, a DL MAC PDU 610 can be implemented in the BS 102 of FIG. 2 for transmission and the UE 116 of FIG. 3 for reception, while UL MAC PDU 620 can be implemented in the UE 116 of FIG. 3 for transmission and the BS 102 of FIG. 2 for reception. This example is for illustration only and other embodiments can be used without departing from the scope of the present disclosure.

A transport block from higher layers includes a MAC PDU, which can include one or more of
Fixed-size MAC CE(s).
Variable size MAC CE(s).
MAC SDU(s)
Optional padding.

A DL MAC PDU (e.g., transport block) is illustrated in FIG. 6A. An UL MAC PDU (e.g., transport block) L is illustrated in FIG. 6B.

In this disclosure, design aspects are provided for the multiplexing of UCI with a variable (dynamic or elastic) payload size on PUSCH, and how the UL-SCH payload and/or CBs are adjusted based on the UCI payload size.

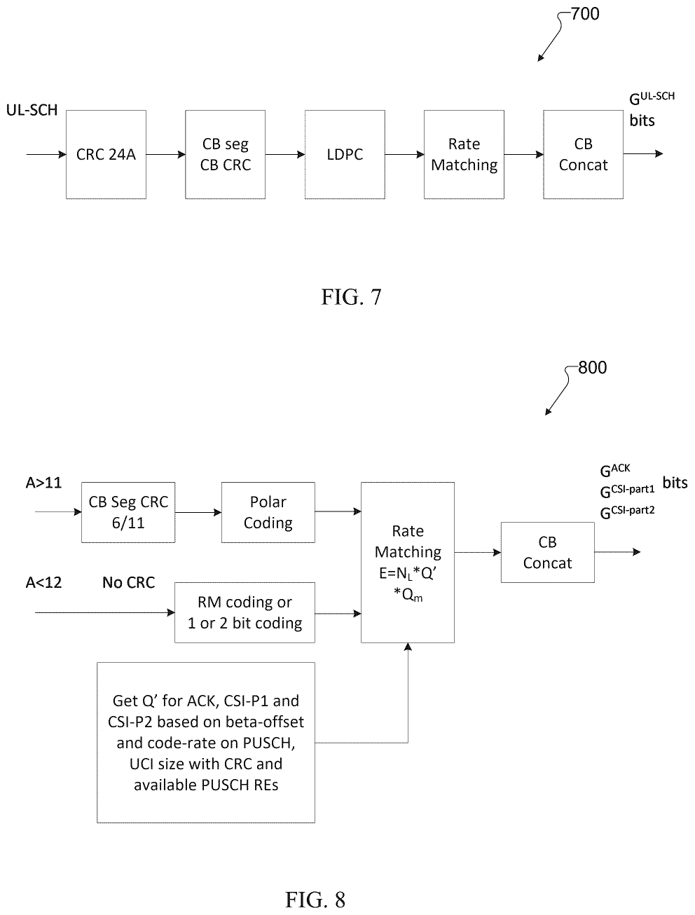

FIG. 7 illustrates an example channel coding 700 according to embodiments of the present disclosure. For example, channel coding 700 can be utilized by any of the UEs 111-116 of FIG. 1. This example is for illustration only and other embodiments can be used without departing from the scope of the present disclosure

In NR, the physical uplink shared channel (PUSCH) can be used to transmit UL shared channel (UL-SCH) and UL control information (UCI). FIG. 7 illustrates the channel coding for UL-SCH. The higher layers (e.g., MAC layer) provides up to two UL-SCH transport blocks (e.g., MAC PDUs) to the physical layer within a transmission time interval (TTI). Two transport blocks are used in case of spatial multiplexing with more than 4 layers. Each transport block is encoded and mapped to the PUSCH. A cyclic redundancy check (CRC), for error detection at the receiver, is appended to the transport block. The transport block is segmented into multiple code blocks (CBs) and each CB has its own CB CRC. The low-density parity check (LDPC) code supports a maximum block size of 8424 bits for base graph 1 and 3840 bits for base graph 2, CB segmentation allows the support of larger transport block sizes. CB-based CRC allows for code block group (CBG)-based HARQ-ACK feedback and CBG-based retransmissions, whereby only the CBGs with failed CB CRCs are retransmitted. Each CB is encoded using an error-correcting LDPC code. Rate matching adjusts the size of the encoded CB to fit within the resources allocated by the scheduler, rate matching also selects bits corresponding to different redundancy versions for hybrid-ARQ. The encoded CBs are then concatenated to provide an encoded bit stream for UL-SCH with GUL-SCH bits.

FIG. 8 illustrates an example channel coding 800 according to embodiments of the present disclosure. For example, channel coding 800 can be utilized by the UE 116 of FIG. 3. This example is for illustration only and other embodiments can be used without departing from the scope of the present disclosure.

With reference to FIG. 8, the channel coding for UCI is shown. As mentioned herein, there can be multiple streams of control information that are encoded separately. For example, the streams can be for HARQ-ACK information, channel state information (CSI)-part1 and CSI-part2. For UCI blocks larger than 11 bits, a CRC is attached to the UCI payload, the CRC can be of size 6-bits for payloads between 12 and 19 bits, and a 11-bit CRC for payloads larger than or equal to 20 bit. Large blocks can be segmented into multiple smaller blocks. The data is then encoded, the coding scheme used depends on the block size. Blocks of size 1 bit (c₀) are encoded as shown in Table 2. Blocks of size 2 bit (c₀, c₁) are encoded as shown in Table 3, where c₂=(c₀+c₁) mod 2. In Tables 2 and 3, “x” and “y” are placeholder bits used during scrambling to maximize the Euclidian distance of modulation symbols carrying UCI bits.

TABLE 2

| Qₘ | Encoded Bits |
|---|---|
| 1 | [c₀] |
| 2 | [c₀ y] |
| 4 | [c₀ y x x] |
| 6 | [c₀ y x x x x] |
| 8 | [c₀ y x x x x x x] |

TABLE 3

| Qₘ | Encoded Bits |
|---|---|
| 1 | [c₀ c₁ c₂] |
| 2 | [c₀ c₁ c₂ c₀ c₁ c₂] |
| 4 | [c₀ c₁ x x c₂ c₀ x x c₁ c₂ x x] |
| 6 | [c₀ c₁ x x x x c₂ c₀ x x x x c₁ c₂ x x x x x] |
| 8 | [c₀ c₁ x x x x x x c₂ c₀ x x x x x x c₁ c₂ x x x [symbol] |

[symbol]

indicates data missing or illegible when filed

Blocks with payload size between 3 and 11 bits are encoded using Reed-Muller with a 32-bit basis vector. Blocks larger than 11 bits use polar coding. Rate matching adjusts the size of the encoded data to fit within the allocated resources. This is then followed by CB concatenation for data that has been segmented into multiple blocks. The encoded bit streams for HARQ-ACK, CSI-part1 and CSI-part2 has size of G^{ACK}, G^{CSI-part1}, G^{CSI-part2} bits respectively.

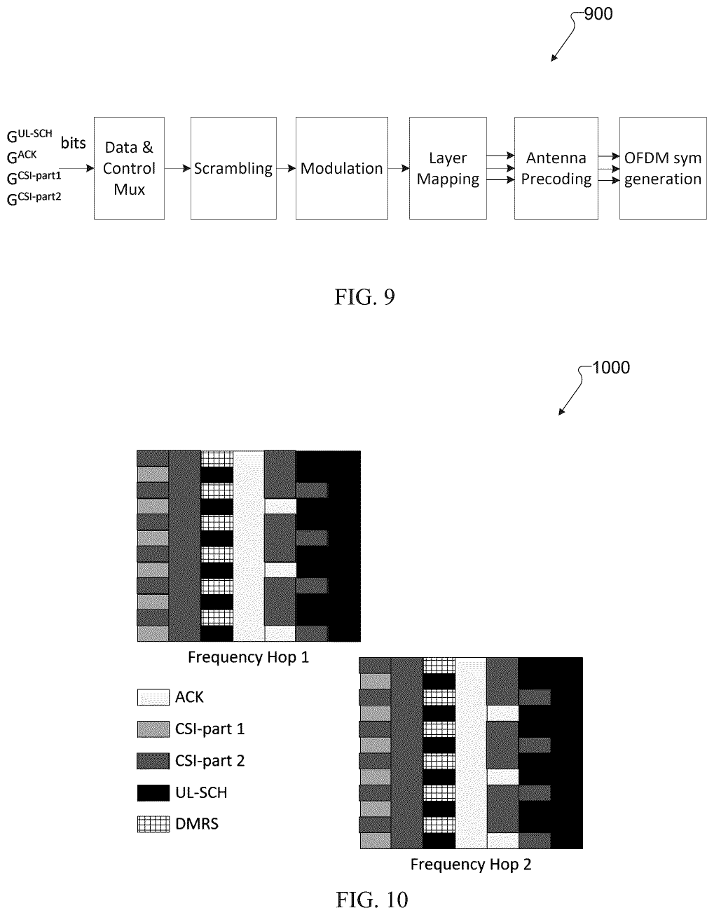

FIG. 9 illustrates an example of PUSCH processing 900 according to embodiments of the present disclosure. For example, PUSCH processing 900 can be implemented in any of the UEs 111-116 of FIG. 1, such as the UE 111. This example is for illustration only and other embodiments can be used without departing from the scope of the present disclosure

FIG. 10 illustrates an example multiplexing configuration 1000 according to embodiments of the present disclosure. For example, multiplexing configuration 1000 can be applied by any of the UEs 111-116 of FIG. 1, such as the UE 112. This example is for illustration only and other embodiments can be used without departing from the scope of the present disclosure.

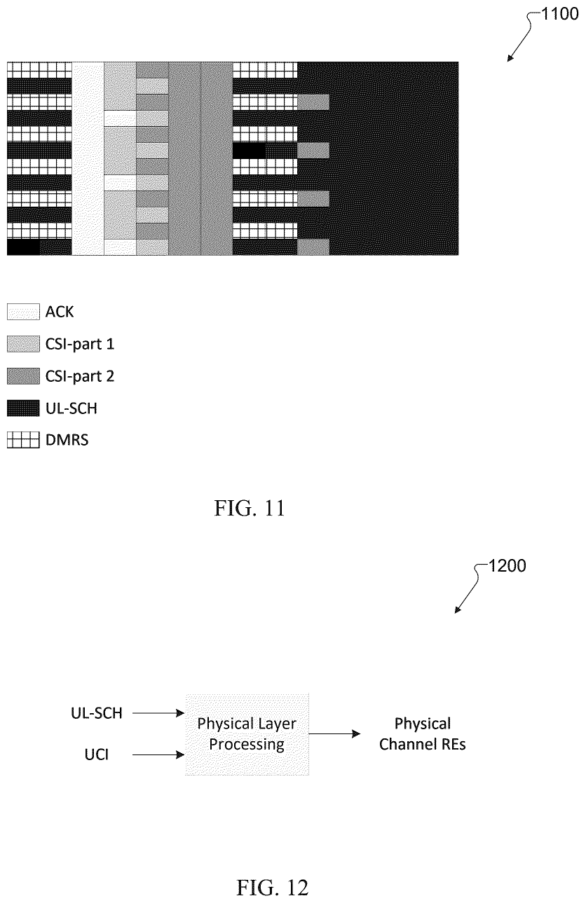

FIG. 11 illustrates an example multiplexing configuration 1100 according to embodiments of the present disclosure. For example, multiplexing configuration 1100 can be applied by any of the UEs 111-116 of FIG. 1, such as the UE 113. This example is for illustration only and other embodiments can be used without departing from the scope of the present disclosure.

When UL-SCH and UCI are transmitted on the same PUSCH, the UL-SCH and UCI encoded bit streams are multiplexed based on the following rules.
UCI is not multiplexed on DMRS symbols
A RE across layers of the same transport is either used for UL-SCH or for a UCI type.
If frequency hopping is enabled the UCI symbols are split equally (or almost equally) between the frequency hops.
   Improves performance with frequency diversity.
ACK is multiplexed starting from the first non-DMRS symbol after first block of DMRS symbols in each frequency hop
   Improves performance (ACK is close to DMRS for better channel estimation)
   Reduces latency
CSI is multiplexed starting from first non-DMRS symbols of each hop
   Reduces latency
Multiplexing order: HARQ-ACK->CSI-part 1->CSI-part 2->UL-SCH
If number of HARQ-ACK bits is 0, 1 or 2 bits reserved elements are calculated expecting 2 HARQ-ACK bits.

With reference to FIG. 9, the PUSCH processing starting with the multiplexing of UL-SCH and UCI is shown.

With reference to FIG. 10, an example of multiplexing ACK, CSI-part1, CSI-part2 and UL-SCH on a PUSCH with a non-front-end loaded DMRS, and with frequency hopping is shown.
First, ACK bits are mapped to the first non-DMRS symbol after the first block of DMRS symbols in each frequency hop. In the example of FIG. 10, the ACK REs fill the REs of the first symbol after the first block of DMRS symbols in each frequency hop, there are fewer remaining ACK REs than the REs of the second symbol after the first block of DMRS symbols in each frequency hop, the remaining ACK REs are disturbed within the second symbol after the first block of DMRS symbols in each frequency hop.
CSI-part1 is multiplexed starting from the first non-DMRS symbol of each frequency hop. In the example, of FIG. 10, CSI-part1 has fewer REs than the available REs in the first symbol of each frequency hop, the CSI-part1 REs are distributed within the first symbol of each frequency hop.
CSI-part2 is multiplexed starting from the first non-DMRS symbol of each frequency hop, using REs that have not been used by ACK, or CSI-part1, and not using symbols with DMRS.
The remaining REs are then used for UL-SCH.

With reference to FIG. 11, another example is shown of multiplexing ACK, CSI-part1, CSI-part2 and UL-SCH on a PUSCH with a front-end loaded DMRS, and without frequency hopping.

In NR, the size of the UCI payload can vary depending on the rank of the channel (number of layers spatially multiplexed on to the same resources. As an example Table 4 illustrates the dependence of wideband PMI on overhead for Rel-15 Type-1 single-panel (SP) WB when (N₁, N₂)=(4,4), and Rel-19 eType SP WB when (N₁, N₂)=(4,4). The WB CQI is 4 bits, the WB RI is 2 or 3 bits, hence for Rel-19 the maximum WB report size for RI/PMI/CQI is 4+3+36=43, and the minimum WB report size for RI/PMI/CQI is 4+3+12=19. The maximum number of CSI reports is 48 (e.g., based on IE maxNrofCSI-ReportConfigurations). The maximum CSI payload size is 48×43=2064 bits. While the minimum CSI payload size is 48×19=912 bits. This variability in payload size is just for WB reporting, based RI, SB reporting can further increase the UCI payload size and lead to variability.

TABLE 4
Wideband PMI Overhead

| | | RI = 1 | RI = 2 | RI = 3 | RI = 4 | RI = 5 | RI = 6 | RI = 7 | RI = 8 |
|---|---|---|---|---|---|---|---|---|---|
| Rel-15 Type-I SP WB | Mode 1 | 10 | 11 | 10 | 10 | 9 | 9 | 9 | 9 |
| with (N₁, N₂) = (4, 4) | Mode 2 | 10 | 11 | 10 | 10 | 9 | 9 | 9 | 9 |
| Rel-19 eType-I SP WB | Mode A | 12 | 13 | 13 | 13 | 28 | 28 | 36 | 36 |
| with (N₁, N₂) = (8, 8) | Mode B | 12 | 20 | 28 | 28 | 26 | 26 | 32 | 32 |

Embodiments of the present disclosure recognize that, as the UCI payload changes, the number of REs used for UCI in the PUSCH channel increases, leaving less REs for UL-SCH, which in turn increases the code rate of the UL-SCH. In this disclosure, how to multiplex UCI with a variable payload with UL-SCH channel in PUSCH is provided.

The present disclosure relates to a 5G/NR and/or 6G communication system.

This disclosure provides aspects related to mapping and multiplexing of UL control information (UCI) onto UL physical channels, wherein the payload of the UCI can vary depending on channel conditions, or other conditions that can change dynamically. The following aspects are provided:
Indication in the PUSCH channel whether or not UCI is multiplexed in the PUSCH channel.
Inclusion of information in the PUSCH channel that provides information about the UCI payload (e.g., size), and UL-SCH payload or code blocks (CBs).
Inclusion of information in UCI to indicate type of information being carried by UCI.
Adjusting the number of CBs or CBGs based on the UCI payload size.

In the following, both frequency division duplexing (FDD) and TDD are regarded as a duplex method for DL and UL signaling. In addition, full duplex (XDD) operation is feasible, e.g., sub-band full duplex (SBFD) or single frequency full duplex (SFFD).

Although exemplary descriptions and embodiments to follow expect orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure provides several components that can be used in conjunction or in combination with one another, or can operate as standalone schemes.

In this disclosure, RRC signaling (e.g., configuration by RRC signaling) includes (1) common information provided by common signaling, e.g., this can be system information block (SIB)-based RRC signaling (e.g., SIBI or other SIB) or (2) RRC dedicated signaling that is sent to a specific UE wherein the information can be common/cell-specific information or dedicated/UE-specific information or (3) UE-group RRC signaling.

In this disclosure MAC CE signaling can be UE-specific e.g., to one UE and can be UE common (e.g., to a group of UEs or UEs in a cell). MAC CE signaling can be DL MAC CE signaling or UL MAC CE signaling.

In this disclosure L1 control signaling includes: (1) DL control information (e.g., DCI on PDCCH or DL control information on PDSCH) and/or (2) UL control information (e.g., UCI on PUCCH or PUSCH). L1 control signaling be UE-specific e.g., to one UE and can be UE common (e.g., to a group of UEs or to all UEs in a cell).

In this disclosure, configuration can refer to configuration by semi-static signaling (e.g., RRC or SIB signaling). In one example, a configuration can be applicable to multiple transmission instances, until a new configuration is received and applied.

In this disclosure, indication can refer to indication by dynamic signaling (e.g., L1 control (e.g., DCI Format in DL or uplink control information (UCI) in UL) or MAC CE signaling). In one example, an indication can be for an associated occasion(s) (e.g., an occasion or multiple occasions associated with the indication).

In this disclosure a list with N elements or entries can be denoted as L (i), where i can take N values, and L (i) can correspond to the element or entry associated with index i. In one example, i can take N arbitrary values. In one example, i=0, 1, . . . , N−1. In one example, i=1, 2, . . . , N. In one example, i is an identity of an element or entry in the list.

In the present disclosure, the term “activation” describes an operation wherein a UE receives and decodes first information provided by a first signal from the network (or BS) and, based on the first information, the UE determines a starting point in time. The starting point can be a present or a future slot/subframe or symbol and the exact location is either implicitly or explicitly indicated, or is otherwise defined in the system operation or is configured by higher layers. Upon successfully decoding the first information, the UE responds according to an indication provided by the first information. The term “deactivation” describes an operation wherein a UE receives and decodes second information provided by a second signal from the network (or BS) and, based on the second information from the signal, the UE determines a stopping point in time. The stopping point can be a present or a future slot/subframe or symbol and the exact location is either implicitly or explicitly indicated, or is otherwise defined in the system operation or is configured by higher layers. Upon successfully decoding the second information, the UE responds according to an indication provided by the second information. The first signal can be same as the second signal or the first information can be same as the second information, wherein a first part of the information can be associated with an “activation” operation and with first UEs or with first parameters for transmissions/receptions by a UE, and a second part of the information can be associated with a “deactivation” operation and with second UEs or with second parameters for transmissions/receptions by the UE. For example, the second information can be absent, and deactivation can be implicitly derived. For example, when a UE has received an activation information in a previous indication, and is not included among UEs with activation information in a next indication, the UE can determine the latter indication as an implicit deactivation indication.

In this disclosure, a time unit, for example, can be a symbol or a slot or sub-frame or a frame. In one example, a time-unit can be multiple symbols, or multiple slots or multiple sub-frames or multiple frames. In one example, a time-unit can be a sub-slot (e.g., part of a slot). In one example, a time-unit can be specified in units of time, e.g., microseconds, or milliseconds or seconds, etc.

In this disclosure, a frequency-unit, for example, can be a sub-carrier or a resource block (RB) or a sub-channel, wherein a sub-channel is a group or RBs, or a bandwidth part (BWP). In one example, a frequency-unit can be multiple sub-carriers, or multiple RBs or multiple sub-channels. In one example, a frequency-unit can be a sub-RB (e.g., part of a RB). A frequency-unit can be specified in units of frequency, e.g., Hz, or kHz or MHz, etc.

Terminology such as UCI, MAC CE, PUCCH, PUSCH, transport block and other terms are used for illustrative purposes and is therefore not normative. Other terms that refer to same functions can also be used.

In this disclosure, UL control information can include the following UL control information types:
HARQ-ACK for DL transport blocks.
Scheduling request (SR).
Channel state information (CSI). In one example, CSI can be a single part CSI. In another example, CSI can be a two-part CSI, e.g., a first part CSI and a second part CSI.
Link recovery request (LRR), this can be similar to SR.
UE initiated beam indication/report (introduced in 3GPP Rel-19).
Transport format indication information, e.g., indicating modulation coding scheme, and/or transport block size and/or resource allocation and/or HARQ related parameters and/or MIMO related parameters of data conveyed in the UL physical channel.

In one example, the information corresponding to each of the UL control information types mentioned herein can be transmitted independently, e.g., the information for each UL control information type is separately encoded and multiplexed or mapped onto the physical UL channel e.g., PUSCH.

In another example, information corresponding to each of the UL control information types mentioned herein can be first multiplexed, and then jointly encoded, rate-matched, scrambled and/or modulated and mapped to resource elements of the corresponding physical UL channel. For example, in NR, when CSI has one part, the HARQ-ACK, SR and CSI information are multiplexed, and jointly pass through the encoding and transmission stages and are transmitted on PUCCH.

In another example, the UL control information (UCI) types are divided into groups, where information corresponding to each group of UL control information types can be first multiplexed, and then jointly encoded, rate-matched, scrambled and/or modulated and mapped to resource elements of the corresponding physical UL channel. For example, in NR, when CSI has two parts, the HARQ-ACK, SR and CSI information are multiplexed to give first part of UCI, and jointly pass through the encoding and transmission stages and are transmitted on PUCCH. The second part CSI can be separately encoded and mapped to the remaining PUCCH resources. UL control information types that are multiplexed together and jointly encoded and transmitted can have similar transport characteristics.

FIG. 12 illustrates an example of physical layer processing 1200 according to embodiments of the present disclosure. For example, physical layer processing 1200 can be utilized by any of the UEs 111-116 of FIG. 1, such as the UE 114. This example is for illustration only and other embodiments can be used without departing from the scope of the present disclosure.

UCI is transmitted in an uplink physical channel (e.g., physical uplink shared channel (PUSCH) or physical uplink control channel (PUCCH)). In this disclosure without loss of generality and for brevity, the physical channel used for UCI is referred to as PUSCH. In one example, UCI is transmitted by itself in PUSCH. In another example UCI is transmitted with uplink shared channel (UL-SCH) in PUSCH.

In one example, a PUSCH can be scheduled or allocated dynamically, e.g., PUSCH is scheduled by a DCI Format (e.g., UL related DCI Format, e.g., DCI Format 0_0 or DCI Format 0_1 or DCI Format 0_2, . . . ). Wherein, the UL related DCI Format can indicate, (1) the time and frequency resources of PUSCH, (2) the modulation coding scheme (MCS) of the PUSCH, which determines the modulation order and the code rate of the transmission and can determine the transport block size based on the amount of time and frequency resources, (3) HARQ related information such as HARQ process number, redundancy version (RV), and new data indicator, the DCI Format can also indicate, the rank of the PUSCH transmission, and precoding related information including SRS related information.

In one example, the PUSCH can be allocated semi-statically, e.g., by higher layer (for example RRC) signaling. Wherein, the RRC configuration can indicate, (1) the time and frequency resources of PUSCH including periodicity/offset of PUSCH occasions, (2) the modulation coding scheme (MCS) of the PUSCH, which determines the modulation order and the code rate of the transmission and can determine the transport block size based on the amount of time and frequency resources, (3) rank and precoding related information including SRS related information.

In one example, the semi-static PUSCH can be PUSCH configured grant Type 1 (CG Type1), wherein the PUSCH becomes active when configured.

In one example, the semi-static PUSCH can be PUSCH configured grant Type 2 (CG Type2), wherein RRC signaling configures the PUSCH, additional dynamic signaling (e.g., L1 control (DCI Format), or MAC CE signaling) can further activate or deactivate the configured PUSCH occasions to use or not to use respectively.

In one example, the following information is presented to physical layer for encoding, modulation and transmission as illustrated in FIG. 12:
UL control information (UCI), wherein UCI can be according to the types mentioned herein. In one example, each UCI type has a bit stream. In one example, a UCI type can have multiple bit streams, for example for CSI, there can be CSI-part1 and CSI-part2. In one example, there are multiple bit streams, and a bit stream can include one or more UCI types, for example, a first bit stream for HARQ-ACK and CSI-part1, and a second bit stream for CSI-part2. In one example, there is one-bit stream for UCI multiplexed on PUSCH, e.g., UCI information (e.g., HARQ-ACK and/or CSI) is multiplexed into one-bit stream. In one example, the size of the UCI payload for each type can vary for example, depending on the channel conditions.
UL shared channel (UL-SCH). In one example, UL-SCH is one transport block (e.g., when the number of spatial layers is 1 to 4). In one example, UL-SCH is two transport blocks (e.g., when the number of spatial layers is 5 to 8).

In the following examples of this disclosure, UCI can refer to UCI information presented to the physical layer for transmission, or UCI can refer to certain UCI type(s), e.g., UCI can refer to CSI information.

In the following examples, the amount of UCI information to transmit can be determined by the UE (e.g., the UE 116) and can vary from one PUSCH transmission to the next. In one example, the determination can be based on channel conditions, for example, the rank of the channel changes the UCI payload as mentioned herein. In one example, the transmission of UCI is UE initiated, the UE can autonomously determine when to transmit UCI based on a condition.

In one example, the UE can indicate in the PUSCH transmission that UCI is being multiplexed on PUSCH. In one example, the indication can be by PUSCH DMRS. In one example, a first PUSCH DMRS sequence is used when no UCI is multiplexed on PUSCH, and a second DMRS sequence is used when UCI is multiplexed on PUSCH. In one example, the BS (e.g., the BS 102) receiver determines if the UE transmitted the first DMRS sequence or the second DMRS, for example, by correlating the received signal with each DMRS sequence, and determines whether or not there is UCI in the PUSCH transmission.

In one example, PUSCH has two transport blocks, the UCI can be multiplexed in the layers of the first transport block or in the layers of the second transport block, or PUSCH is transmitted with no UCI. In one example, a first PUSCH DMRS sequence is used when no UCI is multiplexed on PUSCH, a second DMRS sequence is used when UCI is multiplexed on PUSCH layers corresponding to the first transport block, and a third DMRS sequence is used when UCI is multiplexed on PUSCH layers corresponding to the second transport block. In one example, the BS receiver determines if the UE transmitted the first DMRS sequence or the second DMRS or the third DMRS, for example, by correlating the received signal with each DMRS sequence, and determines whether or not there is UCI in the PUSCH transmission, and if there is UCI, which layers the UCI is multiplexed on (e.g., corresponding to a transport block).

In one example, PUSCH has two transport blocks, the UCI can be multiplexed in the layers of the first transport block or in the layers of the second transport block, or in both the first and the second transport blocks or PUSCH is transmitted with no UCI. In one example, a first PUSCH DMRS sequence is used when no UCI is multiplexed on PUSCH, a second DMRS sequence is used when UCI is multiplexed on PUSCH layers corresponding to the first transport block, a third DMRS sequence is used when UCI is multiplexed on PUSCH layers corresponding to the second transport block, and a fourth DMRS sequence is used when UCI is multiplexed on PUSCH layers corresponding to the first and the second transport blocks. In one example, the BS receiver determines if the UE transmitted the first DMRS sequence or the second DMRS or the third DMRS or the fourth DMRS sequence, for example, by correlating the received signal with each DMRS sequence, and determines whether or not there is UCI in the PUSCH transmission, and if there is UCI, which layers the UCI is multiplexed on (e.g., corresponding to a transport block(s)).

In one example, PUSCH has two transport blocks, the UCI can be multiplexed in the layers of the first transport block or in the layers of the second transport block or in the first and the second transport blocks, or PUSCH is transmitted with no UCI. In one example, a first PUSCH DMRS sequence is used when no UCI is multiplexed on PUSCH, a second DMRS sequence is used when UCI is multiplexed on PUSCH layers corresponding to a transport block:
In one example, if the UCI is multiplexed on the layers corresponding to the first transport block, but not the layers corresponding to the second transport block, the first DMRS sequence is used for the DMRS corresponding to the layers of the second transport block and the second DMRS sequence is used for the DMRS corresponding to the layers of the first transport block.
In one example, if the UCI is multiplexed on the layers corresponding to the second transport block, but not the layers corresponding to the first transport block, the first DMRS sequence is used for the DMRS corresponding to the layers of the first transport block and the second DMRS sequence is used for the DMRS corresponding to the layers of the second transport block.
In one example, if the UCI is multiplexed on the layers corresponding to the first transport block and the second transport block (if supported), the second DMRS sequence is used for the DMRS corresponding to the layers of the first transport block and the layers of the second transport block.

In one example, the BS receiver determines if the UE transmitted the first DMRS sequence or the second DMRS on the layers corresponding to each transport block, for example, by correlating the received signal with each DMRS sequence of the layers corresponding to a transport block, and determines whether or not there is UCI in the PUSCH transmission of the corresponding transport block.

In one example, when UL-SCH, transmitted on PUSCH, has N (e.g., two) transport blocks UCI is multiplexed on the layers corresponding to one of the N (e.g., two) transport blocks.

In one example, when UL-SCH, transmitted on PUSCH, has N (e.g., two) transport blocks UCI is multiplexed on the layers corresponding to the layers of N (e.g., two) transport blocks.

In one example, when UL-SCH, transmitted on PUSCH, has N (e.g., two) transport blocks UCI is multiplexed on the layers corresponding to M of the N (e.g., two) transport blocks, where M can be 1, 2, . . . . N. In one example, the UE can determine M (e.g., based on a condition such as the amount of UCI and/or UL-SCH data to be transmitted, channel conditions, priority of traffic, etc.). In one example, M is configured by the network, e.g., by RRC and/or MAC CE and L1 control (e.g., DCI Format) signaling, for example M can be indicated in the DCI scheduling the PUSCH (e.g., UL related DCI Format) for dynamic PUSCH and/or semi-static PUSCH activated by network (e.g., CG Type2), in another example M can be configured by network (e.g., the network 130) for semi-static PUSCH (e.g., CG Type1 or CG Type2). In one example a range of M is configured by the network, by RRC and/or MAC CE and L1 control (e.g., DCI Format) signaling, and the UE selects a value for M to use within the configured range (e.g., based on a condition as mentioned herein), for example, the range can be not to exceed a value Mₘₐₓ, or between a value Mₘᵢₙ and Mₘₐₓ.

In one the examples mentioned herein, a DMRS sequence can be substituted by DMRS REs. For example, a first set of DMRS REs is used if UCI is not multiplex on PUSCH or is not multiplex on the layers corresponding to a PUSCH transport block, and a second/third/fourth set of REs is used if UCI is multiplexed on PUSCH or on the layers corresponding to a PUSCH transport block.

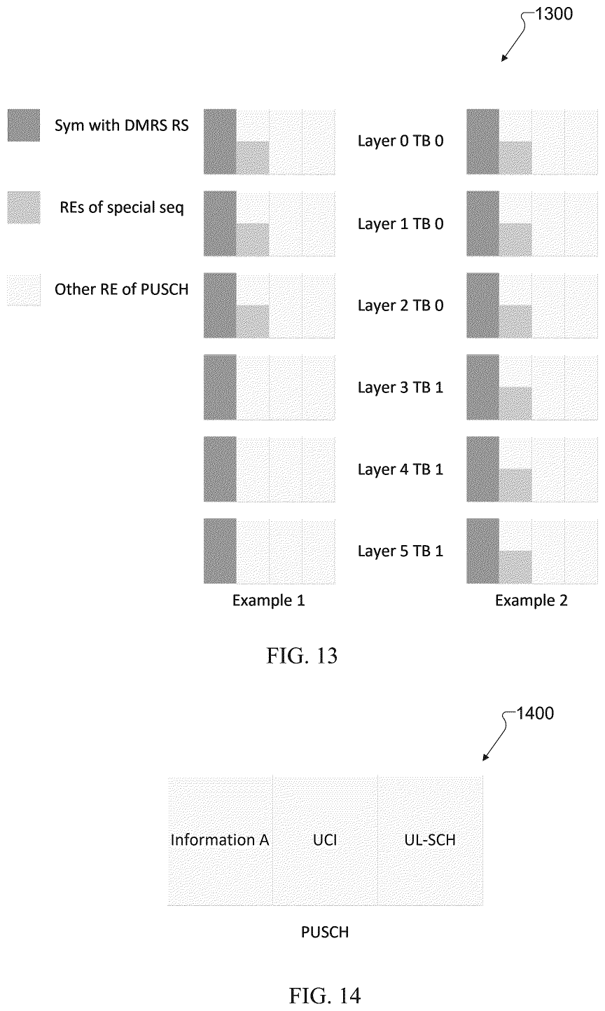

FIG. 13 illustrates examples of TB layers 1300 according to embodiments of the present disclosure. For example, TB layers 1300 can be transmitted by any of the UEs 111-116 of FIG. 1, such as the UE 115. This example is for illustration only and other embodiments can be used without departing from the scope of the present disclosure.

In one example, the indication of multiplexing UCI on PUSCH can be by a special sequence or a special channel or signal multiplexed on PUSCH. In one example, the sequence and/or channel and/or signal can be multiplexed on pre-determined REs in one or more layers of the PUSCH. In one example, the pre-determined REs can be defined in the specifications for a PUSCH allocation. In one example, the pre-determined REs can be configured and/or updated by RRC and/or MAC CE and/or L1 control (e.g., DCI Format) signaling.
In one example, the layers of the REs with the special sequence and/or channel and/or signal, can be configured or indicated by the network, e.g., by RRC and/or MAC CE and/or L1 control (e.g., DCI Format) signaling, or pre-defined based on a rule in the specifications for a PUSCH allocation. In one example, the configuration/indication/rule can be the first symbol or M symbols of the PUSCH allocation. In one example, the configuration/indication/rule can be the first non-DMRS symbol or M non-DMRS symbols of the PUSCH allocation. In one example, the configuration/indication/rule can be on the first or last N physical resource blocks (PRBs) of the PUSCH allocation and on specific symbols as mentioned herein. In one example, the configuration/indication/rule can be distributed (e.g., uniformly) on N PRBs of the PUSCH allocation and on specific symbols as mentioned herein. In one example, with frequency hopping enabled, the configuration/indication/rule can be the first symbol or M symbols of the PUSCH allocation in each hop. In one example, with frequency hopping enabled, the configuration/indication/rule can be the first non-DMRS symbol or M non-DMRS symbols of the PUSCH allocation in each hop.
In one example, the layers of the REs with the special sequence and/or channel and/or signal can be determined by the UE based on a condition.
In one example, layers of the REs with the special sequence and/or channel and/or signal corresponding to a transport block are used or not used for the special sequence and/or channel and/or signal. This is illustrated by way of example in FIG. 13 Example 1, where the layers corresponding to the transport block (TB) 0 are used to carry the special sequence and/or channel and/or signal, and the layers corresponding to TB1 are not used to carry the special sequence and/or channel and/or signal.
In one example, layers of the REs with the special sequence and/or channel and/or signal corresponding to transport blocks are used or not used for the special sequence and/or channel and/or signal. This is illustrated by way of example in FIG. 13 Example 2, where the layers of PUSCH are used to carry the special sequence and/or channel and/or signal.

In the example of FIG. 13, a PUSCH has 6 layers, layers 0 to 2 are used for TB0 and layers 3 to 5 are used for TB1. In Example 1 of FIG. 13, the layers of TB0 are used for the special sequence and/or channel and/or signal to indicate the presence of UCI, in one example, UCI can be present on the same layers as the special sequence and/or channel and/or signal, in another example the special sequence and/or channel and/or signal can indicate the layers UCI is present on, in yet another example the special sequence and/or channel and/or signal can indicate the presence of UCI on layers of PUSCH.

In Example 2 of FIG. 13, layers of PUSCH are used for the special sequence and/or channel and/or signal to indicate the presence of UCI, in one example, UCI can be present on the same layers as the special sequence and/or channel and/or signal, in another example the special sequence and/or channel and/or signal can indicate the layers UCI is present on, in yet another example the special sequence and/or channel and/or signal can indicate the presence of UCI on layers of PUSCH.

In one example, the special sequence or channel or signal in the REs can indicate:
No UCI multiplexed on PUSCH.
No UCI multiplexed on corresponding layer(s) of PUSCH (e.g., the layer(s) of the special sequence or channel or signal).
No UCI multiplexed on layers of a transport block.
UCI multiplexed on PUSCH.
UCI multiplexed on corresponding layer(s) of PUSCH (e.g., the layer(s) of the special sequence or channel or signal).
UCI multiplexed on layers of a transport block.
The special sequence or channel or signal in the REs can indicate the layer(s) or the layers corresponding to transport block(s) on which UCI is multiplexed.

In one example, a first sequence or a first signal can indicate no UCI is multiplexed on PUSCH. In one example, a second sequence or a second signal can indicate UCI is multiplexed on PUSCH (e.g., in each of the layers). In one example, a third sequence or a third signal can indicate UCI is multiplexed on PUSCH layers corresponding to a first transport block. In one example, a fourth sequence or a fourth signal can indicate UCI is multiplexed on PUSCH layers corresponding to a second transport block, . . . . In one example, the content of the channel can indicate whether UCI is multiplexed on PUSCH or not and, if multiplexed, the layers on which UCI is multiplexed.

In the examples of FIG. 13, the REs/RBs of the special sequence or channel or signal are shown to be contiguous, this is for illustration only. In a variant example, REs/RBs of the special sequence or channel or signal can be distributed in frequency (e.g., distributed uniformly in one or more symbols) to provide better frequency diversity. In a variant example, if frequency hopping is enable e.g., with K (e.g., K=2) hops, the REs/RBs of the special sequence or channel or signal can be present in the symbols of the K hops to provide better frequency diversity. In a variant example, the REs/RBs of the special sequence or channel or signal are located in the first M symbols (or M non-DMRS symbols) of the PUSCH, e.g., to allow for efficient pipeline processing at the receiver. In one example, M=1. In one example, M=2. In one example, M can be defined in the system specifications. In one example, M can be configured or updated by RRC and/or MAC CE and/or L1 control (e.g., DCI Format) signaling. In a variant example, the REs/RBs of the special sequence or channel or signal are located in the first M symbols (or M non-DMRS symbols) of each hop of PUSCH, e.g., to allow for efficient pipeline processing at the receiver. In one example, M=1. In one example, M=2. In one example, M can be defined in the system specifications. In one example, M can be configured or updated by RRC and/or MAC CE and/or L1 control (e.g., DCI Format) signaling.

In one example, a (pre-notification) signal/channel is sent before the PUSCH channel, the pre-notification signal/channel includes the special sequence or signal or channel. Wherein, the (pre-notification) signal/channel indicates the presence or absence of UCI in the PUSCH. If UCI is present in the PUSCH, the (pre-notification) signal/channel can indicate the layer(s) and/or transport block(s) on which the UCI is multiplexed. The examples mentioned herein for the special sequence or signal or channel apply to this case.

FIG. 14 illustrates an example PUSCH configuration 1400 according to embodiments of the present disclosure. For example, PUSCH configuration 1400 can be utilized by any of the UEs 111-116 of FIG. 1, such as the UE 116. This example is for illustration only and other embodiments can be used without departing from the scope of the present disclosure.

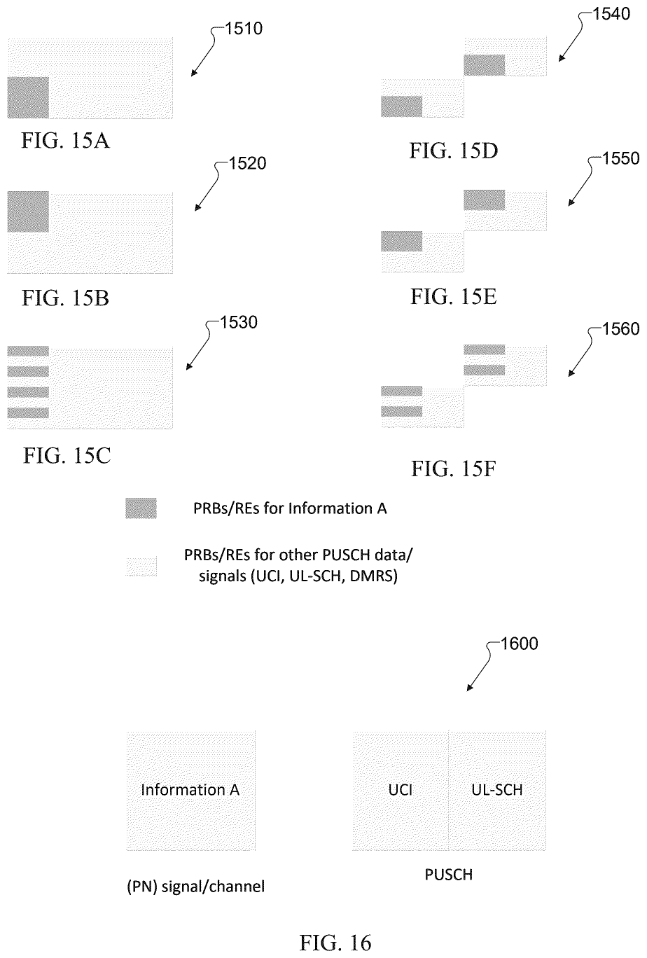

FIGS. 15A, 15B, 15C, 15D, 15E, and 15F illustrate an example multiplexing configuration 1510, 1520, 1530, 1540, 1550, and 1560, respectively, according to embodiments of the present disclosure. For example, multiplexing configuration 1510, 1520, 1530, 1540, 1550, and 1560, respectively, can be utilized by the UE 116 of FIG. 3. This example is for illustration only and other embodiments can be used without departing from the scope of the present disclosure.

In one example, information A is included in the PUSCH that provides information on the UCI and/or UL-SCH multiplexed on the PUSCH. In one example, information A is separately encoded from UCI and from UL-SCH. In one example, information A is multiplexed on PUSCH as illustrated in FIG. 14 and FIG. 15 with UCI and UL-SCH. In one example, information A is multiplexed in the first M symbols (or M non-DMRS symbols) of PUSCH (e.g., as illustrated in FIGS. 15(A), 15(B), 15(C)). In one example, information A is multiplexed in the first M symbols (or M non-DMRS symbols) of each frequency hop of PUSCH, e.g., when frequency hopping is enabled (e.g., as illustrated in FIGS. 15(D), 15(E), 15(F)). In one example, N RBs (or N REs) are used for information A (e.g., in the symbols in which information A is transmitted). In one example, the N RBs (or the REs) are the first N RBs (or the REs) of the PUSCH allocation (e.g., as illustrated in FIGS. 15(A), 15(D)). In one example, the N RBs (or the REs) are the last N RBs (or the REs) of the PUSCH allocation (e.g., as illustrated in FIGS. 15(B), 15(E)). In one example, the N RBs (or the REs) are distributed (e.g., uniformly) in the PUSCH allocation (e.g., as illustrated in FIGS. 15(C), 15(F)). In one example, the N RBs (or the REs) are configured.

FIG. 16 illustrates an example pre-notification (PN) and PUSCH configuration 1600 according to embodiments of the present disclosure. For example, PN and PUSCH configuration 1600 can be applied by any of the UEs 111-116 of FIG. 1, such as the UE 111. This example is for illustration only and other embodiments can be used without departing from the scope of the present disclosure.

In a variant example, information A is transmitted in a (pre-notification (PN)) signal/channel before the PUSCH as illustrated in FIG. 16.

In one example, information A can indicate:
The payload size of UCI.
The number of REs used for UCI.
The type(s) of UCI information included in UCI multiplexed on PUSCH.
Transport block(s) size of UL-SCH.
The number of REs used for UL-SCH
Number of CBs/CBGs for each TB of UL-SCH or CBs/CBGs (e.g., as bitmap or list of CBs/CBGs) for each TB of UL-SCH.
The priority level of the UCI and/or the priority level of the UL-SCH.

In one example, information A includes the payload size of the UCI. For example, the payload size of UCI is determined based on the amount of information the UE wants to transmit. In one example, the UE can determine the number of REs used for UCI based on one or more of the code rate for UCI (R_{UCI}), the code rate for UL-SCH (R_{UL-SCH}), the modulation order for PUSCH (Qₘ), the number of layers on which UCI is mapped (N_{L}), the beta offset for UCI

$$( {β}_{offset}^{P U S C H} ) .$$

In the following examples, P_{UCI} is related to the UCI payload. In one example, P_{UCI} is the UCI payload size, in one example, P_{UCI} is the UCI payload size plus the CRC block(s) size appended to the UCI.

In one example, the number of REs for UCI is given by:

$${N}_{R E}^{UCI} = ⌈ \frac{{P}_{UCI} \cdot {β}_{offset}^{PUSCH}}{{R}_{UL - SCH} \cdot {Q}_{m}} ⌉$$

In one example, the number of REs for UCI is given by:

$${N}_{R E}^{UCI} = ⌈ \frac{{P}_{UCI} \cdot {β}_{offset}^{PUSCH}}{{R}_{UL - SCH} \cdot {Q}_{m} \cdot {N}_{L}} ⌉$$

In one example, the number of REs for UCI is given by:

$${N}_{R E}^{UCI} = ⌈ \frac{{P}_{UCI}}{{R}_{UCI} \cdot {Q}_{m}} ⌉$$

In one example, the number of REs for UCI is given by:

$${N}_{R E}^{UCI} = ⌈ \frac{{P}_{UCI}}{{R}_{UCI} \cdot {Q}_{m} \cdot {N}_{L}} ⌉$$

In the examples mentioned herein, the ceiling function ┌ ┐ can be replaced by the floor function └ ┘.

In one example, a UE configured e.g., by RRC signaling or SIB signaling or MAC CE or L1 control (e.g., DCI Format) a list payload sizes for UCI, e.g., {U_{UCI}(0), U_{UCI}(1), . . . , U_{UCI}(L−1)}, the UE determines a UCI payload size, U_{UCI}. The UE selects a UCI payload size from the list, e.g., U_{UCI}(j), and signals the selected payload size (e.g., index j of the selected payload size) to BS e.g., in Information A. The selection of U_{UCI}(j) can be according to one of the following examples.

In one example, the UE selects the payload size U_{UCI}(j) such that U_{UCI}(j) is the smallest payload size in the list that is greater than or equal to the determined payload size U_{UCI}. In one example, the UE can apply padding to payload of size Uu_{UCI} to get to the payload of size U_{UCI}(j).

In one example, the UE selects the payload size U_{UCI}(j) such that U_{UCI}(j) is nearest or closest value in the list to the determined payload size U_{UCI}. In one example, the UE can apply padding or puncturing to the payload of size U_{UCI} to get to the payload of size U_{UCI}(j).

In one example, if U_{UCI} is larger than the largest value in the list, the UE (e.g., the UE 116) selects the largest payload size in the list, e.g., U_{UCI}(J). In one example, the UE may drop UCI reports, e.g., based on priority from the lowest priority to the highest priority, to fit within the payload size U_{UCI}(J).

In one example, the selection of a payload size from the list, U_{UCI}(j) is up to UE implementation.

In the following example, different UCI types, e.g., UCI Type i, can have different beta offsets

$${β}_{offset}^{P U SCH - i}$$

or different code rates, R_{UCI-i}. P_{UCI-i} is related to the payload size for UCI Type i. In one example, P_{UCI-i} is the UCI payload size for UCI Type i, in one example, P_{UCI-i} is the UCI payload size plus the CRC block(s) size appended to the UCI for UCI Type i. The total number of REs can be found by summing the number of REs for each UCI Type, as in the following examples. Wherein, M is the number of different UCI Types.

$${N}_{R E}^{UCI - i}$$

is the number of REs for UCI Type i.

In one example, the number of REs for UCI is given by:

$${N}_{R E}^{UCI - i} = ⌈ \frac{{P}_{UCI - i} \cdot {β}_{offset}^{PUSCH - i}}{{R}_{UL - SCH} \cdot {Q}_{m}} ⌉$$

$${N}_{R E}^{UCI} = {\sum }_{i = 0}^{M - 1} {N}_{RE}^{UCI - i} = {\sum }_{i = 0}^{M - 1} ⌈ \frac{{P}_{UCI - i} \cdot {β}_{o f fset}^{PUSCH - i}}{{R}_{UL - SCH} \cdot {Q}_{m}} ⌉$$

In one example, the number of REs for UCI is given by:

$${N}_{RE}^{UCI - i} = ⌈ \frac{{P}_{UCI - i} \cdot {β}_{offset}^{PUSCH - i}}{{R}_{UL - SCH} \cdot {Q}_{m} \cdot {N}_{L}} ⌉$$

$${N}_{RE}^{UCI} = {\sum }_{i = 0}^{M - 1} {N}_{RE}^{UCI - i} = {\sum }_{i = 0}^{M - 1} ⌈ \frac{{P}_{UCI - i} \cdot {β}_{offset}^{PUSCH - i}}{{R}_{UL - SCH} \cdot {Q}_{m} \cdot {N}_{L}} ⌉$$

In one example, the number of REs for UCI is given by:

$${N}_{RE}^{UCI - i} = ⌈ \frac{{P}_{UCI - i}}{{R}_{UCI - i} \cdot {Q}_{m}} ⌉$$

$${N}_{RE}^{UCI} = {\sum }_{i = 0}^{M - 1} {N}_{RE}^{UCI - i} = {\sum }_{i = 0}^{M - 1} ⌈ \frac{{P}_{UCI - i}}{{R}_{UCI - i} \cdot {Q}_{m}} ⌉$$

In one example, the number of REs for UCI is given by:

$${N}_{RE}^{UCI - i} = ⌈ \frac{{P}_{UCI - i}}{{R}_{UCI - i} \cdot {Q}_{m} \cdot {N}_{L}} ⌉$$

$${N}_{RE}^{UCI} = {\sum }_{i = 0}^{M - 1} {N}_{RE}^{UCI - i} = {\sum }_{i = 0}^{M - 1} ⌈ \frac{{P}_{UCI - i}}{{R}_{UCI - i} \cdot {Q}_{m} \cdot {N}_{L}} ⌉$$

In the examples mentioned herein, the ceiling function ┌ ┐ can be replaced by the floor function └ ┘.

In one example, a UE configured e.g., by RRC signaling or SIB signaling or MAC CE or L1 control (e.g., DCI Format) a list payload sizes for UCI Type-i, e.g., {U_{UCI-i}(0), U_{UCI-i}(1), . . . , U_{UCI-i}(L−1)}, the UE determines a UCI payload size for UCI type-i, U_{UCI-i}. The UE selects a UCI payload size for UCI type-i from the list, e.g., U_{UCI-i}(j), and signals the selected payload size (e.g., index j of the selected payload size for UCI type-i) to BS (e.g., the BS 102) e.g., in Information A. The selection of U_{UCI-i}(j) can be according to one of the following examples.

In one example, the UE selects the payload size for UCI type-i U_{UCI-i}(j) such that U_{UCI-i}(j) is the smallest payload size in the list that is greater than or equal to the determined payload size for UCI type-i U_{UCI-i}. In one example, the UE can apply padding to payload of size U_{UCI-i} to get to the payload of size U_{UCI-i}(j).

In one example, the UE selects the payload size for UCI type-i U_{UCI-i}(j) such that U_{UCI-i}(j) is nearest or closest value in the list to the determined payload size for UCI type-i U_{UCI-i}. In one example, the UE can apply padding or puncturing to the payload of size U_{UCI-i} to get to the payload of size U_{UCI-i}(j).

In one example, if U_{UCI-i} is larger than the largest value in the list, the UE selects the largest payload size for UCI type-i in the list, e.g., U_{UCI-i}(J). In one example, the UE may drop UCI reports for UCI type-i, e.g., based on priority from the lowest priority to the highest priority, to fit within the payload size U_{UCI-i}(J).

In one example, the selection of a payload size from the list, U_{UCI-i}(j) is up to UE implementation.

In one In one example, the number of coded bits for UCI is given by

$${N}_{RE}^{UCI} \cdot {Q}_{m} \cdot {N}_{L} .$$

In one example, the number of coded bits for UCI Type i is given by

$${N}_{RE}^{UCI - i} \cdot {Q}_{m} \cdot {N}_{L} .$$

In one example, a UE is configured or updated by RRC and/or MAC CE and/or L1 control (e.g., DCI Format) signaling) a maximum number of REs for UCI

$$( e . g . , {N}_{RE - max}^{UCI} ) .$$

In one example, a UE determines

$${N}_{RE - max}^{UCI}$$

based on a configured value and the number of REs available for data (UL-SCH or UCI) transmission and/or symbols and/or RBs of the PUSCH. In one example,

$${N}_{RE - max}^{UCI}$$

is the overhead of UCI in PUSCH. In one example, if

$${N}_{RE}^{UCI}$$

exceeds

$${N}_{RE - max}^{UCI} ,$$

the UE can limit the number of REs for UCI on PUSCH to

$${N}_{RE - max}^{UCI} .$$

In one example, the UE can adjust the code rate of the UCI to use

$${N}_{RE - max}^{UCI}$$

REs for UCI or to use no more than

$${N}_{RE - max}^{UCI}$$

### for UCI.

In one example, the UE can adjust the code rate of the UCI to use

$${N}_{RE - max}^{UCI}$$

REs for UCI or to use no more than

$${N}_{RE - max}^{UCI}$$

for UCI based on the UCI code rates or beta-offset values mentioned herein. In one example, the UE drops UCI reports in priority order starting with the lowest priority until, the number of REs used for UCI based on the equations mentioned herein doesn't exceed

$${N}_{RE - max}^{UCI}$$

### REs.

In one example, for a given UCI payload size, the UE determines

$${N}_{R E}^{UCI} ,$$

and the UE indicates

$${N}_{R E}^{UCI}$$

in information A. In one example, for a given UCI payload size, the UE determines

$${N}_{R E}^{UCI} ,$$

if

$${N}_{R E}^{UCI}$$

is larger than

$${N}_{RE - max}^{UCI} ,$$

the UE adjusts

$${N}_{R E}^{UCI} to {N}_{RE - max}^{UCI} ,$$

the UE indicates

$${N}_{R E}^{UCI}$$

in information A.

In one example, a UE configured e.g., by RRC signaling or SIB signaling or MAC CE or L1 control (e.g., DCI Format) a list RE sizes for UCI, e.g.,

$$\{ {N}_{R E}^{UCI} ( 0 ) , {N}_{R E}^{UCI} ( 1 ) , … , {N}_{R E}^{UCI} ( L - 1 ) \} ,$$

the UE determines a number of REs for a determine UCI payload,

$${N}_{R E}^{UCI}$$

as mentioned herein. The UE selects a value for the number of REs from the list, e.g.,

$${N}_{R E}^{UCI} ( j ) ,$$

and signals the selected value (e.g., index j of the selected value) to BS e.g., in Information A. The selection of can be according

$${N}_{R E}^{UCI} ( j )$$

can be according to one of the following examples.

In one example, the UE selects the number of REs

$${N}_{R E}^{UCI} ( j )$$

such that

$${N}_{R E}^{UCI} ( j )$$

is the value in the list that is greater than or equal to the determined number of REs

$${N}_{R E}^{UCI} .$$

In one example, the UE can adjust the coding rate (e.g., rate matching) to fit within the allocated number of REs).

In one example, the UE selects the number of REs

$${N}_{R E}^{UCI} ( j )$$

such that

$${N}_{R E}^{UCI} ( j )$$

is nearest or closest value in the list to the determined number of REs

$${N}_{R E}^{UCI} .$$

In one example, the UE can adjust the coding rate (e.g., rate matching) to fit within the allocated number of REs).

In one example, if

$${N}_{R E}^{UCI}$$

is larger than the largest value in the list, the UE selects the number of REs for UCI in the list, e.g.,

$${N}_{R E}^{UCI} ( J ) .$$

In one example, the UE may drop UCI reports, e.g., based on priority from the lowest priority to the highest priority, to fit within the selected number of REs and not exceed a code rate (e.g., a configured maximum code rate or a code rate determined by the UE as mentioned herein). In one example, the UE can adjust the coding rate (e.g., rate matching) to fit within the allocated number of REs).

In one example, the selection of a number of REs

$${N}_{R E}^{UCI} ( j )$$

from the list, is up to UE implementation.

In the examples mentioned herein and the following examples, RE (resource element) can be replaced by RB (resource block). In one example, a RB has 12 REs.

In one example, information A includes the number of REs used for UCI. In one example, the UE transmitter or BS receiver can determine the payload size for UCI based on one or more of the code rate for UCI (R_{UCI}), the code rate for UL-SCH (R_{UL-SCH}), the modulation order for PUSCH (Qₘ), the number of layers on which UCI is mapped (N_{L}), the beta offset for UCI

$$( {β}_{offset}^{PUSCH} ) .$$

In the following examples, P_{UCI} is related to the UCI payload. In one example, P_{UCI} is the UCI payload size, in one example, P_{UCI} is the UCI payload size plus the CRC block(s) size appended to the UCI. In the following example,

$${N}_{R E}^{UCI}$$

is the number or Kes used for UCI in PUSCH

In one example, P_{UCI} is given by:

$${P}_{UCI} \leq \frac{{N}_{R E}^{UCI} \cdot {R}_{UL - SCH} \cdot {Q}_{m}}{{β}_{offset}^{PUSCH}}$$

In one example, P_{UCI} is given by:

$${P}_{UCI} \leq \frac{{N}_{R E}^{UCI} \cdot {R}_{UL - SCH} \cdot {Q}_{m} \cdot {N}_{L}}{{β}_{offset}^{PUSCH}}$$

In one example, P_{UCI} is given by:

$${P}_{UCI} \leq {N}_{R E}^{UCI} \cdot {R}_{UCI} \cdot {Q}_{m}$$

In one example, P_{UCI} is given by:

$${P}_{UCI} \leq {N}_{R E}^{UCI} \cdot {R}_{UCI} \cdot {Q}_{m} \cdot {N}_{L}$$

In one example, UCI reports are dropped in priority order starting with the lowest priority until the limit of P_{UCI} mentioned herein is achieved.

In a variant example, different UCI types, e.g., UCI Type i, can have different beta offsets

$${β}_{offset}^{P U S C H - i}$$

or difference code rates, R_{UCI-i}. In one example, the UCI types are arranged in priority order with UCI Type i=0, having the highest priority and UCI Type i=M−1 having the lowest priority, the UE starting with i=0, populates the REs for UCI. If UCI-Type i occupies

$${N}_{R E}^{UCI - i} REs ,$$

where

$${N}_{R E}^{UCI - i}$$

can be given by one of the following examples.

In one example, the number of REs for UCI is given by:

$${N}_{R E}^{UCI - i} = ⌈ \frac{{P}_{UCI - i} \cdot {β}_{offset}^{P U S C H - i}}{{R}_{U L - S C H} \cdot {Q}_{m}} ⌉$$

In one example, the number of REs for UCI is given by:

$${N}_{R E}^{UCI - i} = ⌈ \frac{{P}_{UCI - i} \cdot {β}_{offset}^{P U S C H - i}}{{R}_{U L - S C H} \cdot {Q}_{m} \cdot {N}_{L}} ⌉$$

In one example, the number of REs for UCI is given by:

$${N}_{R E}^{UCI - i} = ⌈ \frac{{P}_{UCI - i}}{{R}_{UCI - i} \cdot {Q}_{m}} ⌉$$

In one example, the number of REs for UCI is given by:

$${N}_{R E}^{UCI - i} = ⌈ \frac{{P}_{UCI - i}}{{R}_{UCI - i} \cdot {Q}_{m} \cdot {N}_{L}} ⌉$$

In the examples mentioned herein, the ceiling function [ ] can be replaced by the floor function [ ].

If the number of REs after multiplexing UCI Type j is less than or equal to

$${N}_{R E}^{UCI} ,$$

i.e.,

$${\sum }_{i = 0}^{j} {N}_{R E}^{UCI - i} \leq {N}_{R E}^{UCI}$$

And the number of REs after multiplexing UCI Type j+1 is greater than

$${N}_{R E}^{UCI} ,$$

i.e.,

$${\sum }_{i = 0}^{j + 1} {N}_{R E}^{UCI - i} > {N}_{R E}^{UCI}$$

The UE can multiplex UCI types up to UCI type j, the UE reduces the payload size of UCI Type j+1 such that the number of REs used by UCI type j+1 doesn't exceed

$${N}_{R E}^{UCI} - {\sum }_{i = 0}^{j} {N}_{R E}^{UCI - i} ,$$

the payload size for UCI Type j+1, can be according to one of the following examples.

In one example, P_{UCI} is given by:

$${P}_{UCI - j + 1} \leq ( {N}_{R E}^{UCI} - {\sum }_{i = 0}^{j} {N}_{R E}^{UCI - i} ) \frac{{R}_{UL - SCH} \cdot {Q}_{m}}{{β}_{offset}^{P U SCH - j + 1}}$$

In one example, P_{UCI} is given by:

$${P}_{UCI - j + 1} \leq ( {N}_{R E}^{UCI} - {\sum }_{i = 0}^{j} {N}_{R E}^{UCI - i} ) \frac{{R}_{UL - SCH} \cdot {Q}_{m} \cdot {N}_{L}}{{β}_{offset}^{P U SCH - j + 1}}$$

In one example, P_{UCI} is given by:

$${P}_{UCI - j + 1} \leq ( {N}_{R E}^{UCI} - {\sum }_{i = 0}^{j} {N}_{R E}^{UCI - i} ) \cdot {R}_{UCI - j + 1} \cdot {Q}_{m}$$

In one example, P_{UCI} is given by:

$${P}_{UCI - j + 1} \leq ( {N}_{R E}^{UCI} - {\sum }_{i = 0}^{j} {N}_{R E}^{UCI - i} ) \cdot {R}_{UCI - j + 1} \cdot {Q}_{m} \cdot {N}_{L}$$

In one example, UCI reports for UCI Type j+1 are dropped in priority order starting with the lowest priority until the limit of P_{UCI-j+1} mentioned herein is achieved.

In a variant example, the UE can multiplex UCI types up to UCI type j, the UE adjusts the coding rate for UCI Type j+1 or the beta offset for UCI Type j+1 such that the number of REs used by UCI type j+1 equals or doesn't exceed

$${N}_{R E}^{UCI} - {\sum }_{i = 0}^{j} {N}_{R E}^{UCI - i} .$$

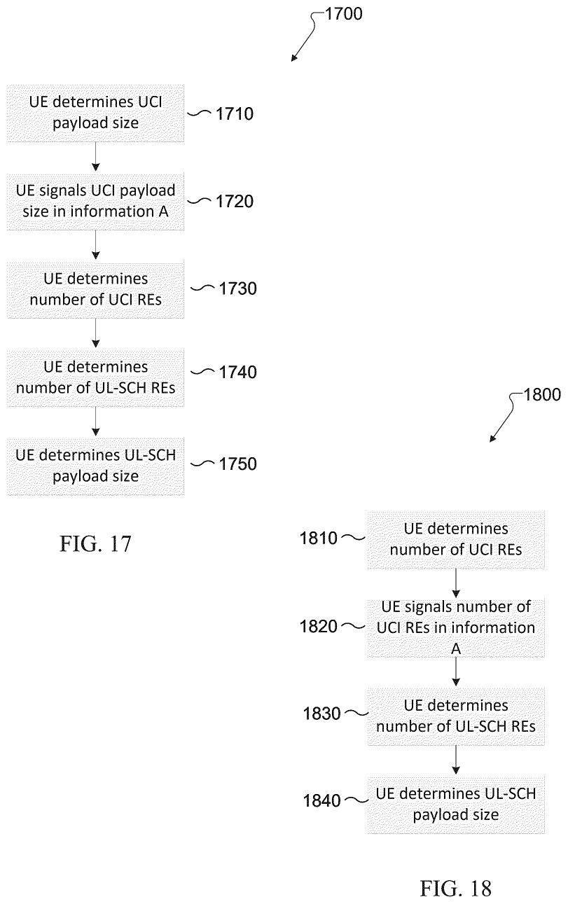

FIG. 17 illustrates a flowchart of an example UE procedure 1700 for determining the UL-SCH payload size according to embodiments of the present disclosure. For example, procedure 1700 can be performed by any of the UEs 111-116 of FIG. 1, such as the UE 112. This example is for illustration only and other embodiments can be used without departing from the scope of the present disclosure.

The procedure begins in 1710, a UE determines the UCI payload size. In 1720, the UE signals the UCI payload size in information A. In 1730, the UE determines the number of UCI REs. In 1740, the UE determines the number of UL-SCH REs. In 1750, the UE determines the UL-SCH payload size.

FIG. 18 illustrates a flowchart of an example UE procedure 1800 for determining the UL-SCH payload size according to embodiments of the present disclosure. For example, procedure 1800 can be performed by any of the UEs 111-116 of FIG. 1, such as the UE 113. This example is for illustration only and other embodiments can be used without departing from the scope of the present disclosure.

The procedure begins in 1810, a UE determines the number of UCI REs. In 1820, the UE signals the number of UCI REs in information A. In 1830, the UE determines the number of UL-SCH REs. In 1840, the UE determines the UL-SCH payload size.

In one example, P_{UL-SCH} is related to the UL-SCH payload. In one example, P_{UL-SCH} is the UL-SCH payload size, in one example, P_{UL-SCH} is the UCI payload size plus the CRC block(s) size appended to the UL-SCH, e.g., including TB CRC (if present) and/or CBs CRC (if present). In one example,

$${N}_{R E}^{UL - SCH}$$

is the number of REs used for UL-SCH.

In one example,

$${N}_{R E}^{UL - SCH}$$

is provided in information A.

In one example, the payload size of UL-SCH is provided in information A. The UE can determine P_{UL-SCH} as mentioned herein. In one example, the number of REs for UL-SCH is determined based on P_{UL-SCH}.
In one example,

$${N}_{R E}^{UL - SCH} = ⌈ \frac{{P}_{UL - SCH}}{{R}_{UL - SCH} \cdot {Q}_{m} \cdot {N}_{L}} ⌉ .$$

In one example,

$${N}_{R E}^{UL - SCH} = ⌊ \frac{{P}_{UL - SCH}}{{R}_{UL - SCH} \cdot {Q}_{m} \cdot {N}_{L}} ⌋$$

In one example, if

$${N}_{R E}^{P U S C H}$$

is the number of REs available in PUSCH channel for data (e.g., UCI and UL-SCH) transmission. In one example,

$${N}_{R E}^{P U S C H} = {N}_{S C}^{R B} \cdot {N}_{s y m}^{P U S C H} \cdot {N}_{P R B}^{P U S C H} - {N}_{D M R S} .$$

In one example,

$${N}_{R E}^{P U S C H} = {N}_{sc}^{R B} \cdot {N}_{s y m}^{P U S C H} \cdot {N}_{P R B}^{P U S C H} - {N}_{DMRS} - {N}_{o h} .$$

In one example,

$${N}_{R E}^{P U S C H} = {N}_{P R B}^{P U S C H} ( {N}_{sc}^{R B} \cdot {N}_{s y m}^{P U S C H} - {N}_{D MRS , RB} ) .$$

In one example,

$${N}_{R E}^{P U S C H} = {N}_{P R B}^{P U S C H} ( {N}_{sc}^{R B} \cdot {N}_{s y m}^{P U S C H} - {N}_{DMRS , RB} - {N}_{oh , RB} ) .$$

In one example,

$${N}_{sc}^{RB}$$

is the number of sub-carriers per RB. In one example,

$${N}_{sc}^{RB} = 12.$$

In one example,

$${N}_{sym}^{PUSCH}$$

is the number of symbols allocated to PUSCH. In one example,

$${N}_{PRB}^{PUSCH}$$

is the number of PRBs allocated to PUSCH. In one example, N_{DMRS} is the number of REs for DMRS in the PUSCH allocated resources, including overhead of the DMRS code-division multiplexing (CDM) groups without data, if any. In one example, N_{DMRS,RB} is the number of REs per PRB for DMRS in the PUSCH allocated resources, including overhead of the DMRS CDM groups without data, if any. In one example, Nₒₕ is the number of REs for overhead (e.g., this can include for example, REs for Information A) in the PUSCH allocated resources. In one example, N_{oh,RB} is the number of REs per PRB for overhead (e.g., this can include for example, REs for Information A) in the PUSCH allocated resources. In one example, the UE can determine the number REs for UL-SCH based on number of REs used for

$$UCI ( e . g . , {N}_{RE}^{UCI} )$$

determined as mentioned herein. In one example,

$${N}_{RE}^{UL - SCH} = {N}_{RE}^{PUSCH} - {N}_{RE}^{UCI} .$$

In one example,

$${N}_{RE}^{UL - SCH} = {N}_{RE}^{PUSCH} - {N}_{RE - max}^{UCI} .$$

In one example, information A provides UCI payload size→from UCI payload size,

$${N}_{RE}^{UCI}$$

can be determined as mentioned herein→from

$${N}_{RE}^{UCI} , {N}_{RE}^{UL - SCH}$$

can be determined as mentioned herein. In one example, information A provides

$${N}_{RE}^{UCI} \to from {N}_{RE}^{UCI} , {N}_{RE}^{UL - SCH}$$

can be determined as mentioned herein.

In one example, the payload size of UL-SCH is provided in information A.

In one example, UE can determine the payload size based on

$${N}_{RE}^{UL - SCH} , wherein , {N}_{RE}^{UL - SCH}$$

can be determined as mentioned herein. In one example,

$${P}_{UL - SCH} \leq {N}_{RE}^{UL - SCH} \cdot {R}_{UL - SCH} \cdot {Q}_{m} \cdot {N}_{L} .$$

In one example, P_{UL-SCH} is related to the UL-SCH payload. In one example, P_{UL-SCH} is the UL-SCH payload size, in one example, P_{UL-SCH} is the UL-SCH payload size plus the CRC block(s) size appended to the UL-SCH, e.g., including TB CRC (if present) and/or CBs CRC (if present).

In one example, as illustrated in FIG. 17, the UE determines the UCI payload size, e.g., UE determines P_{UCI}, UE can indicate the UCI payload size in Channel A→then, the UE/BS determine number of REs allocated to UCI

$$( e . g . , {N}_{RE}^{UCI} )$$

as mentioned herein→then, the UE/BS determine the number of REs allocated to

$$UL - SCH ( e . g . , {N}_{RE}^{UL - SCH} ) ,$$

→then, the UE/BS determine the UL-SCH payload size (e.g., based on P_{UL-SCH}).

In one example, as illustrated in FIG. 18, the UE determines number of REs allocated to

$$UCI ( e . g . , {N}_{RE}^{UCI} )$$

as mentioned herein, UE can indicate number of REs allocated to UCI in Information A,→then, the UE/BS determine the number of REs allocated to UL-SCH

$$( e . g . , {N}_{R E}^{U L - S C H} ) ,$$

→the UE/BS determines the UL-SCH payload size (e.g., based on P_{UL-SCH}). Based on number of REs allocated to UCI in Information A, BS can determine UCI payload size, UE can determine UCI code rate or any UCI dropping.

In one example, the physical layer provides the higher layer the payload size of UL-SCH determined as mentioned herein, and the higher layer provides the physical layer with TB(s) (e.g., MAC PDU(s)) according to the payload size of UL-SCH provided by the physical layer.

In one example, the higher layers provide the physical layer TB(s) (e.g., MAC PDU(s)) with a size that doesn't take into account the UCI payload, or that takes into account a nominal UCI payload, e.g., determined based on an expected overhead parameter Nₒₕ or

$${N}_{R E - nominal}^{UCI} .$$

In one example, the physical layer can truncate the UL-SCH payload (e.g., TB(s)) to fit within the allocated resources after removing the resources used for UCI with the determined code rate of UL-SCH. In one example, UE can indicate in information A that the UL-SCH payload is truncated.

In one example the physical layer can perform channel coding on the UL-SCH payload (e.g., TB(s)) including appending CRC, CB segmentation (e.g., into N CBs), channel encoding (e.g., using low-density parity-check (LPDC)), rate matching and CB concatenation (e.g., concatenation of M CBs, wherein M≤N). The physical layer can determine the number of CBs to concatenate (e.g., M) to fit within the allocated resources, with the determined code rate for UL-SCH. In one example, the UE (e.g., the UE 116) can indicate M in information A. In one example, the UE can indicate a bit map of the M CBs transmitted (out of the N CBs from CB segmentation) in information A. In one example, a UE can indicate with a flag whether CBs have been dropped or not. In one example, based on the UCI payload size and/or the number of UE REs indicated in Information A, the receiver (e.g., BS) can determine if CBs have been dropped or not (e.g., implicit indication) of drop CBs.

In one example the physical layer can perform channel coding on the UL-SCH payload (e.g., TB(s)) including appending CRC, CB segmentation (e.g., into N CBs), channel encoding (e.g., using LPDC), rate matching and CB concatenation (e.g., concatenation of M CBs, wherein M≤N). In one example, the CBs concatenated correspond to full CBGs (i.e., either CBs of a CBG are transmitted or no CBs of a CBGs are transmitted). The physical layer can determine the number of CBs to concatenate (e.g., M) to fit within the allocated resources based on the CBGs, with the determined code rate for UL-SCH. In one example, the UE can indicate number of CBGs or M in information A. In one example, the UE can indicate a bit map of the CBGs transmitted (out of the CBGs of the transport block) in information A. In one example, a UE can indicate with a flag whether CBGs have been dropped or not. In one example, based on the UCI payload size and/or the number of UE REs indicated in Information A, the receiver (e.g., BS) can determine if CBGs have been dropped or not (e.g., implicit indication) of drop CBGs.

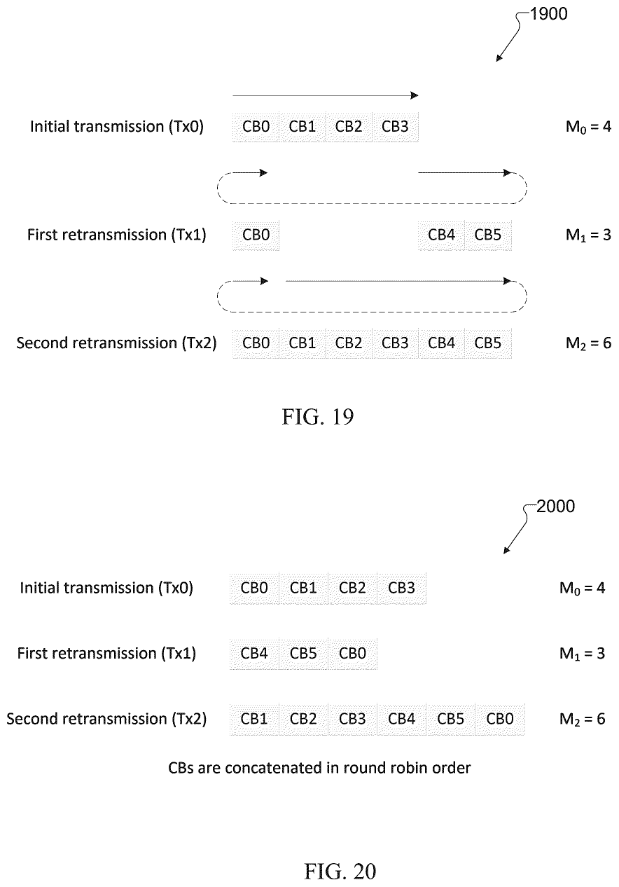

FIG. 19 illustrates an example transmission and retransmissions 1900 according to embodiments of the present disclosure. For example, transmission and retransmissions 1900 can be transmitted by any of the UEs 111-116 of FIG. 1, such as the UE 114. This example is for illustration only and other embodiments can be used without departing from the scope of the present disclosure.

In one example, for transmission and retransmission of PUSCH, the UE determines the number of CBs to transmit in the initial transmission, e.g., M₀ CBs out of N CBs, e.g., based on UCI payload size or number of REs used for UCI in the initial transmission. For a first retransmission, the UE determines the number of CBs to transmit, e.g., M₁ CBs out of N CBs, e.g., based on UCI payload size or number of REs used for UCI in the first retransmission. For a second retransmission, the UE determines the number of CBs to transmit, e.g., M₂ CBs out of N CBs, e.g., based on UCI payload size or number of REs used for UCI in the second retransmission . . . and so on until CBs have been successfully received. In one example, the UCI overhead and/or the amount of UCI resources in each transmission can be different, hence the values, M₀, M₁, M₂, . . . can be different.

In one example, the UE can transmit UL-SCH CBs in a round-robin order across the different transmissions. In one example, the CB indices are 0, 1, . . . , N−1.

For the initial transmission, i.e., transmission 0, the following CBs are transmitted: CB₀, CB₁, . . . , CB_{M}_{₀}₋₁.

For retransmission i, the following CBs are transmitted: CB_{(I(i)+0)mod N}, CB_{(I(i)+1)mod N}, . . . , CB_{(I(i)+M}_{ᵢ}_{-1)mod N}, where

$$I ( i ) = {\sum }_{j = 0}^{i - 1} {M}_{j} ,$$

e.g., number of CBs transmitted before transmission i. FIG. 19 indicates an example of transmission of CBs across multiple transmissions, in the example, of FIG. 19, N=6, M₀=4, M₁=3, and M₂=6.

FIG. 20 illustrates an example transmission and retransmissions 2000 according to embodiments of the present disclosure. For example, transmission and retransmissions 2000 can be transmitted by any of the UEs 111-116 of FIG. 1, such as the UE 115. This example is for illustration only and other embodiments can be used without departing from the scope of the present disclosure.

In one example of FIG. 19, the CBs are determined and transmitted (concatenated) in a round robin order as shown in FIG. 19 and in FIG. 20.

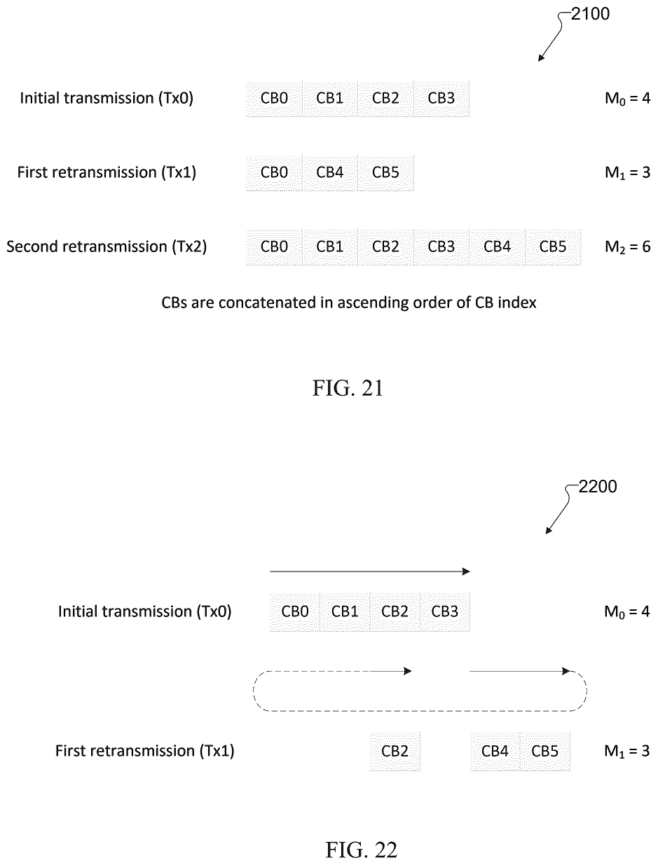

FIG. 21 illustrates an example transmission and retransmissions 2100 according to embodiments of the present disclosure. For example, transmission and retransmissions 2100 can be transmitted by any of the UEs 111-116 of FIG. 1, such as the UE 116. This example is for illustration only and other embodiments can be used without departing from the scope of the present disclosure.

In one example of FIG. 19, the CBs are determined in a round robin order as shown in FIG. 19, and are transmitted (concatenated) in order of CB index, e.g., in ascending order of CB index as illustrated in FIG. 21, or in descending order of CB index.

In the examples mentioned herein (associated with FIGS. 19, 20 and 21), CB can be replaced by CBG.

FIG. 22 illustrates an example transmission and retransmission(s) 2200 according to embodiments of the present disclosure. For example, transmission and retransmission(s) 2200 can be transmitted by the UE 116 of FIG. 3. This example is for illustration only and other embodiments can be used without departing from the scope of the present disclosure.

In one example, the UE can transmit UL-SCH CBs in a round-robin order across the different transmissions. The network (e.g., the network 130) can indicate to the UE for a transmission, which CBs (e.g., of the previous transmission) have been successfully received, or which CBs (e.g., of the previous transmission) have not been successfully received. The UE can skip the CBs that have been successfully received in previous transmissions. FIG. 22 indicates an example of transmission of CBs across multiple transmissions, the network indicates to the UE CBs that have been successfully decoded or the CBs that have not been successfully decoded in the example, of FIG. 22, N=6, M₀=4 and M₁=3 after the initial transmission, the UE indicates that CB2 has not been successfully decoded (or that CB0, CB1 and CB3 have been successfully decoded. In the first retransmission, which can have 3 CBs, the UE can transmit CB4 and CB5 which were not transmitted in the initial transmission and CB2, which was not successfully decoded.

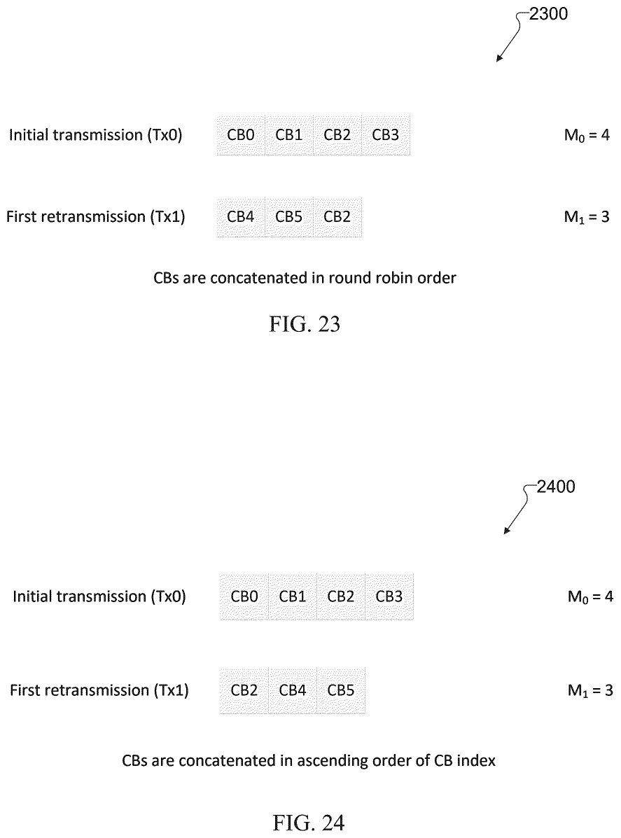

FIG. 23 illustrates an example transmission and retransmission 2300 according to embodiments of the present disclosure. For example, transmission and retransmission 2300 can be transmitted by any of the UEs 111-116 of FIG. 1, such as the UE 111. This example is for illustration only and other embodiments can be used without departing from the scope of the present disclosure.

In one example of FIG. 22, the CBs are determined and transmitted (concatenated) in a round robin order as shown in FIG. 22 and shown in FIG. 23.

FIG. 24 illustrates an example transmission and retransmission 2400 according to embodiments of the present disclosure. For example, transmission and retransmission 2400 can be transmitted by any of the UEs 111-116 of FIG. 1, such as the UE 112. This example is for illustration only and other embodiments can be used without departing from the scope of the present disclosure.

In one example of FIG. 22, the CBs are determined in a round robin order as shown in FIG. 22, and are transmitted (concatenated) in order of CB index, e.g., in ascending order of CB index as illustrated in FIG. 24, or in descending order of CB index.

In the examples mentioned herein (associated with FIGS. 22, 23 and 24), CB can be replaced by CBG.

In one example, the BS (e.g., the BS 102) for transmission i can indicate to the UE CBs or CBGs to transmit in order, the UE determines the number of CBs or CBGs to transmit for transmission i and UE transmits first Mᵢ indicated CBs or CBGs. In one example, if the BS indicates CBs or CBGs Cₐ, C_{b}, C_{c}, C_{d} to transmit, and the UE determines that it can transmit 2 CBs or CBGs, it transmits Cₐ and C_{b}.

In one example, the BS for transmission i can indicate to the UE CBs or CBGs to transmit e.g., as a bit map, the UE determines the number of CBs or CBGs to transmit for transmission i and selects Mᵢ CBs or CBGs from the CBs or CBGs indicated by the BS. In one example, the selection can be such that the CB or CBGs has not been indicated that it is successfully received by the BS. In one example, the selection can be for CB or CBGs with the least number of transmissions in prior transmission/retransmissions of PUSCH associated with a same TB. In one example, the selection can be in ascending order of CB index.

In one example, the UE can include in information A a bit map or a list of the CBs or CBGs transmitted in PUSCH. In one example, the order of CBs or CBGs transmitted in PUSCH is the order of corresponding bits in the bit map or in the list. For example, if there are N=6 CBs or CBGs, and the bit map is 0 1 0 0 1 1 (expecting that the most significant bit (MSB) is CB0/CBG0 and the least significant bit (LSB) is CB5/CBG5), the order of CBs/CBGs transmitted is CB1/CBG1 CB4/CBG4 CB5/CBG5. In a variant example, the MSB corresponds to CB5/CBG5 and the LSB corresponds to CB0/CBG0. In one example, a “1” in a bitmap indicates that the corresponding CB/CBG is transmitted, and a “0” in a bitmap indicates that the corresponding CB/CBG is not transmitted. In one example, a “1” in a bitmap indicates that the corresponding CB/CBG is not transmitted, and a “0” in a bitmap indicates that the corresponding CB/CBG is transmitted. In one example, information A includes a list of CB/CBGs transmitted.

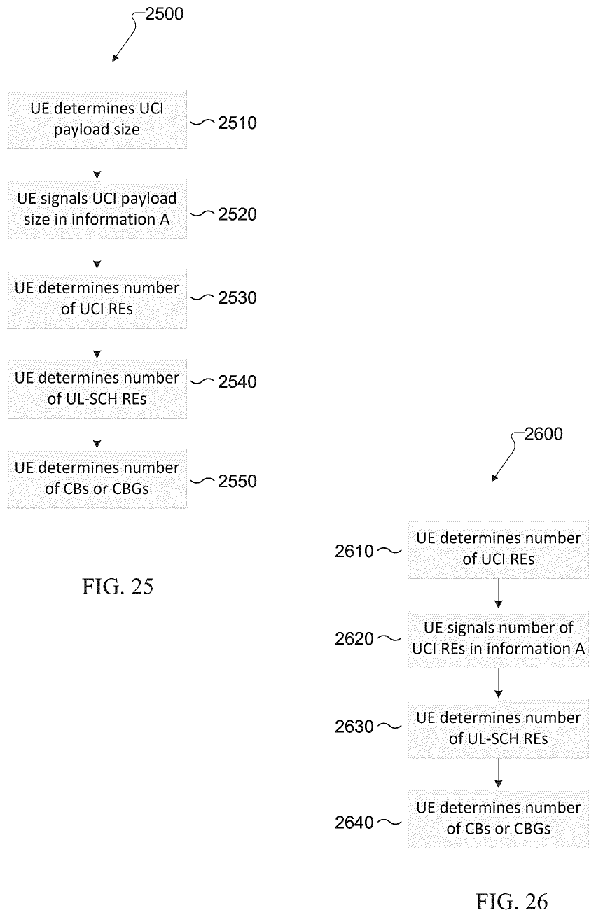

FIG. 25 illustrates a flowchart of an example UE procedure 2500 for determining the number of CBs/CBGs according to embodiments of the present disclosure. For example, procedure 2500 can be performed by any of the UEs 111-116 of FIG. 1, such as the UE 113. This example is for illustration only and other embodiments can be used without departing from the scope of the present disclosure.

The procedure begins in 2510, a UE determines the UCI payload size. In 2520, the UE signals the UCI payload size in information A. In 2530, the UE determines the number of UCI REs. In 2540, the UE determines the number of UL-SCH REs. In 2550, the UE determines the number of CBs or CBGs.

In one example, as illustrated in FIG. 25, the UE determines the UCI payload size, e.g., UE determines P_{UCI}, UE can indicate the UCI payload size in Information A→then, the UE/BS determine number of REs allocated to UCI

$$( e . g . , {N}_{R E}^{UCI} )$$

as mentioned herein→then, the UE/BS determine the number of REs allocated to UL-SCH

$$( e . g . , {N}_{R E}^{U L - S C H} ) ,$$

→then, the UE/BS determine the number of UL-SCH CBs or CBGs to transmit. Based on number of REs allocated to UCI in Information A, BS can determine UCI payload size, UE can determine UCI code rate or any UCI dropping. In one example, CBs/CBGs transmitted and the order of CBs/CBGs are determined based on a rule, e.g., in round-robin order as mentioned herein. In one example, CBs/CBGs transmitted and the order of CBs/CBGs are determined based on signaling in information A (e.g., list of CBs/CBGs or a bitmap of CBs/CBGs transmitted) as mentioned herein.

FIG. 26 illustrates a flowchart of an example UE procedure 2600 for determining the number of CBs/CBGs according to embodiments of the present disclosure. For example, procedure 2600 can be performed by any of the UEs 111-116 of FIG. 1, such as the UE 114. This example is for illustration only and other embodiments can be used without departing from the scope of the present disclosure.

The procedure begins in 2610, a UE determines the number of UCI REs. In 2620, the UE signals the number of UCI REs in information A. In 2630, the UE determines the number of UL-SCH REs. In 2640, the UE determines the number of CBs or CBGs.

In one example, as illustrated in FIG. 26, the UE determines number of REs allocated to UCI

$$( e . g . , {N}_{R E}^{UCI} )$$

as mentioned here, UE can indicate number of REs allocated to UCI in Information A, →then, the UE/BS determine the number of REs allocated to UL-SCH

$$( e . g . , {N}_{R E}^{U L - S C H} ) ,$$

→then, the UE/BS determines the number of UL-SCH CBs or CBGs to transmit. Based on number of REs allocated to UCI in Information A, BS can determine UCI payload size, UE can determine UCI code rate or any UCI dropping. In one example, CBs/CBGs transmitted and the order of CBs/CBGs are determined based on a rule, e.g., in round-robin order as mentioned herein. In one example, CBs/CBGs transmitted and the order of CBs/CBGs are determined based on signaling in information A (e.g., list of CBs/CBGs or a bitmap of CBs/CBGs transmitted) as mentioned herein.

In one example, the UCI payload (e.g., a UCI header) or Information A can include information about the UCI, e.g., number of CSI reports, type of UCI information or report that is included in the UCI, and/or payload size of each type of UCI information or report. In one example, the information about the UCI, e.g., number of CSI reports, type of UCI information that is included in the UCI can be determined based on a rule based on the configuration and UCI payload size (e.g., included in or determined by Information A) or number of REs used for UCI (e.g., included in or determined by Information A).

In one example, the number of REs available for data transmission in

$${N}_{R E}^{P U S C H}$$

as mentioned herein. In one example, the physical layer has UCI data to transmit of size P_{UCI}. In one example, based on the UCI size and a UCI code rate and/or modulation order and/or number of layers, the UE determines the number of REs for UCI as

$${N}_{R E}^{UCI}$$

as mentioned herein. In one example, the physical layer has UL-SCH data (e.g., transport block(s)) to transmit of size P_{UL-SCH}. In one example, based on the UL-SCH size and a UL-SCH code rate and/or modulation order and/or number of layers, the UE determines the number of REs for UL-SCH as

$${N}_{R E}^{U L - S C H}$$

as mentioned herein. In one example, if

$${N}_{R E}^{U L - S C H} + {N}_{R E}^{UCI} > {N}_{R E}^{P U S C H} ,$$

the UE can follow one of the following examples.

In one example, the UE drops UL-SCH data or UCI data in order of priority, starting with the lowest priority until

$${N}_{R E}^{U L - S C H} + {N}_{R E}^{UCI}$$

is no longer larger than

$${N}_{R E}^{P U S C H} .$$

In one example, the UE adjusts the code rate of UCI and/or UL-SCH so that

$${N}_{R E}^{U L - S C H} + {N}_{R E}^{UCI}$$

is no longer larger than

$${N}_{R E}^{P U S C H} .$$

In one example, the UE (1) adjusts the code rate of UCI and/or UL-SCH so that

$${N}_{RE}^{UL - SCH} + {N}_{RE}^{UCI}$$

is no longer larger than

$${N}_{RE}^{PUSCH}$$

and/or (2) drops UL-son data or UCI data in order of priority, starting with the lowest priority until

$${N}_{RE}^{UL - SCH} + {N}_{RE}^{UCI}$$

is no longer larger than

$${N}_{RE}^{PUSCH} .$$

In one example, the UE (1) adjusts the code rate of UCI and/or UL-SCH up to a maximum code rate so that

$${N}_{RE}^{UL - SCH} + {N}_{RE}^{UCI}$$

is no longer larger than

$${N}_{RE}^{PUSCH}$$

and/or (2) after the maximum code rate is reached, drops UL-SCH data or UCI data in order of priority, starting with the lowest priority until

$${N}_{RE}^{UL - SCH} + {N}_{RE}^{UCI}$$

is no longer larger than

$${N}_{RE}^{PUSCH} .$$

In one example, the adjustment of the code rate is done proportionally across UCI and UL-SCH. In one example, the adjustment of code rate is up to a maximum code rate. In one example if the code rate reaches the maximum value for UCI and/or UL-SCH and

$${N}_{RE}^{UL - SCH} + {N}_{RE}^{UCI} > {N}_{RE}^{PUSCH} ,$$

the UE drops UL-SCH data or UCI data in order of priority, starting with the lowest priority until

$${N}_{RE}^{UL - SCH} + {N}_{RE}^{UCI}$$

is no longer larger than

$${N}_{RE}^{PUSCH} .$$

In one example, the maximum code rate for UCI and maximum code rate for UL-SCH are the same. In one example, the maximum code rate for UCI and maximum code rate for UL-SCH can be different. In one example, the maximum code rate is the same for blocks of UCI and/or UL-SCH. In one example, the maximum code rate can be different for each block (e.g., the maximum code rate can depend on the priority of the block of UCI and/or UL-SCH). In one example, the maximum code rate for UCI and/or UL-SCH and/or a block(s) of UCI or UL-SCH can be configured and/or updated by RRC and/or SIB and/or MAC CE and/or L1 control (e.g., DCI Format) signaling.

In one example, if UCI has a lower priority than UL-SCH, UCI code rate is adjusted so that UCI and UL-SCH fit within the allocated resources. In one example, if UCI has a lower priority than UL-SCH, UCI code rate is adjusted first so that UCI and UL-SCH fit within the allocated resources and the code rate of UCI doesn't exceed a maximum value. In one example, if the code rate of UCI reaches the maximum value and

$${N}_{RE}^{UL - SCH} + {N}_{RE}^{UCI} > {N}_{RE}^{PUSCH} ,$$

the UL drops UCI or part of the UCI (e.g., in order of priority starting with the lowest priority until

$${N}_{RE}^{UL - SCH} + {N}_{RE}^{UCI}$$

is no longer larger than

$${N}_{RE}^{PUSCH} .$$

In one example, if the code rate of UCI reaches the maximum value and

$${N}_{RE}^{UL - SCH} + {N}_{RE}^{UCI} > {N}_{RE}^{PUSCH} ,$$

the UL-SCH code rate is adjusted so that UCI and UL-SCH fit within the allocated resources. In one example, if the code rate of UCI reaches the maximum value and

$${N}_{RE}^{UL - SCH} + {N}_{RE}^{UCI} > {N}_{RE}^{PUSCH} ,$$

the UL-SCH code rate is adjusted so that UCI and UL-SCH fit within the allocated resources and the code rate of UL-SCH doesn't exceed a maximum value. In one example, if the code rate of UL-SCH reaches the maximum value and

$${N}_{RE}^{UL - SCH} + {N}_{RE}^{UCI} > {N}_{RE}^{PUSCH} ,$$

UE drops UL-SCH data or UCI data in order of priority, starting with the lowest priority until

$${N}_{RE}^{UL - SCH} + {N}_{RE}^{UCI}$$

is no longer larger than

$${N}_{RE}^{PUSCH} .$$

In one example, the maximum code rate for UCI and maximum code rate for UL-SCH are the same. In one example, the maximum code rate for UCI and maximum code rate for UL-SCH can be different. In one example, the maximum code rate for UL-SCH and/or the maximum code rate for UCI can be configured and/or updated by RRC and/or SIB and/or MAC CE and/or L1 control (e.g., DCI Format) signaling.

In one example, if UL-SCH has a lower priority than UCI, UL-SCH code rate is adjusted so that UCI and UL-SCH fit within the allocated resources. In one example, if UL-SCH has a lower priority than UCI, UL-SCH code rate is adjusted first so that UCI and UL-SCH fit within the allocated resources and the code rate of UL-SCH doesn't exceed a maximum value. In one example, if the code rate of UL-SCH reaches the maximum value and

$${N}_{RE}^{UL - SCH} + {N}_{RE}^{UCI} > {N}_{RE}^{PUSCH} ,$$

the UE drops UL-SCH or part of the UL-SCH (e.g., in order of priority starting with the lowest priority until

$${N}_{RE}^{UL - SCH} + {N}_{RE}^{UCI}$$

is no longer larger than

$${N}_{RE}^{PUSCH} .$$

In one example, it the code rate of UL-SCH reaches the maximum value and

$${N}_{RE}^{UL - SCH} + {N}_{RE}^{UCI} > {N}_{RE}^{PUSCH} ,$$

the UCI code rate is adjusted so that UCI and UL-SCH fit within the allocated resources. In one example, if the code rate of UL-SCH reaches the maximum value and

$${N}_{RE}^{UL - SCH} + {N}_{RE}^{UCI} > {N}_{RE}^{PUSCH} ,$$

the UCI code rate is adjusted so that UCI and UL-SCH fit within the allocated resources and the code rate of UCI doesn't exceed a maximum value. In one example, if the code rate of UCI reaches the maximum value and

$${N}_{RE}^{UL - SCH} + {N}_{RE}^{UCI} > {N}_{RE}^{PUSCH} ,$$

UE drops UL-SCH data or UCI data in order of priority, starting with the lowest pointy until

$${N}_{RE}^{UL - SCH} + {N}_{RE}^{UCI}$$

is no longer larger than

$${N}_{RE}^{PUSCH} .$$

In one example, the maximum code rate for UCI and maximum code rate for UL-SCH are the same. In one example, the maximum code rate for UCI and maximum code rate for UL-SCH can be different. In one example, the maximum code rate for UL-SCH and/or the maximum code rate for UCI can be configured and/or updated by RRC and/or SIB and/or MAC CE and/or L1 control (e.g., DCI Format) signaling.

In a variant example, there are multiple UCI blocks or UCI Types with different priorities and/or there are multiple UL-SCH blocks with different priorities.

In one example, starting with a first block, wherein the first block is a UCI block/Type or UL-SCH block with the lowest priority, the UE drops the first block or part of the first block until

$${N}_{RE}^{UL - SCH} + {N}_{RE}^{UCI}$$

is no longer larger than

$${N}_{RE}^{PUSCH} .$$

In one example, starting with a first block, wherein the first block is a UCI block/Type or UL-SCH block with the lowest priority, the code rate of the first block is adjusted first so that UCI and UL-SCH fit within the allocated resources. In one example, starting a first block, wherein the first block is a UCI block/Type or UL-SCH block with the lowest priority, the code rate of the first block is adjusted first so that UCI and UL-SCH fit within the allocated resources and the code rate of the first block doesn't exceed a maximum value. In one example, if the code rate of the first block reaches the maximum value and

$${N}_{RE}^{UL - SCH} + {N}_{RE}^{UCI} > {N}_{RE}^{PUSCH} ,$$

the UE drops the first block or part of the first block until

$${N}_{R E}^{U L - S C H} + {N}_{R E}^{UCI}$$

is no longer larger than

$${N}_{R E}^{PUSCH} .$$

In one example, if the code rate of the first block reaches the maximum value or the first block is dropped and

$${N}_{R E}^{UL - SCH} + {N}_{R E}^{UCI} > {N}_{R E}^{PUSCH} ,$$

the UE selects a second block wherein the second block is next UCI block/Type or UL-SCH block with the next lowest priority and repeats one or more of the examples herein for the second block, and so on for other blocks until

$${N}_{R E}^{UL - SCH} + {N}_{R E}^{UCI}$$

is no longer larger than

$${N}_{R E}^{PUSCH} .$$

In one example, the maximum code rate is the same for blocks. In one example the maximum code rate can be different for each block (e.g., the maximum code rate can depend on the priority of the block). In one example, the maximum code rate for a block or for all blocks can be configured and/or updated by RRC and/or SIB and/or MAC CE and/or L1 control (e.g., DCI Format) signaling.

In one example, the UE can indicate in Information A, the payload size of UCI and/or UL-SCH and/or number of REs used for UCI and/or number of REs used for UL-SCH. In one example, the UE can indicate in Information A, the payload size of a UCI block/type and/or UL-SCH block and/or number of REs used for a UCI block/type and/or number of REs used for UL-SCH block. In one example, the UE can indicate in Information A, the code rate for UCI and/or the code rate for UL-SCH. In one example, the UE can indicate in Information A, the code rate for a UCI block/type and/or the code rate for a UL-SCH block. In one example, the UE can indicate in Information A, the lowest priority data included in UCI. In one example, the UE can indicate in Information A, the lowest priority data included in UL-SCH.

In the example mentioned herein, a number of REs can be configured or indicated to the UE (or determined by the UE) for UCI

$$( e . g . , {N}_{R E - c}^{UCI} ) ,$$

and/or a number of KES can be configured or indicated to the UE (or determined by the UE) for UL-SCH

$$( e . g . , {N}_{R E - c}^{UL - SCH} ) .$$

In one example,

$${N}_{R E - c}^{UCI} + {N}_{R E - c}^{U L - SCH} = {N}_{R E}^{PUSCH} .$$

In a variant example, UL channel is used for UCI and not for UL-SCH, e.g., P_{UL-SCH}=0, and

$${N}_{R E - c}^{U L - SCH} = 0 , and {N}_{R E - c}^{UCI} = {N}_{R E}^{PUSCH} .$$

In one example, the UE (e.g., the UE 116) determines the transport block(s) size, e.g., P_{UL-SCH} based on a

$${N}_{R E - c}^{UL - SCH} or {N}_{R E}^{PUSCH} - {N}_{R E - c}^{UCI}$$

and a code rate, modulation order and/or number of layers signaled/indicated/configured to the UE (e.g., based on MCS and/or number of layers/rank).

In one example, the physical layer has UCI data to transmit of size P_{UCI}. In one example, the UE determines a code rate for UCI data (e.g., based on a beta offset and a code rate of PUSCH data (e.g, that can be calculated from P_{UL-SCH} and

$${N}_{R E - c}^{U L - SCH} ) ) .$$

In one the number of REs required to transmit UCI exceeds the number of REs available for transmission of UCI

$$( e . g . , {N}_{R E - c}^{UCI} ) ,$$

the UE can follow one of the following examples.

In one example, the UE drops UCI data (e.g., UCI blocks/types or part thereof) in order of priority, starting with the lowest priority until UCI data can fit in resources

$${N}_{R E - c}^{UCI}$$

with the determined code rate.

In one example, the UE adjusts the code rate of UCI data so that UCI can fit in the resources

$${N}_{R E - c}^{UCI} .$$

In one example, the UE (1) adjusts the code rate of UCI and/or (2) drops UCI data (e.g., UCI blocks/types or part thereof) in order of priority, starting with the lowest priority so that UCI can fit in the resources

$${N}_{R E - c}^{UCI} .$$

In one example, the UE (1) adjusts the code rate of UCI up to a maximum code rate so that UCI can fit in the resources

$${N}_{R E - c}^{UCI}$$

and/or (2) after the maximum code rate is reached, drops UCI data in order of priority, starting with the lowest priority so that UCI can fit in the resources

$${N}_{R E - c}^{UCI} .$$

In one example, the maximum code rate for is the same for UCI blocks/types. In one example, the maximum code rate can be different for each UCI block/type (e.g., the maximum code rate can depend on the priority of the UCI block/type). In one example, the maximum code rate for UCI and/or UCI block(s)/type(s) can be configured and/or updated by RRC and/or SIB and/or MAC CE and/or L1 control (e.g., DCI Format) signaling.

In one example, BS and UE follow the same rules to determine the maximum code rate and/or the information to drop e.g., based on priority to fit within the allocated resources for UCI and/or UL-SCH.

In one example, the UE can signal assistance information in Information A so that the BS (e.g., the BS 102) receiver can determine (1) size of UCI payload and/or (2) code rate for UCI. In one example, the UE can indicate in Information A, the payload size of UCI. In one example, the UE can indicate in Information A, the payload size of a UCI block/type. In one example, the UE can indicate in Information A, the code rate for UCI. In one example, the UE can indicate in Information A, the code rate for a UCI block/type. In one example, the UE can indicate in Information A, the lowest priority data included in UCI.

In a variant of the examples herein, the UE can determine the maximum code rate for UCI and/or UL-SCH, e.g., based on the channel conditions. In one example, the UE can signal the maximum code rate in information A.

In this disclosure the configuration and indication of a flexible uplink transmission resource, e.g., PUSCH, is provided wherein the amount of time and/or frequency resources used is flexible, and can be determined by UE for example, the determination can be based on (1) the amount of traffic including UL-SCH and/or UCI the UE has to transmit and/or (2) the channel conditions which can determine a code rate for the traffic transmission.

When the network (e.g., the network 130) schedules or configures resources for uplink transmission, the amount of data the UE has to transmit can be unknown to the network. Data can include control information in UCI and/or user data in UL-SCH. It would seem reasonable that resources scheduled or configured to the UE can be flexible or dynamic or adaptable or elastic, whereby the UE can determine the amount of resources for the uplink transmission (e.g., PUSCH) based on the amount of data (UCI and/or UL-SCH) the UE has to transmit and/or the channel conditions which can determine the code rate for the UL data transmissions.

When the network schedules or configures or allocates resources for UL transmission, it may know the amount of data the UE has to transmit. In one example, with UE initiated reporting or UE initiated transmission, the UE may initiate a transmission of CSI report, beam management report or other type of reports that the network is not aware of. In another example, the size of the report can vary depending on the channel conditions. For example, in NR, the size of the UCI payload can vary depending on the rank of the channel (number of layers spatially multiplexed on to the same resources. As an example Table 1 illustrates the dependence of wideband PMI on overhead for Rel-15 Type-1 single-panel (SP) WB when (N₁, N₂)=(4,4), and Rel-19 eType SP WB when (N₁, N₂)=(4,4). The WB CQI is 4 bits, the WB RI is 2 or 3 bits, hence for Rel-19 the maximum WB report size for rank indicator (RI)/precoding matrix indicator (PMI)/channel quality indicator (CQI) is 4+3+36=43, and the minimum WB report size for RI/PMI/CQI is 4+3+12=19. The maximum number of CSI reports is 48 (e.g., based on IE maxNrofCSI-ReportConfigurations). The maximum CSI payload size is 48×43=2064 bits. While the minimum CSI payload size is 48×19=912 bits. This variability in payload size is just for WB reporting, based RI, SB reporting can further increase the UCI payload size and lead to variability.

TABLE 5
Wideband PMI overhead

| | | RI = 1 | RI = 2 | RI = 3 | RI = 4 | RI = 5 | RI = 6 | RI = 7 | RI = 8 |
|---|---|---|---|---|---|---|---|---|---|
| Rel-15 Type-I SP WB | Mode 1 | 10 | 11 | 10 | 10 | 9 | 9 | 9 | 9 |
| with (N₁, N₂) = (4, 4) | Mode 2 | 10 | 11 | 10 | 10 | 9 | 9 | 9 | 9 |
| Rel-19 eType-I SP WB | Mode A | 12 | 13 | 13 | 13 | 28 | 28 | 36 | 36 |
| with (N₁, N₂) = (8, 8) | Mode B | 12 | 20 | 28 | 28 | 26 | 26 | 32 | 32 |

Additionally, the amount of uplink resources used for transmission can vary depending on the channel conditions and the code rate used, which can be determined, at least in part by the UE for example based on the measurement of the DL channel and expecting some type of reciprocity at the UE.

The resources allocated to the UE for UL transmission, can correspond to different resource allocation sizes, and the UE decides which resource allocation size to use based on the amount of uplink resources the UE determines for an UL transmission.

As the UCI payload changes (e.g., increases), the number of REs used for UCI in the PUSCH channel increases, leaving less REs for UL-SCH, which in turn increases the code rate of the UL-SCH. In this disclosure, how to multiplex UCI with a variable payload with UL-SCH channel in PUSCH is provided.

The present disclosure relates to a 5G/NR and/or 6G communication system.

This disclosure provides aspects related to resource allocation for UL transmissions from the UE, wherein the UE is configured UL resources with different resource allocation amounts, and the UE decides on the resources to use for UL transmission. The following aspects are provided:
The configuration or allocation of UL resources with different resource allocation amounts.
How the UE determines the amount of UL resources and consequently the UL resource to use.
Signaling of the amount of UL resources (or UL resource used) and other transmission parameters from the UE to the network.

In the following, both FDD and TDD are regarded as a duplex method for DL and UL signaling. In addition, full duplex (XDD) operation is feasible, e.g., sub-band full duplex (SBFD) or single frequency full duplex (SFFD).

Although exemplary descriptions and embodiments to follow expect orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure provides several components that can be used in conjunction or in combination with one another, or can operate as standalone schemes.

In this disclosure, RRC signaling (e.g., configuration by RRC signaling) includes (1) common information provided by common signaling, e.g., this can be system information block (SIB)-based RRC signaling (e.g., SIBI or other SIB) or (2) RRC dedicated signaling that is sent to a specific UE wherein the information can be common/cell-specific information or dedicated/UE-specific information or (3) UE-group RRC signaling.

In this disclosure MAC CE signaling can be UE-specific e.g., to one UE and can be UE common (e.g., to a group of UEs or UEs in a cell). MAC CE signaling can be DL MAC CE signaling or UL MAC CE signaling.

In this disclosure L1 control signaling includes: (1) DL control information (e.g., DCI on PDCCH or DL control information on PDSCH) and/or (2) UL control information (e.g., UCI on PUCCH or PUSCH). L1 control signaling be UE-specific e.g., to one UE and can be UE common (e.g., to a group of UEs or to all UEs in a cell).

In this disclosure, configuration can refer to configuration by semi-static signaling (e.g., RRC or SIB signaling). In one example, a configuration can be applicable to multiple transmission instances, until a configuration is received and applied.

In this disclosure, indication can refer to indication by dynamic signaling (e.g., L1 control (e.g., DCI Format) or MAC CE signaling). In one example, an indication can be for an associated occasion(s) (e.g., an occasion or multiple occasions associated with the indication).

In this disclosure a list with N elements or entries can be denoted as L (i), where i can take N values, and L (i) can correspond to the element or entry associated with index i. In one example, i can take N arbitrary values. In one example, i=0, 1, . . . , N−1. In one example, i=1, 2, . . . , N. In one example, i is an identity of an element or entry in the list.

In the present disclosure, the term “activation” describes an operation wherein a UE receives and decodes first information provided by a first signal from the network (or BS) and, based on the first information, the UE determines a starting point in time. The starting point can be a present or a future slot/subframe or symbol and the exact location is either implicitly or explicitly indicated, or is otherwise defined in the system operation or is configured by higher layers. Upon successfully decoding the first information, the UE responds according to an indication provided by the first information. The term “deactivation” describes an operation wherein a UE receives and decodes second information provided by a second signal from the network (or BS) and, based on the second information from the signal, the UE determines a stopping point in time. The stopping point can be a present or a future slot/subframe or symbol and the exact location is either implicitly or explicitly indicated, or is otherwise defined in the system operation or is configured by higher layers. Upon successfully decoding the second information, the UE responds according to an indication provided by the second information. The first signal can be same as the second signal or the first information can be same as the second information, wherein a first part of the information can be associated with an “activation” operation and with first UEs or with first parameters for transmissions/receptions by a UE, and a second part of the information can be associated with a “deactivation” operation and with second UEs or with second parameters for transmissions/receptions by the UE. For example, the second information can be absent, and deactivation can be implicitly derived. For example, when a UE has received an activation information in a previous indication, and is not included among UEs with activation information in a next indication, the UE can determine the latter indication as an implicit deactivation indication.

In this disclosure, a time unit, for example, can be a symbol or a slot or sub-frame or a frame. In one example, a time-unit can be multiple symbols, or multiple slots or multiple sub-frames or multiple frames. In one example, a time-unit can be a sub-slot (e.g., part of a slot). In one example, a time-unit can be specified in units of time, e.g., microseconds, or milliseconds or seconds, etc.

In this disclosure, a frequency-unit, for example, can be a sub-carrier or a resource block (RB) or a sub-channel, wherein a sub-channel is a group or RBs, or a bandwidth part (BWP). In one example, a frequency-unit can be multiple sub-carriers, or multiple RBs or multiple sub-channels. In one example, a frequency-unit can be a sub-RB (e.g., part of a RB). A frequency-unit can be specified in units of frequency, e.g., Hz, or kHz or MHz, etc.

Terminology such as UCI, MAC CE, PUCCH, PUSCH, transport block and other terms are used for illustrative purposes and is therefore not normative. Other terms that refer to same functions can also be used.

In this disclosure, UL control information can include the following UL control information types:
HARQ-ACK for DL transport blocks.
Scheduling request (SR).
Channel state information (CSI). In one example, CSI can be a single part CSI. In another example, CSI can be a two-part CSI, e.g., a first part CSI and a second part CSI.
Link recovery request (LRR), this can be similar to SR.
UE initiated beam indication/report (introduced in 3GPP Rel-19).
Transport format indication information, e.g., indicating modulation coding scheme, and/or transport block size and/or resource allocation and/or HARQ related parameters and/or MIMO related parameters of data conveyed in the UL physical channel.

In one example, the information corresponding to each of the UL control information types mentioned herein can be transmitted independently, e.g., the information for each UL control information type is separately encoded and multiplexed or mapped onto the physical UL channel e.g., PUSCH.

In another example, information corresponding to each of the UL control information types mentioned herein can be first multiplexed, and then jointly encoded, rate-matched, scrambled and/or modulated and mapped to resource elements of the corresponding physical UL channel. For example, in NR, when CSI has one part, the HARQ-ACK, SR and CSI information are multiplexed, and jointly pass through the encoding and transmission stages and are transmitted on PUCCH.

In another example, the UL control information (UCI) types are divided into groups, where information corresponding to each group of UL control information types can be first multiplexed, and then jointly encoded, rate-matched, scrambled and/or modulated and mapped to resource elements of the corresponding physical UL channel. For example, in NR, when CSI has two parts, the HARQ-ACK, SR and CSI information are multiplexed to give first part of UCI, and jointly pass through the encoding and transmission stages and are transmitted on PUCCH. The second part CSI can be separately encoded and mapped to the remaining PUCCH resources. UL control information types that are multiplexed together and jointly encoded and transmitted can have similar transport characteristics.

UCI is transmitted in an uplink physical channel (e.g., physical uplink shared channel (PUSCH) or physical uplink control channel (PUCCH)). In this disclosure without loss of generality and for brevity, the physical channel used for UCI is referred to as PUSCH. In one example, UCI is transmitted by itself (e.g., standalone) in PUSCH. In another example UCI is transmitted with uplink shared channel (UL-SCH) in PUSCH.

In one example, a PUSCH can be scheduled or allocated dynamically, e.g., PUSCH is scheduled by a DCI Format (e.g., UL related DCI Format, e.g., DCI Format 0_0 or DCI Format 0_1 or DCI Format 0_2, . . . ). Wherein, the UL related DCI Format can indicate, (1) the time and frequency resources of PUSCH, (2) the modulation coding scheme (MCS) of the PUSCH, which determines the modulation order and the code rate of the transmission and can determine the transport block size based on the amount of time and frequency resources, (3) HARQ related information such as HARQ process number, redundancy version (RV), and new data indicator, the DCI Format can also indicate, the rank of the PUSCH transmission, and precoding related information including SRS related information.

In one example, the PUSCH can be allocated semi-statically, e.g., by higher layer (for example RRC) signaling. Wherein, the RRC configuration can indicate, (1) the time and frequency resources of PUSCH including periodicity/offset of PUSCH occasions, (2) the modulation coding scheme (MCS) of the PUSCH, which determines the modulation order and the code rate of the transmission and can determine the transport block size based on the amount of time and frequency resources, (3) rank and precoding related information including SRS related information.

In one example, the semi-static PUSCH can be PUSCH configured grant Type 1 (CG Type1), wherein the PUSCH becomes active when configured.

In one example, the semi-static PUSCH can be PUSCH configured grant Type 2 (CG Type2), wherein RRC signaling configures the PUSCH, additional dynamic signaling (e.g., L1 control (DCI Format), or MAC CE signaling) can further activate or deactivate the configured PUSCH occasions to use or not to use respectively.

In one example, the following information is presented to physical layer for encoding, modulation and transmission as illustrated in FIG. 12:
UL control information (UCI), wherein UCI can be according to the types mentioned herein. In one example, each UCI type has a bit stream. In one example, a UCI type can have multiple bit streams, for example for CSI, there can be CSI-part1 and CSI-part2. In one example, there are multiple bit streams, and a bit stream can include one or more UCI types, for example, a first bit stream for HARQ-ACK and CSI-part1, and a second bit stream for CSI-part2. In one example, there is one-bit stream for UCI multiplexed on PUSCH, e.g., UCI information (e.g., HARQ-ACK and/or CSI) is multiplexed into one-bit stream. In one example, the size of the UCI payload for each type can vary for example, depending on the channel conditions.
UL shared channel (UL-SCH). In one example, UL-SCH is one transport block (e.g., when the number of spatial layers is 1 to 4). In one example, UL-SCH is two transport blocks (e.g., when the number of spatial layers is 5 to 8).

In the following examples of this disclosure, UCI can refer to UCI information presented to the physical layer for transmission, or UCI can refer to certain UCI type(s), e.g., UCI can refer to CSI information.

In the following examples, the amount of UCI information to transmit can be determined by the UE and can vary from one PUSCH transmission to the next. In one example, the determination can be based on channel conditions, for example, the rank of the channel changes the UCI payload as mentioned herein. In one example, the transmission of UCI is UE initiated, the UE can autonomously determine when to transmit UCI based on a condition.

In the following examples, the code rate for the UL transmission (e.g., PUSCH or PUCCH) can be determined by the UE, for example based on the channel conditions the UE measures on the downlink. In one example, the code rate for UL transmission can be additionally configured or indicated not to exceed a maximum value. In one example, the code rate for UL transmission can be additionally configured or indicated not to be less than a minimum value.

In one example, the UE (e.g., the UE 116) can determine the amount of resources for an uplink transmission and indicate that amount or the resources used to the network (e.g., the network 130).

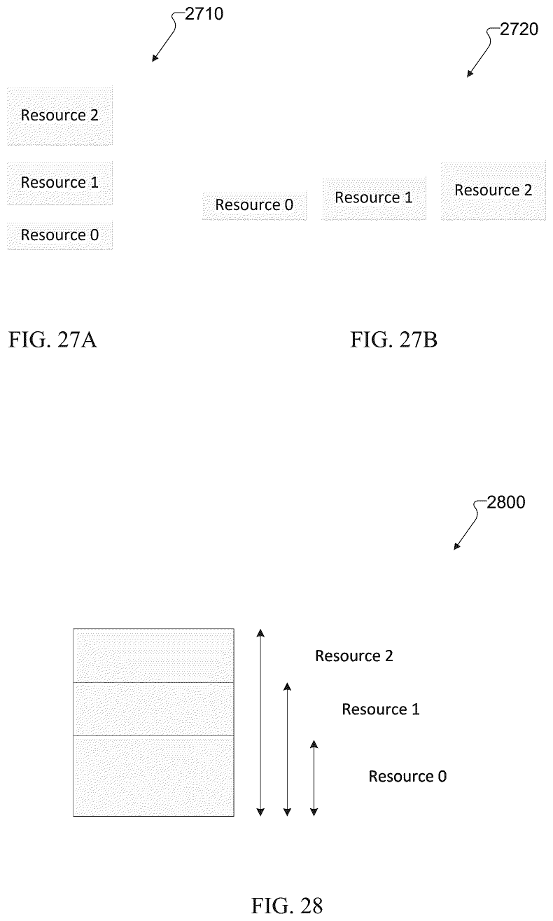

FIGS. 27A and 27B illustrate an example UL resource configuration 2710 and 2720 according to embodiments of the present disclosure. For example, UL resource configuration 2710 and 2720 can be utilized by any of the UEs 111-116 of FIG. 1, such as the UE 115. This example is for illustration only and other embodiments can be used without departing from the scope of the present disclosure.

In the following examples, a resource allocation can be:
A resource allocation in the frequency domain (e.g., in sub-carriers, or resource blocks (RBs), or sub-channels (where a sub-channel is a number of RBs) or resource block groups (RBGs), or frequency units)
A resource allocation in the time domain (e.g., in symbols or slots or time units)
A resource allocation in the frequency domain as mentioned herein and a resource allocation in the time domain as mentioned herein.

In one example, multiple resources can be configured for UL transmissions, e.g., PUSCH (e.g., CG Type1 or CG Type2). In one example, multiple resources can be indicated for UL transmissions, e.g., PUSCH (e.g., dynamic PUSCH indicated by UL related DCI Format).

In one example, the multiple resources can have different resource amounts (e.g., different number of REs). In one example, the UE determines the amount of resources to be used for an UL transmission, and determines an UL resource that has a sufficient number of resources as explained later in this disclosure.

In one example, the UL resources with different resource amounts are non-overlapping for example, illustrated in FIG. 27(A) and FIG. 27(B).

FIG. 28 illustrates an example UL resource configuration 2800 according to embodiments of the present disclosure. For example, UL resource configuration 2800 can be utilized by any of the UEs 111-116 of FIG. 1, such as the UE 116. This example is for illustration only and other embodiments can be used without departing from the scope of the present disclosure.

In one example, the UL resources with different resource amounts have overlapping resource for example, illustrated in FIG. 28. In the example of FIG. 28, there are three resources, “Resource 0”, “Resource 1” and “Resource 2”, the resources have a same starting resource, but different resource allocation sizes.

In one example, the UE is configured or indicated a starting resource (e.g., a starting RB in frequency domain or a starting symbol in time domain). In one example, the UE is configured or indicated or determines multiple resource allocation sizes (e.g., N resource allocation sizes from resource allocation size 0 to resource allocation size N−1).

In one example, the UE determines N resource allocation sizes within a range from minimum resource allocation size, to maximum resource allocation size.

A UE can determine the maximum resource allocation size. In one example, the UE is indicated the maximum resource allocation size. In one example, the UE is configured the maximum resource allocation size. In one example, the UE determines the maximum resource allocation based on an offset from the minimum resource allocation size, e.g.,

$$Maximum resource allocation size = Minimum resource allocation + Offset .$$

In one example, the “Offset” is defined in the system specifications. In one example, the “Offset” is a function of (or depends on) the size of the minimum resource allocation. In one example, the UE is configured the “Offset”, or a parameter to determine the “Offset”. In one example, the UE is indicated the “Offset”, or a parameter to determine the “Offset”.

A UE can determine the minimum resource allocation size. In one example, the UE is indicated the minimum resource allocation size. In one example, the UE is configured the minimum resource allocation size. In one example, the UE determines the minimum resource allocation based on an offset from the maximum resource allocation size, e.g.,

$$Minimum resource allocation size = Maximum resource allocation - Offset .$$

In one example, the “Offset” is defined in the system specifications. In one example, the “Offset” is a function of (or depends on) the size of the maximum resource allocation. In one example, the UE is configured the “Offset”, or a parameter to determine the “Offset”. In one example, the UE is indicated the “Offset”, or a parameter to determine the “Offset”.

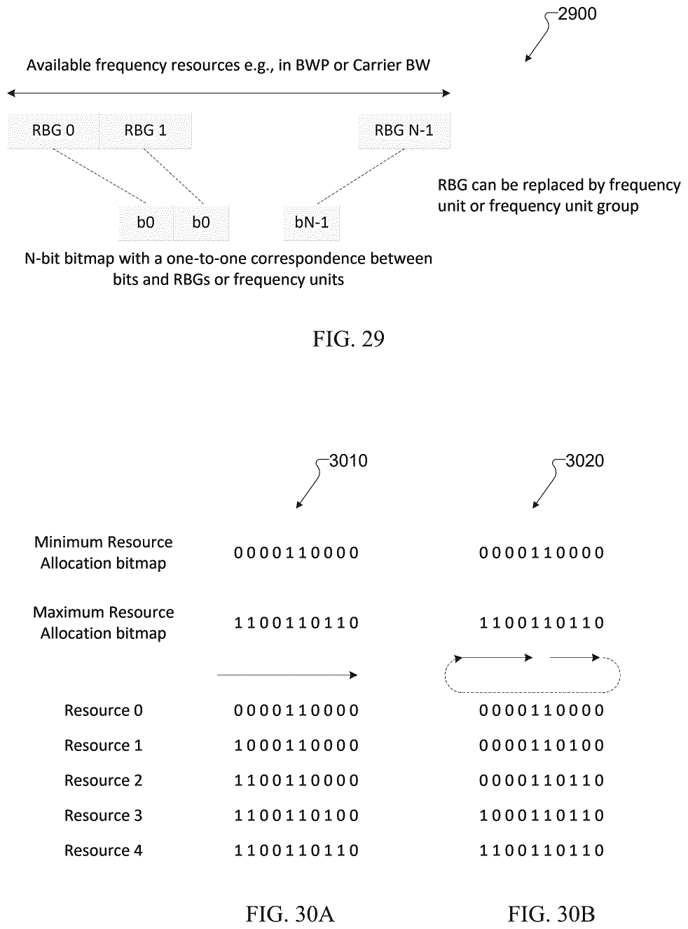

FIG. 29 illustrates an example available frequency resource configuration 2900 according to embodiments of the present disclosure. For example, frequency resource configuration 2900 can be utilized by the UE 116 of FIG. 3. This example is for illustration only and other embodiments can be used without departing from the scope of the present disclosure.

In one example, for frequency domain resources, the UE is configured or indicated frequency domain resources using frequency domain resource allocation type 0. In one example, for resource allocation type 0, the UE is indicated a bitmap, with a size equal to the number of RBGs, and a one-to-one correspondence between each bit in the bitmap and a corresponding RBG in the resource grid as illustrated in FIG. 29. In one example, if a bit in the bitmap is “1”, the UL transmission uses the corresponding RBG. In one example, if a bit in the bitmap is “0”, the UL transmission doesn't use the corresponding RBG. In one example, a UE is indicated or configured a bitmap with a minimum frequency domain resource allocation, e.g., a minimum number of “1”'s in the bitmap for an UL transmission. In one example, a UE is indicated or configured a bitmap with a maximum frequency domain resource allocation, e.g., a maximum number of “1”'s in the bitmap for an UL transmission. In one example, the “1”'s in the minimum resource allocation bitmap are a subset of the “1”'s in the maximum resource allocation bitmap.

FIGS. 30A and 30B illustrate an example UL transmission resource configuration 3010 and 3020 according to embodiments of the present disclosure. For example, any of the UEs 111-116 of FIG. 1, such as the UE 111, can be configured by the UL transmission resource configuration 3010 and 3020. This example is for illustration only and other embodiments can be used without departing from the scope of the present disclosure.

In one example, K uplink transmission resources are determined based on the minimum resource allocation bitmap and maximum resource allocation bitmap. In one example, Nₙ is the number of ones in the minimum resource allocation bitmap and Ny is the number of ones in the maximum resource allocation bitmap. In one example, K=Nₓ−Nₙ+1. In one example, resource 0, has No one's in the resource allocation bitmap (e.g., the minimum resource allocation bitmap), resource k has Nₙ+k one's in the resource allocation bitmap, for k=0, 1, . . . . K−1, resource K−1, has Nₓ one's in the resource allocation bitmap (e.g., the maximum resource allocation bitmap). In one example, the order of adding one's to the bitmap, can be in order of increasing bit index in bitmap (MSB bit in bitmap has index 0 and LSB bit in bitmap has largest index), for bits that are “1” in the maximum resource allocation bitmap starting from the MSB (bit with index 0), this is illustrated by way of example in FIG. 30(A). In one example, the order of adding one's to the bitmap, can be in order of increasing bit index in bitmap (MSB bit in bitmap has index 0 and LSB bit in bitmap has largest index), for bits that are “1” in the maximum resource allocation bitmap starting from the bit to the right of the LSB that is 1 in the minimum resource allocation, and then wrapping around from LSB to MSB when reaching the LSB, this is illustrated by way of example in FIG. 30(B). Other methods for determining the K resources are feasible. In variant examples, resource 0, has Nₓ one's in the resource allocation bitmap (e.g., the maximum resource allocation bitmap), resource k has Nₓ−k one's in the resource allocation bitmap, for k=0, 1, . . . . K−1, resource K−1, has Nₘ one's in the resource allocation bitmap (e.g., the minimum resource allocation bitmap), resources are generated starting from the maximum resource allocation and removing bits in the bitmap till the minimum resource allocation.

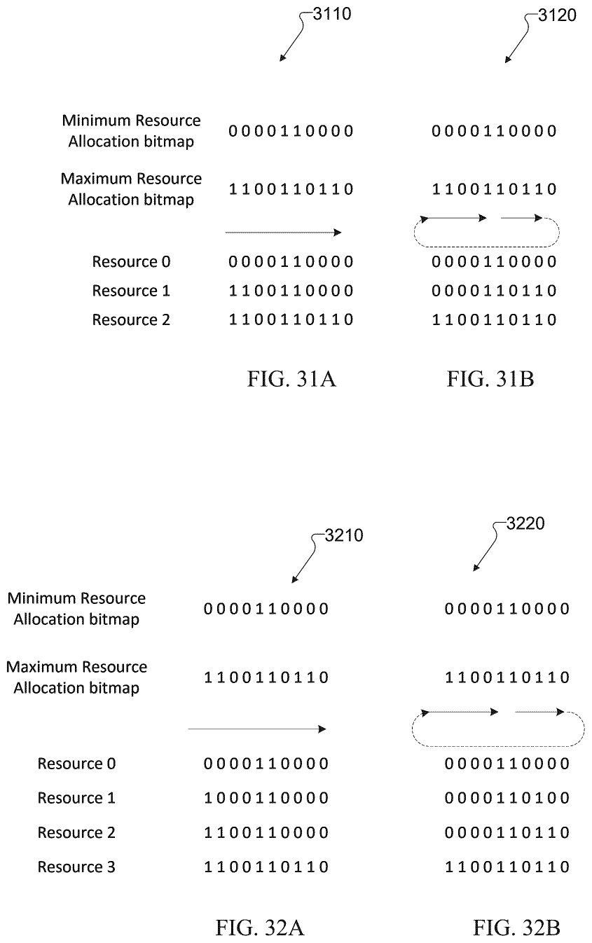

FIGS. 31A and 31B illustrate an example UL transmission resource configuration 3110 and 3120 according to embodiments of the present disclosure. For example, any of the UEs 111-116 of FIG. 1, such as the UE 112, can be configured by the UL transmission resource configuration 3110 and 3120. This example is for illustration only and other embodiments can be used without departing from the scope of the present disclosure.

In one example, resource k+1 has d more ones than resource k. In one example, resource k+1 has d less ones than resource k. In one example, d can be defined in the system specifications, for example d=2 or d=1. In one example, d is indicated to the UE. In one example, d is configured to the UE. In one example, the number of resources K is given by:

$$K = ⌊ \frac{{N}_{x} - {N}_{n}}{d} ⌋ + 1.$$

In one example, resource 0, has Nₙ one's in the resource allocation bitmap (e.g., the minimum resource allocation bitmap), resource k has Nₙ+d·k one's in the resource allocation bitmap, for k=0, 1, . . . . K−1. In one example, the order of adding one's to the bitmap, can be in order of increasing bit index in bitmap (MSB bit in bitmap has index 0 and LSB bit in bitmap has largest index), for bits that are “1” in the maximum resource allocation bitmap starting from the MSB (bit with index 0), this is illustrated by way of example in FIG. 31(A), with d=2. In one example, the order of adding one's to the bitmap, can be in order of increasing bit index in bitmap (MSB bit in bitmap has index 0 and LSB bit in bitmap has largest index), for bits that are “1” in the maximum resource allocation bitmap starting from the bit to the right of the LSB that is 1 in the minimum resource allocation, and then wrapping around from LSB to MSB when reaching the LSB, this is illustrated by way of example in FIG. 31(B), with d=2. Other methods for determining the K resources are feasible. In variant examples, resource 0, has Nₓ one's in the resource allocation bitmap (e.g., the maximum resource allocation bitmap), resource k has Nₓ−d·k one's in the resource allocation bitmap, for k=0, 1, . . . . K−1, resource K−1, has Nₘ one's in the resource allocation bitmap (e.g., the minimum resource allocation bitmap), resources are generated starting from the maximum resource allocation and removing bits in the bitmap till the minimum resource allocation.

FIGS. 32A and 32B illustrate an example UL transmission resource configuration 3210 and 3220 according to embodiments of the present disclosure. For example, any of the UEs 111-116 of FIG. 1, such as the UE 112, can be configured by the UL transmission resource configuration 3210 and 3220. This example is for illustration only and other embodiments can be used without departing from the scope of the present disclosure.

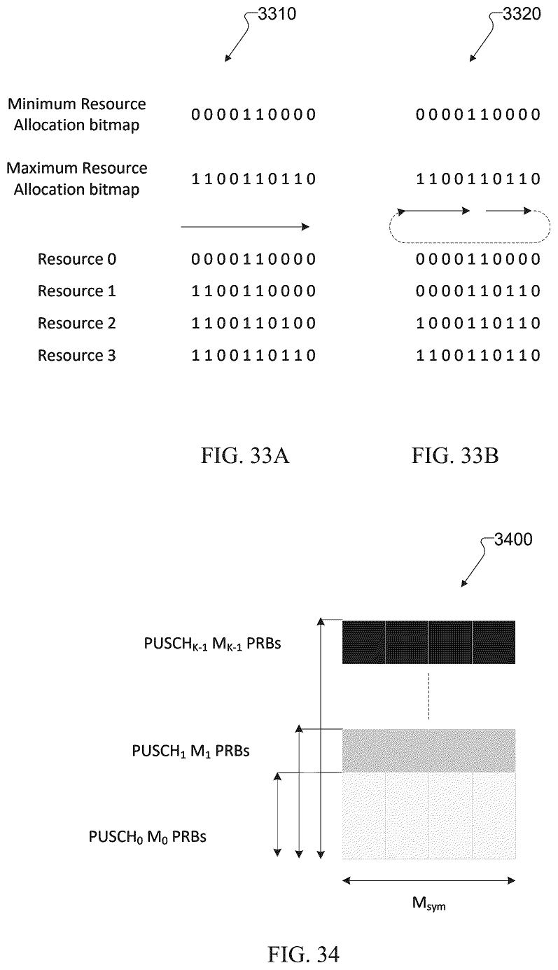

FIGS. 33A and 33B illustrate an example UL transmission resource configuration 3310 and 3320 according to embodiments of the present disclosure. For example, any of the UEs 111-116 of FIG. 1, such as the UE 112, can be configured by the UL transmission resource configuration 3310 and 3320. This example is for illustration only and other embodiments can be used without departing from the scope of the present disclosure.

In one example, there are K UL transmission resources. In one example, K can be defined in the system specifications, for example K=4 or K=6. In one example, K is indicated to the UE. In one example, K is configured to the UE. In one example, resource 0, has Nₙ one's in the resource allocation bitmap (e.g., the minimum resource allocation bitmap). In one example, resource K−1, has Nₓ one's in the resource allocation bitmap (e.g., the maximum resource allocation bitmap). In one example, resource k has

$${N}_{n} + ⌊ k \frac{{N}_{x} - {N}_{n}}{K - 1} ⌋$$

one's in the resource allocation bitmap, for k=0, 1, . . . . K−1, as illustrated in FIG. 32A/B with K=4. In one example, resource k has

$${N}_{n} + ⌈ k \frac{{N}_{x} - {N}_{n}}{K - 1} ⌉$$

one's in the resource allocation bitmap, for k=0, 1, . . . . K−1, as illustrated in FIG. 33A/B with K=4. In one example, the order of adding one's to the bitmap, can be in order of increasing bit index in bitmap (MSB bit of bitmap has index 0 and LSB bit of bitmap has largest index), for bits that are “1” in the maximum resource allocation bitmap starting from the MSB (bit with index 0), this is illustrated by way of example in FIG. 32(A) and FIG. 33(A), with K=4. In one example, the order of adding one's to the bitmap, can be in order of increasing bit index of bitmap (MSB bit of bitmap has index 0 and LSB bit of bitmap has largest index), for bits that are “1” in the maximum resource allocation bitmap starting from the bit to the right of the LSB that is 1 in the minimum resource allocation, and then wrapping around from LSB to MSB when reaching the LSB, this is illustrated by way of example in FIG. 32(B) and FIG. 33(B), with K=4. Other methods for determining the K resources are feasible. In variant examples, resource 0, has Nₓ one's in the resource allocation bitmap (e.g., the maximum resource allocation bitmap), resource k has

$${N}_{x} - ⌊ k \frac{{N}_{x} - {N}_{n}}{K - 1} ⌋ or {N}_{x} - ⌈ k \frac{{N}_{x} - {N}_{n}}{K - 1} ⌉$$

one's in the resource allocation bitmap, for k=0, 1, . . . . K−1, resource K−1, has Nₘ one's in the resource allocation bitmap (e.g., the minimum resource allocation bitmap), resources are generated starting from the maximum resource allocation and removing bits in the bitmap till the minimum resource allocation.

In one example, the maximum frequency domain resource allocation bitmap is indicated to the UE, and the minimum frequency domain resource allocation bitmap is configured to the UE.

In one example, the maximum frequency domain resource allocation bitmap is indicated to the UE, and the minimum frequency domain resource allocation bitmap is determined by the UE. In one example, the minimum resource allocation bitmap is a bitmap with one bit set to one, for example the bit that corresponds to the most significant bit in the maximum resource allocation bitmap that is one. In one example, the minimum resource allocation bitmap is a bitmap with one bit set to one, for example the bit that corresponds to the least significant bit in the maximum resource allocation bitmap that is one. In one example, the minimum resource allocation bitmap is a bitmap with d bits set to one, for example the bits that corresponds to the most significant d bits in the maximum resource allocation bitmap that are one. In one example, the minimum resource allocation bitmap is a bitmap with d bits set to one, for example the bits that corresponds to the least significant d bits in the maximum resource allocation bitmap that are one. In one example, d is defined in the specifications. In one example, d is configured to the UE. In one example, d is indicated to the UE. In one example, d corresponds to the additional bits in the bitmap that are set to one between two consecutive resources as mentioned herein.

In one example, the minimum frequency domain resource allocation bitmap is indicated to the UE, and the maximum frequency domain resource allocation bitmap is configured to the UE.

In one example, the minimum frequency domain resource allocation bitmap is indicated to the UE, and the maximum frequency domain resource allocation bitmap is determined by the UE.

In one example, the minimum frequency domain resource allocation bitmap is indicated to the UE, and the maximum frequency domain resource allocation bitmap is indicated to the UE.

In one example, the minimum frequency domain resource allocation bitmap is configured to the UE, and the maximum frequency domain resource allocation bitmap is configured to the UE.

FIG. 34 illustrates an example UL transmission resource configuration 3400 according to embodiments of the present disclosure. For example, any of the UEs 111-116 of FIG. 1, such as the UE 113, can be configured by the UL transmission resource configuration 3400. This example is for illustration only and other embodiments can be used without departing from the scope of the present disclosure.

In one example, for frequency domain resources, the UE is configured or indicated frequency domain resources using frequency domain resource allocation type 1. In one example, for resource allocation type 1, the frequency resources are allocated contiguously, e.g., from for starting frequency location (e.g., starting PRB or start frequency unit) for number of M frequency units (e.g., M PRBs).

In one example, a UE is configured or indicated or determines K UL transmission resources (e.g., PUSCH resources) with same starting frequency location and different resource allocation size. In one example, a UE is indicated or configured or determines a minimum frequency domain resource allocation size Mₙ. In one example, a UE is indicated or configured or determines a maximum frequency domain resource allocation size Mₓ. In one example, Mₙ and Mₓ can be minimum and maximum number of RBs respectively. In one example, Mₙ and Mₓ can be minimum and maximum number of frequency units respectively.

In one example, the resources can correspond to different number of RBs or frequency units over the same number of symbols or time units for example as illustrated in FIG. 34. In one example, the UE can be configured or indicated or determines K UL transmission (e.g., PUSCHs) configurations with different number of RBs or frequency units. Based on the payload size of UCI and/or the payload size of UL-SCH, the UE selects the UL transmission (e.g., PUSCH) configuration with the least number of resources that meets the target code rate for UCI and/or the target code rate for UL-SCH.

In one example, K uplink transmission resources are determined based on the minimum frequency domain resource allocation size and maximum frequency domain resource allocation size. In one example, K=Mₓ−Mₙ+1. In one example, resource 0, has Mₙ RBs or frequency units (e.g., the minimum frequency domain resource allocation size), resource k has Mₙ+k RBs or frequency units, for k=0, 1, . . . . K−1, resource K−1, has My RBs or frequency units (e.g., the maximum frequency domain resource allocation size). In one example, resource 0, has My RBs or frequency units (e.g., the maximum frequency domain resource allocation size), resource k has Mₓ−k RBs or frequency units, for k=0, 1, . . . . K−1, resource K−1, has Mₙ RBs or frequency units (e.g., the minimum frequency domain resource allocation size). In one example, the starting RB for K uplink transmission resources is the same, e.g., as illustrated in FIG. 34.

In one example, resource k+1 has d more RBs or frequency units than resource k. In one example, resource k+1 has d less RBs or frequency units than resource k. In one example, d can be defined in the system specifications, for example d=2 or d=1. In one example, d is indicated to the UE. In one example, d is configured to the UE. In one example, the number of resources K is given by:

$$K = ⌊ \frac{{M}_{x} - {M}_{n}}{d} ⌋ + 1.$$

In one example, resource 0, has Mₙ RBs or frequency units (e.g., the minimum frequency domain resource allocation size), resource k has Mₙ+d·k RBs or frequency units, for k=0, 1, . . . . K−1. In one example, resource 0, has Mₓ RBs or frequency units (e.g., the maximum frequency domain resource allocation size), resource k has Mₓ−d·k RBs or frequency units, for k=0, 1, . . . . K−1. In one example, the starting RB or frequency unit for K uplink transmission resources is the same, e.g., as illustrated in FIG. 34.

In one example, there are K UL transmission resources. In one example, K can be defined in the system specifications, for example K=4 or K=6. In one example, K is indicated to the UE. In one example, K is configured to the UE. In one example, resource 0, has Mₙ RBs or frequency units (e.g., the minimum frequency domain resource allocation size). In one example, resource K−1, has Mₓ RBs or frequency units (e.g., the maximum frequency domain resource allocation size). In one example, resource k has

$${M}_{n} + ⌊ k \frac{{M}_{x} - {M}_{n}}{K - 1} ⌋$$

RBs or frequency units, for k=0, 1, . . . . K−1. In one example, resource k has

$${M}_{n} + ⌈ k \frac{{M}_{x} - {M}_{n}}{K - 1} ⌉$$

RBs or frequency units, for k=0, 1, . . . . K−1. In one example, resource 0, has Mₓ RBs or frequency units (e.g., the maximum frequency domain resource allocation size). In one example, resource K−1, has Mₙ RBs or frequency units (e.g., the minimum frequency domain resource allocation size). In one example, resource k has

$${M}_{x} - ⌊ k \frac{{M}_{x} - {M}_{n}}{K - 1} ⌋$$

RBs or frequency units, for k=0, 1, . . . . K−1. In one example, resource k has

$${M}_{x} - ⌈ k \frac{{M}_{x} - {M}_{n}}{K - 1} ⌉$$

RBs or frequency units, for k=0, 1, . . . . K−1. In one example, the starting RB or frequency unit for K uplink transmission resources is the same, e.g., as illustrated in FIG. 34.

In one example, the maximum frequency domain resource allocation size is indicated to the UE, and the minimum frequency domain resource allocation size is configured to the UE. In one example, the maximum frequency domain resource allocation size is indicated to the UE together with the starting location (e.g., starting RB or starting frequency unit) as resource indication value (RIV). In one example, the maximum frequency domain resource allocation size is indicated to the UE as a separate parameter.

In one example, the maximum frequency domain resource allocation size is indicated to the UE, and the minimum frequency domain resource allocation size is determined by the UE. In one example, the maximum frequency domain resource allocation size is indicated to the UE (e.g., the UE 116) together with the starting location (e.g., starting RB or starting frequency unit) as resource indication value (RIV). In one example, the maximum frequency domain resource allocation size is indicated to the UE as a separate parameter. In one example, the minimum frequency domain resource allocation size is one (e.g., one RB or one frequency unit). In one example, the minimum frequency domain resource allocation size is d (e.g., d RBs or d frequency units). In one example, d is defined in the system specification. In one example, d is configured to the UE.

In one example, the minimum frequency domain resource allocation size is indicated to the UE, and the maximum frequency domain resource allocation size is configured to the UE. In one example, the minimum frequency domain resource allocation size is indicated to the UE together with the starting location (e.g., starting RB or starting frequency unit) as resource indication value (RIV). In one example, the minimum frequency domain resource allocation size is indicated to the UE as a separate parameter.

In one example, the minimum frequency domain resource allocation size is indicated to the UE, and the maximum frequency domain resource allocation size is determined by the UE. In one example, the minimum frequency domain resource allocation size is indicated to the UE together with the starting location (e.g., starting RB or starting frequency unit) as resource indication value (RIV). In one example, the minimum frequency domain resource allocation size is indicated to the UE as a separate parameter. In one example, the maximum frequency domain resource allocation size is the bandwidth part (BWP) or carrier BW (e.g., RBs or frequency units from starting location till end of BWP or carrier BW, or RBs or frequency units in BWP or carrier BW). In one example, the maximum frequency domain resource allocation size is d (e.g., d PRBs or d frequency units). In one example, d is defined in the system specification. In one example, d is configured to the UE.

In one example, the minimum frequency domain resource allocation size is indicated to the UE, and the maximum frequency domain resource allocation size is indicated to the UE. In one example, the minimum frequency domain resource allocation size is indicated to the UE together with the starting location (e.g., starting RB or starting frequency unit) as resource indication value (RIV). In one example, the minimum frequency domain resource allocation size is indicated to the UE as a separate parameter. In one example, the maximum frequency domain resource allocation size is indicated to the UE together with the starting location (e.g., starting RB or starting frequency unit) as resource indication value (RIV). In one example, the maximum frequency domain resource allocation size is indicated to the UE as a separate parameter.

In one example, the minimum frequency domain resource allocation size is configured to the UE, and the maximum frequency domain resource allocation size is configured to the UE. In one example, the starting location (e.g., starting RB or starting frequency unit) is indicated to the UE.

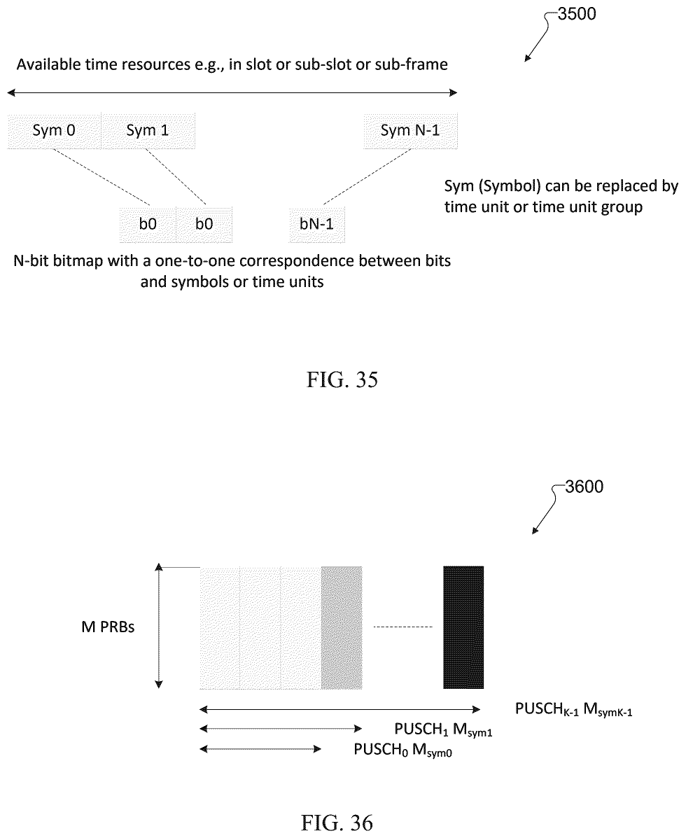

FIG. 35 illustrates an example available time resource configuration 3500 according to embodiments of the present disclosure. For example, any of the UEs 111-116 of FIG. 1, such as the UE 114, can be configured by the available time resource configuration 3500. This example is for illustration only and other embodiments can be used without departing from the scope of the present disclosure.

In one example, for time domain resources, the UE is configured or indicated time domain resources using a bitmap of the symbols or time units used for transmission. In one example, the UE is indicated a bitmap, with a size equal to the number of symbols or time units available, and a one-to-one correspondence between each bit in the bitmap and a corresponding symbol or time unit in the available resources as illustrated in FIG. 35. In one example, if a bit in the bitmap is “1”, the UL transmission uses the corresponding symbol or time unit. In one example, if a bit in the bitmap is “0”, the UL transmission doesn't use the corresponding symbol or time unit. In one example, a UE is indicated or configured a bitmap with a minimum time domain resource allocation, e.g., a minimum number of “1”'s in the bitmap for an UL transmission. In one example, a UE is indicated or configured a bitmap with a maximum time domain resource allocation, e.g., a maximum number of “1”'s in the bitmap for an UL transmission. In one example, the “1”'s in the minimum resource allocation bitmap are a subset of the “1”'s in the maximum resource allocation bitmap.

In one example, K uplink transmission resources are determined based on the minimum resource allocation bitmap and maximum resource allocation bitmap. In one example, Nₙ is the number of ones in the minimum resource allocation bitmap and Nₓ is the number of ones in the maximum resource allocation bitmap. In one example, K=Nₓ−Nₙ+1. In one example, resource 0, has Nₙ one's in the resource allocation bitmap (e.g., the minimum resource allocation bitmap), resource k has Nₙ+k one's in the resource allocation bitmap, for k=0, 1, . . . . K−1, resource K−1, has Nₓ one's in the resource allocation bitmap (e.g., the maximum resource allocation bitmap). In one example, the order of adding one's to the bitmap, can be in order of increasing bit index in bitmap (MSB bit of bitmap has index 0 and LSB bit of bitmap has largest index), for bits that are “1” in the maximum resource allocation bitmap starting from the MSB (bit with index 0), this is illustrated by way of example in FIG. 30(A). In one example, the order of adding one's to the bitmap, can be in order of increasing bit index in bitmap (MSB bit of bitmap has index 0 and LSB bit of bitmap has largest index), for bits that are “1” in the maximum resource allocation bitmap starting from the bit to the right of the LSB that is 1 in the minimum resource allocation, and then wrapping around from LSB to MSB when reaching the LSB, this is illustrated by way of example in FIG. 30(B). Other methods for determining the K resources are feasible. In variant examples, resource 0, has Nₓ one's in the resource allocation bitmap (e.g., the maximum resource allocation bitmap), resource k has Nₓ−k one's in the resource allocation bitmap, for k=0, 1, . . . . K−1, resource K−1, has Nₙ one's in the resource allocation bitmap (e.g., the minimum resource allocation bitmap), resources are generated starting from the maximum resource allocation and removing bits in the bitmap till the minimum resource allocation.

In one example, resource k+1 has d more ones than resource k. In one example, resource k+1 has d less ones than resource k, In one example, d can be defined in the system specifications, for example d=2 or d=1. In one example, d is indicated to the UE. In one example, d is configured to the UE. In one example, the number of resources K is given by:

$$K = ⌊ \frac{{N}_{x} - {N}_{n}}{d} ⌋ + 1.$$

In one example, resource 0, has Nₙ one's in the resource allocation bitmap (e.g., the minimum resource allocation bitmap), resource k has Nₙ+d·k one's in the resource allocation bitmap, for k=0, 1, . . . . K−1. In one example, the order of adding one's to the bitmap, can be in order of increasing bit index of bitmap (MSB bit in bitmap has index 0 and LSB bit in bitmap has largest index), for bits that are “1” in the maximum resource allocation bitmap starting from the MSB (bit with index 0), this is illustrated by way of example in FIG. 31(A), with d=2. In one example, the order of adding one's to the bitmap, can be in order of increasing bit index of bitmap (MSB bit in bitmap has index 0 and LSB bit in bitmap has largest index), for bits that are “1” in the maximum resource allocation bitmap starting from the bit to the right of the LSB that is 1 in the minimum resource allocation, and then wrapping around from LSB to MSB when reaching the LSB, this is illustrated by way of example in FIG. 31(B), with d=2. Other methods for determining the K resources are feasible. In variant examples, resource 0, has Nₓ one's in the resource allocation bitmap (e.g., the maximum resource allocation bitmap), resource k has Nₓ−d·k one's in the resource allocation bitmap, for k=0, 1, . . . . K−1, resource K−1, has Nₘ one's in the resource allocation bitmap (e.g., the minimum resource allocation bitmap), resources are generated starting from the maximum resource allocation and removing bits in the bitmap till the minimum resource allocation.

In one example, there are K UL transmission resources. In one example, K can be defined in the system specifications, for example K=4 or K=6. In one example, K is indicated to the UE. In one example, K is configured to the UE. In one example, resource 0, has No one's in the resource allocation bitmap (e.g., the minimum resource allocation bitmap). In one example, resource K−1, has Nₓ one's in the resource allocation bitmap (e.g., the maximum resource allocation bitmap). In one example, resource k has

$${N}_{n} + ⌊ k \frac{{N}_{x} - {N}_{n}}{K - 1} ⌋$$

one's in the resource allocation bitmap, for k=0, 1, . . . . K−1, as illustrated in FIG. 32 with K=4. In one example, resource k has

$${N}_{n} + ⌈ k \frac{{N}_{x} - {N}_{n}}{K - 1} ⌉$$

one's in the resource allocation bitmap, for k=0, 1, . . . . K−1, as illustrated in FIG. 33 with K=4. In one example, the order of adding one's to the bitmap, can be in order of increasing bit index in bitmap (MSB bit of bitmap has index 0 and LSB bit of bitmap has largest index), for bits that are “1” in the maximum resource allocation bitmap starting from the MSB (bit with index 0), this is illustrated by way of example in FIG. 32(A) and FIG. 33(A), with K=4. In one example, the order of adding one's to the bitmap, can be in order of increasing bit index in bitmap (MSB bit of bitmap has index 0 and LSB bit of bitmap has largest index), for bits that are “1” in the maximum resource allocation bitmap starting from the bit to the right of the LSB that is 1 in the minimum resource allocation, and then wrapping around from LSB to MSB when reaching the LSB, this is illustrated by way of example in FIG. 32(B) and FIG. 33(B), with K=4. Other methods for determining the K resources are feasible. In variant examples, resource 0, has Nₓ one's in the resource allocation bitmap (e.g., the maximum resource allocation bitmap), resource k has

$${N}_{x} - ⌊ k \frac{{N}_{x} - {N}_{n}}{K - 1} ⌋ or {N}_{x} - ⌈ k \frac{{N}_{x} - {N}_{n}}{K - 1} ⌉$$

one's in the resource allocation bitmap, for k=0, 1, . . . . K−1, resource K−1, has Nₘ one's in the resource allocation bitmap (e.g., the minimum resource allocation bitmap), resources are generated starting from the maximum resource allocation and removing bits in the bitmap till the minimum resource allocation.

In one example, the maximum time domain resource allocation bitmap is indicated to the UE, and the minimum time domain resource allocation bitmap is configured to the UE.

In one example, the maximum time domain resource allocation bitmap is indicated to the UE, and the minimum time domain resource allocation bitmap is determined by the UE. In one example, the minimum resource allocation bitmap is a bitmap with one bit set to one, for example the bit that corresponds to the most significant bit in the maximum resource allocation bitmap that is one. In one example, the minimum resource allocation bitmap is a bitmap with one bit set to one, for example the bit that corresponds to the least significant bit in the maximum resource allocation bitmap that is one. In one example, the minimum resource allocation bitmap is a bitmap with d bits set to one, for example the bits that corresponds to the most significant d bits in the maximum resource allocation bitmap that are one. In one example, the minimum resource allocation bitmap is a bitmap with d bits set to one, for example the bits that corresponds to the least significant d bits in the maximum resource allocation bitmap that are one. In one example, d is defined in the specifications. In one example, d is configured to the UE. In one example, d is indicated to the UE. In one example, d corresponds to the additional bits in the bitmap that are set to one between two consecutive resources as mentioned herein.

In one example, the minimum time domain resource allocation bitmap is indicated to the UE, and the maximum time domain resource allocation bitmap is configured to the UE.

In one example, the minimum time domain resource allocation bitmap is indicated to the UE, and the maximum time domain resource allocation bitmap is determined by the UE.

In one example, the minimum time domain resource allocation bitmap is indicated to the UE, and the maximum time domain resource allocation bitmap is indicated to the UE.

In one example, the minimum time domain resource allocation bitmap is configured to the UE, and the maximum time domain resource allocation bitmap is configured to the UE.

In one example, for time domain resources, the UE is configured or indicated time domain resources using time domain allocation size, e.g., as number of symbols or number of time units. In one example, the time resources are allocated contiguously, e.g., from for starting time location (e.g., starting symbol or start time unit) for number of M time units (e.g., M symbols).

In one example, a UE is configured or indicated or determines K UL transmission resources (e.g., PUSCH resources) with same starting time location and different resource allocation size. In one example, a UE is indicated or configured or determines a minimum time domain resource allocation size Mₙ. In one example, a UE is indicated or configured or determines a maximum time domain resource allocation size Mₓ. In one example, Mₙ and Mₓ can be minimum and maximum number of symbols respectively. In one example, Mₙ and Mₓ can be minimum and maximum number of time units respectively.

FIG. 36 illustrates an example UL transmission resource configuration 3600 according to embodiments of the present disclosure. For example, any of the UEs 111-116 of FIG. 1, such as the UE 115, can be configured by the UL transmission resource configuration 3600. This example is for illustration only and other embodiments can be used without departing from the scope of the present disclosure.

In one example, the resources can correspond to different number of symbols or time units over the same number of RBs or frequency units for example as illustrated in FIG. 36. In one example, the UE can be configured or indicated or determines K UL transmission (e.g., PUSCHes) configurations with different number of symbols or time units. Based on the payload size of UCI and/or the payload size of UL-SCH, the UE selects the UL transmission (e.g., PUSCH) configuration with the least number of resources that meets the target code rate for UCI and/or the target code rate for UL-SCH.

In one example, K uplink transmission resources are determined based on the minimum time domain resource allocation size and maximum time domain resource allocation size. In one example, K=Mₓ−Mₙ+1. In one example, resource 0, has Mₙ symbols or time units (e.g., the minimum time domain resource allocation size), resource k has Mₙ+k symbols or time units, for k=0, 1, . . . . K−1, resource K−1, has Mₓ symbols or time units (e.g., the maximum time domain resource allocation size). In one example, resource 0, has Mₓ symbols or time units (e.g., the maximum time domain resource allocation size), resource k has Mₓ-k symbols or time units, for k=0, 1, . . . . K−1, resource K−1, has Mₙ symbols or time units (e.g., the minimum time domain resource allocation size). In one example, the starting symbol or time unit for K uplink transmission resources is the same, e.g., as illustrated in FIG. 36.

In one example, resource k+1 has d more symbols or time units than resource k. In one example, resource k+1 has d less symbols or time units than resource k. In one example, d can be defined in the system specifications, for example d=2 or d=1. In one example, d is indicated to the UE. In one example, d is configured to the UE. In one example, the number of resources K is given by:

$$K = ⌊ \frac{{M}_{x} - {M}_{n}}{d} ⌋ + 1.$$

In one example, resource 0, has Mₙ symbols or time units (e.g., the minimum time domain resource allocation size), resource k has Mₙ+d·k symbols or time units, for k=0, 1, . . . . K−1. In one example, resource 0, has My symbols or time units (e.g., the maximum time domain resource allocation size), resource k has Mₓ−d·k symbols or time units, for k=0, 1, . . . . K−1. In one example, the starting symbol or time unit for K uplink transmission resources is the same, e.g., as illustrated in FIG. 36.

In one example, there are K UL transmission resources. In one example, K can be defined in the system specifications, for example K=4 or K=6. In one example, K is indicated to the UE. In one example, K is configured to the UE. In one example, resource 0, has Mₙ symbols or time units (e.g., the minimum time domain resource allocation size). In one example, resource K−1, has Mₓ symbols or time units (e.g., the maximum time domain resource allocation size). In one example, resource k has

$${M}_{n} + ⌊ k \frac{{M}_{x} - {M}_{n}}{K - 1} ⌋$$

symbols or time units, for k=0, 1, . . . . K−1. In one example, resource k has

$${M}_{n} + ⌈ k \frac{{M}_{x} - {M}_{n}}{K - 1} ⌉$$

symbols or time units, for k=0, 1, . . . . K−1. In one example, K is configured to the UE. In one example, resource 0, has Mₓ symbols or time units (e.g., the maximum time domain resource allocation size). In one example, resource K−1, has Mₙ symbols or time units (e.g., the minimum time domain resource allocation size). In one example, resource k has

$$x - ⌊ k \frac{{M}_{x} - {M}_{n}}{K - 1} ⌋$$

symbols or time units, for k=0, 1, . . . . K−1. In one example, resource k has

$${M}_{x} - ⌈ k \frac{{M}_{x} - {M}_{n}}{K - 1} ⌉$$

symbols or time units, for k=0, 1, . . . . K−1. In one example, the starting symbol or time unit for K uplink transmission resources is the same, e.g., as illustrated in FIG. 36.

In one example, the maximum time domain resource allocation size is indicated to the UE, and the minimum time domain resource allocation size is configured to the UE. In one example, the maximum time domain resource allocation size is indicated to the UE together with the starting location (e.g., starting symbol or starting time unit) as resource indication value (RIV). In one example, the maximum time domain resource allocation size is indicated to the UE as a separate parameter.

In one example, the maximum time domain resource allocation size is indicated to the UE, and the minimum time domain resource allocation size is determined by the UE. In one example, the maximum time domain resource allocation size is indicated to the UE together with the starting location (e.g., starting symbol or starting time unit) as resource indication value (RIV). In one example, the maximum time domain resource allocation size is indicated to the UE as a separate parameter. In one example, the minimum time domain resource allocation size is one (e.g., one symbol or one-time unit). In one example, the minimum time domain resource allocation size is d (e.g., d symbols or d time units). In one example, d is defined in the system specification. In one example, d is configured to the UE.

In one example, the minimum time domain resource allocation size is indicated to the UE, and the maximum time domain resource allocation size is configured to the UE. In one example, the minimum time domain resource allocation size is indicated to the UE together with the starting location (e.g., starting symbol or starting time unit) as resource indication value (RIV). In one example, the minimum time domain resource allocation size is indicated to the UE as a separate parameter.

In one example, the minimum time domain resource allocation size is indicated to the UE, and the maximum resource time domain allocation size is determined by the UE. In one example, the minimum time domain resource allocation size is indicated to the UE together with the starting location (e.g., starting symbol or starting time unit) as resource indication value (RIV). In one example, the minimum time domain resource allocation size is indicated to the UE as a separate parameter. In one example, the maximum time domain resource allocation size is the slot or sub-frame (e.g., symbols or time units from starting location till end of slot or sub-frame, or symbols or time units in slot or sub-frame). In one example, the maximum resource allocation size is d (e.g., d symbols or d time units). In one example, d is defined in the system specification. In one example, d is configured to the UE.

In one example, the minimum time domain resource allocation size is indicated to the UE, and the maximum time domain resource allocation size is indicated to the UE. In one example, the minimum time domain resource allocation size is indicated to the UE together with the starting location (e.g., starting symbol or starting time unit) as resource indication value (RIV). In one example, the minimum time domain resource allocation size is indicated to the UE as a separate parameter. In one example, the maximum time domain resource allocation size is indicated to the UE together with the starting location (e.g., starting symbol or starting time unit) as resource indication value (RIV). In one example, the maximum time domain resource allocation size is indicated to the UE as a separate parameter.

In one example, the minimum time domain resource allocation size is configured to the UE, and the maximum time domain resource allocation size is configured to the UE. In one example, the starting location (e.g., starting symbol or starting time unit) is indicated to the UE. In one example, the K resources used for an UL transmission can have different frequency domain resources (e.g., K_{f} possible frequency domain allocation) and different time domain resources (e.g., Kₜ possible time domain allocation) as mentioned herein.

In one example, pairs of frequency and time domain resources are allowed, e.g., K=K_{f}. Kₜ. In one example, the K_{f} frequency domain resources are indexed as: k_{f}=0, 1, . . . , K_{f}−1. In one example, the Kₜ time domain resources are indexed as: kₜ=0, 1, . . . , Kₜ−1. In one example, the K uplink resources are indexed, using index k, first over the frequency domain resources and then over the time domain resources, such that k=kₜ·K_{f}+k_{f}, where k=0, 1, . . . , K−1. In one example, the K uplink resources are indexed, using index k, first over the time domain resources and then over the frequency domain resources, such that k=k_{f}·Kₜ+kₜ, where k=0, 1, . . . , K−1.

In one example, a subset of pairs of time domain and frequency domain resources is allowed, wherein the subset of pairs can be indicated or configured to the UE. For example, of the K_{f}·Kₜ possible resources, only K resources are available as configured or indicated to the UE, wherein K<K_{f}·Kₜ or K≤K_{f}·Kₜ.

In one example, the frequency domain resources use a bitmap and the time domain resources use a bitmap as mentioned herein.

In one example, the frequency domain resources use a bitmap and the time domain resources use a resource allocation size (e.g., start symbol or time-unit and number or symbols or time-units) as mentioned herein.

In one example, the frequency domain resources use a resource allocation size (e.g., start RB or frequency-unit and number of RBs or frequency-units) and the time domain resources use a bitmap as mentioned herein.

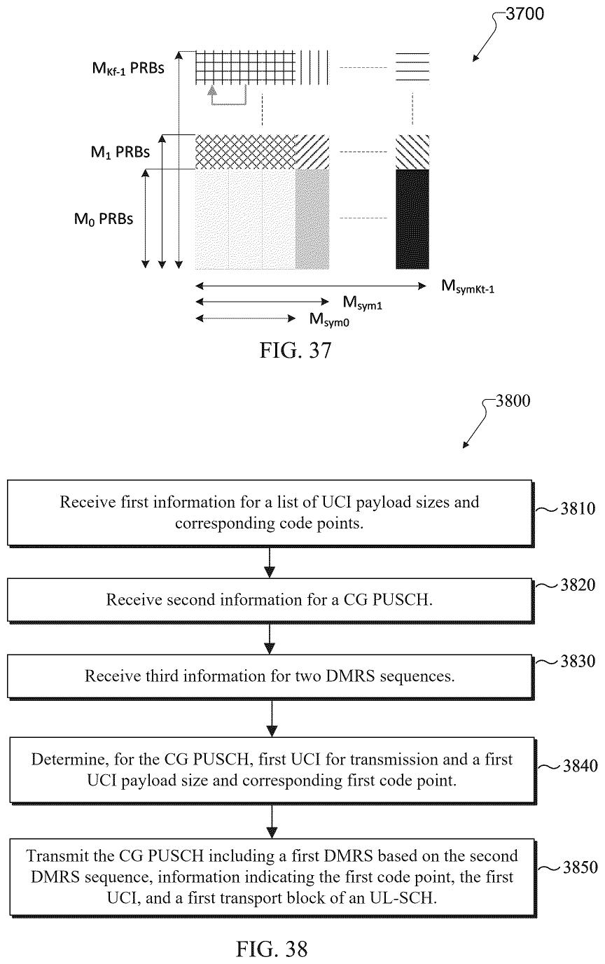

FIG. 37 illustrates an example UL transmission resource configuration 3700 according to embodiments of the present disclosure. For example, any of the UEs 111-116 of FIG. 1, such as the UE 116, can be configured by the UL transmission resource configuration 3700. This example is for illustration only and other embodiments can be used without departing from the scope of the present disclosure.

In one example, the frequency domain resources use a resource allocation size (e.g., start RB or frequency-unit and number of RBs or frequency-units) and the time domain resources use a resource allocation size (e.g., start symbol or time-unit and number or symbols or time-units) as mentioned herein and as illustrated in FIG. 37.

In one example, a UE (e.g., the UE 116) can be configured with M subsets of resources, wherein each subset includes K resources. The UE is indicated (e.g., by L1 control (DCI Format) or MAC CE signaling) one of the M subsets, e.g., subset m, where m=0, 1, . . . , M−1, the UE selects one of the K resources of the indicated subset m.

In one example, a UE can be configured with M subsets of resources, wherein each subset includes Kₘ resources, wherein m=0, 1, . . . , M−1. The UE is indicated (e.g., by L1 control (DCI Format) or MAC CE signaling) one of the M subsets, e.g., subset m, where m=0, 1, . . . , M−1, the UE selects one of the Kₘ resources of the indicated subset m.

In one example, a UE can be indicated K resources, e.g., for dynamic uplink transmission (e.g., dynamic PUSCH), the UE selects one of the K resources of the indicated K resources.

In one example, a UE can be configured K resources, e.g., for semi-static uplink transmission (e.g., CG Type1 PUSCH or CG Type2 PUSCH), the UE selects one of the K resources of the indicated K resources for a transmission instance of uplink transmission.

The determination of amount of UL resources (amount of resource elements (REs)) for UL transmission and a corresponding UL resource, can depend on the amount of data the UE has to transmit (e.g., UCI payload and/or UL-SCH payload), and the channel conditions, which can determine the modulation coding scheme (MCS) (e.g., code rate and modulation order), and the rank of the transmission (e.g., number of transmission layers using spatial multiplexing).

In one example, the UE is indicated or configured: (1) K resources for UL transmission, (2) modulation coding scheme for UL transmission, (3) rank or number of layers for uplink transmission. For each resource k of the K resources, the UE determines the number of resource elements

$${N}_{R E}^{P U S C H} ( k )$$

available for data transmission (e.g., for transmission of UCI and/or UL-SCH). In one example,

$${N}_{PRB}^{PUSCH} ( k )$$

is the number of PRBs of resource k. In one example,

$${N}_{sym}^{PUSCH} ( k )$$

is the number of symbols of resource k. In one example, N_{DMRS}(k) is the number of REs for DMRS in resource k, including overhead of the DMRS CDM groups without data. In one example, Nₒₕ(k) is additional overhead REs in resource k, e.g., overhead due to Information A, if any, as described later in this disclosure. In one example,

$${N}_{R E}^{PUSCH} ( k ) = {N}_{sc}^{RB} \cdot {N}_{s y m}^{PUSCH} ( k ) \cdot {N}_{PRB}^{PUSCH} ( k ) - {N}_{DMRS} ( k ) - {N}_{o h} ( k ) .$$

In a variant example, N_{DMRS}(k) and/or Nₒₕ(k) can be in units of average REs per RB and are multiplied by

$${N}_{s y m}^{PUSCH} ( k )$$

to get total corresponding REs for PUSCH allocation. In one example,

$${N}_{s c}^{RB}$$

is the number of sub-carriers per RB. In one example,

$${N}_{s c}^{RB} = 12 .$$

In one example, the physical layer is presented UCI and/or UL-SCH as illustrated in FIG. 12, and determines the number of REs required and the corresponding resource k as described in the following.

In one example, UCI has a payload size of O_{UCI} and a CRC size O_{CRC} (if there is no CRC appended to UCI O_{CRC}=0), UE can calculate minimum number of REs required for UCI, based on a UCI code rate of R_{UCI}, or based on UL-SCH code rate of R_{UL-SCH} and a beta offset of

$${β}_{offset}^{PUSCH}$$

and based on a modulation order Qₘ and based on transmission on N_{L} layers.

In one example, the number of REs for UCI is given by:

$${N}_{R E}^{UCI} = ⌈ \frac{( {O}_{UCI} + {O}_{C R C} ) \cdot {β}_{o f fset}^{P U S C H}}{{R}_{UL - SCH} \cdot {Q}_{m}} ⌉$$

In one example, the number of REs for UCI is given by:

$${N}_{R E}^{UCI} = ⌈ \frac{( {O}_{UCI} + {O}_{C R C} ) \cdot {β}_{o f fset}^{P U S C H}}{{R}_{UL - SCH} \cdot {Q}_{m} \cdot {N}_{L}} ⌉$$

In one example, the number of REs for UCI is given by:

$${N}_{R E}^{UCI} = ⌈ \frac{( {O}_{UCI} + {O}_{C R C} )}{{R}_{UCI} \cdot {Q}_{m}} ⌉$$

In one example, the number of REs for UCI is given by:

$${N}_{R E}^{UCI} = ⌈ \frac{( {O}_{UCI} + {O}_{C R C} )}{{R}_{UCI} \cdot {Q}_{m} \cdot {N}_{L}} ⌉$$

In a variant of the equations herein, the ceiling function can be replaced by the floor function.

In a variant example, different UCI-types can have different UCI rates or different beta offsets. In one example, given UCI type i has a payload of O_{UCI-i} and a CRC size O_{CRC-i} (if there is no CRC appended to UCI O_{CRC-i}=0, in one example, a CRC can be applied after different UCI streams are multiplexed), UE can calculate minimum number of REs required for UCI type i, based on a UCI type i code rate of R_{UCI-i}, or based on UL-SCH code rate of R_{UL-SCH} and a UCI type i beta offset of

$${β}_{offset}^{P U SCH - i}$$

and based on a modulation order Qₘ and based on transmission on N_{L} layers. The REs of UCI types can then be summed together to get

$${N}_{R E}^{UCI} .$$

In one example, the number of REs for UCI is given by:

$${N}_{R E}^{UCI - i} = ⌈ \frac{( {O}_{UCI - i} + {O}_{CRC - i} ) \cdot {β}_{offset}^{P U SCH - i}}{{R}_{UL - SCH} \cdot {Q}_{m}} ⌉$$

$${N}_{R E}^{UCI} = {\sum }_{i = 0}^{M - 1} {N}_{R E}^{UCI - i} = {\sum }_{i = 0}^{M - 1} ⌈ \frac{( {O}_{UCI - i} + {O}_{CRC - i} ) \cdot {β}_{offset}^{P U SCH - i}}{{R}_{UL - SCH} \cdot {Q}_{m}} ⌉$$

In one example, the number of REs for UCI is given by:

$${N}_{R E}^{UCI - i} = ⌈ \frac{( {O}_{UCI - i} + {O}_{CRC - i} ) \cdot {β}_{offset}^{P U SCH - i}}{{R}_{UL - SCH} \cdot {Q}_{m} \cdot {N}_{L}} ⌉$$

$${N}_{R E}^{UCI} = {\sum }_{i = 0}^{M - 1} {N}_{R E}^{UCI - i} = {\sum }_{i = 0}^{M - 1} ⌈ \frac{( {O}_{UCI - i} + {O}_{CRC - i} ) \cdot {β}_{offset}^{P U SCH - i}}{{R}_{UL - SCH} \cdot {Q}_{m} \cdot {N}_{L}} ⌉$$

In one example, the number of REs for UCI is given by:

$${N}_{R E}^{UCI - i} = ⌈ \frac{( {O}_{UCI - i} + {O}_{CRC - i} )}{{R}_{UCI - i} \cdot {Q}_{m}} ⌉$$

$${N}_{R E}^{UCI} = {\sum }_{i = 0}^{M - 1} {N}_{R E}^{UCI - i} = {\sum }_{i = 0}^{M - 1} ⌈ \frac{( {O}_{UCI - i} + {O}_{CRC - i} )}{{R}_{UCI - i} \cdot {Q}_{m}} ⌉$$

In one example, the number of REs for UCI is given by:

$${N}_{R E}^{UCI - i} = ⌈ \frac{( {O}_{UCI - i} + {O}_{CRC - i} )}{{R}_{UCI - i} \cdot {Q}_{m} \cdot {N}_{L}} ⌉$$

$${N}_{R E}^{UCI} = {\sum }_{i = 0}^{M - 1} {N}_{R E}^{UCI - i} = {\sum }_{i = 0}^{M - 1} ⌈ \frac{( {O}_{UCI - i} + {O}_{CRC - i} )}{{R}_{UCI - i} \cdot {Q}_{m} \cdot {N}_{L}} ⌉$$

In a variant of the equations herein, the ceiling function can be replaced by the floor function.

In one example, UL-SCH has a payload size (e.g., per TB) of O_{UL-SCH} and a transport block (TB) CRC size O_{CRC-TB} (if there is no TB CRC appended to UCI O_{CRC-TB}=0), and a code block (CB) CRC size O_{CRC-CB} (if there is no CB CRC appended to UCI O_{CRC-CB}=0), and number of CBs NCB (e.g., per TB). In one example, if N_{CB}=1, O_{CRC-CB}=0. In one example, the total number of bits at the input to the encoder is O_{UL-SCH}+O_{CRC-TB}+N_{CB}·O_{CRC-CB}. A UE can calculate minimum number of REs required for UL-SCH (e.g., per TB), based on UL-SCH code rate of R_{UL-SCH} and based on a modulation order Qₘ and based on transmission on N_{L} layers (e.g., per TB). In one example, the number of REs for UL-SCH (e.g., per TB) is given by:

$${N}_{R E}^{UL - SCH} = ⌈ \frac{{O}_{UL - SCH} + {O}_{CRC - TB} + {N}_{C B} \cdot {O}_{CRC - CB}}{{N}_{L} \cdot {R}_{UL - SCH} \cdot {Q}_{m}} ⌉$$

In one example,

$${N}_{R E}^{UL - SCH}$$

is calculated per TB and the largest value across TBs is selected.

In variant example, UL-SCH has a payload size across TBs of O_{UL-SCH} and a transport block (TB) CRC size O_{CRC-TB} (if there is no TB CRC appended to UCI O_{CRC-TB}=0, there are multiple TBs, O_{CRC-TB} is the sum of bits in TB CRC blocks), and a code block (CB) CRC size O_{CRC-CB} (if there is no CB CRC appended to UCI O_{CRC-CB}=0, O_{CRC-CB} is the sum bits in CB CRC blocks), and number of CBs N_{CB}. In one example, if N_{CB}=1 (e.g., per TB), O_{CRC-CB}=0. In one example, the total number of bits at the input to the encoder is O_{UL-SCH}+O_{CRC-TB}+O_{CRC-CB}. A UE can calculate minimum number of REs required for UL-SCH based on UL-SCH code rate of R_{UL-SCH} and based on a modulation order Qₘ and based on transmission on N_{L} layers. In one example, the number of REs for UL-SCH is given by:

$${N}_{R E}^{UL - SCH} = ⌈ \frac{{O}_{UL - SCH} + {O}_{CRC - TB} + {O}_{CRC - CB}}{{N}_{L} \cdot {R}_{UL - SCH} \cdot {Q}_{m}} ⌉$$

In one example, the total number of REs for transmission of UCI and data is

$${N}_{R E}^{UCI} = {N}_{R E}^{P U S C H} ( k ) - {N}_{R E}^{UL - SCH} .$$

In one example, resource k is selected from the K resources such that resource k has the least number of resource elements (e.g., smallest

$${N}_{sc}^{R B} \cdot {N}_{s y m}^{P U S C H} ( k ) \cdot {N}_{P R B}^{P U S C H} ( k ) ) and$$

$${N}_{R E}^{P U S C H} ( k ) \geq {N}_{R E}^{UCI} + {N}_{R E}^{UL - SCH}$$

In one example, if there is no

$$UCI {N}_{RE}^{UCI} = 0 .$$

In one example, if there is no

$$UL - SCH {N}_{RE}^{UL - SCH} = 0.$$

In one example,

$${N}_{RE}^{PUSCH} ( K - 1 ) < {N}_{RE}^{UCI} + {N}_{RE}^{UL - SCH} ,$$

e.g., resource with the largest amount of resource elements available for data transmission, doesn't have enough resource elements for transmission of UCI and UL-SCH, UE can:
Drop transmissions in priority order (e.g., starting with the lowest priority and in ascending order of priority). In one example, UL-SCH transmission dropped or transmitted with a smaller block size, followed by UCI transmission in descending priority order unit there are enough resources.
Proportionally increase code rate across all transmissions.
Proportionally increase code rate across all transmissions until a maximum code rate that can be configured or indicated to the UE, beyond that if resources are not enough, transmissions are dropped or reduced in size in ascending priority order unit there are enough resources (starting with the smallest priority).
Increased code rate of transmissions until a maximum code rate in ascending priority order unit there are enough resources, beyond that if resources are not enough, transmissions are dropped or reduced in size in ascending priority order unit there are enough resources (starting with the smallest priority).

In a variant of the examples mentioned herein, the UE calculates the UL-SCH payload size based on a reference resource e.g., kᵣ. In one example, kᵣ is indicated to the UE. In one example, kᵣ is indicated to the UE in the UL DCI Format scheduling the UL transmission. In one example, kᵣ is configured to the UE. In one example, k, is determined by the UE based on a rule. In one example,

$${k}_{r} = ⌊ \frac{K}{2} ⌋ .$$

In one example,

$${k}_{r} = ⌈ \frac{K}{2} ⌉ .$$

In one example,

$${k}_{r} = ⌊ \frac{K - 1}{2} ⌋ .$$

In one example,

$${k}_{r} = ⌈ \frac{K - 1}{2} ⌉ .$$

In one example, if K is even,

$${k}_{r} = \frac{K}{2}$$

and if K is odd,

$${k}_{r} = \frac{K - 1}{2} .$$

In one example, if K is even,

$${k}_{r} = ⌈ \frac{K - 1}{2} ⌉ - 1$$

and if K is odd,

$${k}_{r} = \frac{K - 1}{2} .$$

In one example, kᵣ=0. In one example, kᵣ=K−1. In one example, the UE calculates the payload size for UL-SCH based on the time frequency allocation of resource kᵣ as described in [REF 4]. In one example, payload size is calculated to be approximately equal to

$${R}_{UL - SCH} \cdot {N}_{L} \cdot {Q}_{m} \cdot {N}_{RE}^{UL - SCH}$$

including size of TB CRC and CB CRC blocks. In one example the TB size is approximated to the nearest quantized value of TB size using tables in [REF 4]. In one example, for a re-transmission, the UL transport block size is that of the previous transmission of the same HARQ process.

In a variant of the examples mentioned herein, the UE calculates the UL-SCH payload size based on a reference overhead for UCI, e.g., N_{oh-UCI}. Wherein, N_{oh-UCI} can represent a reference overhead configured or indicated (e.g., in a DCI Format) for UCI, e.g., reference number of REs for UCI. In one example, payload size is calculated to be approximately equal to

$${R}_{UL - SCH} \cdot {N}_{L} \cdot {Q}_{m} \cdot {N}_{RE}^{UL - SCH}$$

including size of TB CRC and CB CRC blocks, wherein

$${N}_{RE}^{UL - SCH}$$

are the REs used tor UL-SCH after removing reference UCI overhead RE from resource k used for UL transmission. In one example the TB size is approximated to the nearest quantized value of TB size using tables in [REF 4]. In one example, the resource used to calculate the UL-SCH payload size, k, can be: k=0. In one example, the resource used to calculate the UL-SCH payload size, k, can be: k=K−1 . . . . In one example, the resource used to calculate the UL-SCH payload size, k, can be: k=kᵣ, wherein kᵣ is as mentioned herein. In one example, the actual UCI REs used for UCI transmission can be different than that given by N_{oh-UCI} e.g., based on the actual UCI payload size and/or UCI code rate. In one example, the actual resource k used for UL transmission can be different than what is mentioned herein, e.g., based on the actual UCI payload size and/or UCI code rate.

In one example, the physical layer is presented UCI and/or UL-SCH as illustrated in FIG. 12, the size of the UL-SCH transport block(s) size is calculate as previously described. The physical layer determines the number of REs required and the corresponding resource k as previously described including any potential dropping of information.

In a variant of the examples mentioned herein, the UE is indicated or configured: (1) K resources for UL transmission, (2) rank or number of layers for uplink transmission. The UE can determine the modulation coding scheme (MCS) based on channel conditions.
In one example, the physical layer is presented UCI and/or UL-SCH as illustrated in FIG. 12. The physical layer determines the number of REs required and the corresponding resource k as previously described including any potential dropping of information based on the payload size of UCI and the payload size of UL-SCH, and using the determined code rate (from determined MCS).
In one example, the physical layer is presented UCI and/or UL-SCH as illustrated in FIG. 12, the size of the UL-SCH transport block(s) size is calculate a previously described based on a reference resource kᵣ, or the size of a previous transmission in case of retransmissions. The physical layer determines the number of REs required and the corresponding resource k as previously described including any potential dropping of information based on the payload size of UCI and the determined payload size of UL-SCH, and using the determined code rate (from determined MCS).

In a variant of the examples mentioned herein, the UE is indicated or configured: (1) K resources for UL transmission. The UE can determine the modulation coding scheme (MCS) and the number of layers N_{L} (rank) based on channel conditions.
In one example, the physical layer is presented UCI and/or UL-SCH as illustrated in FIG. 12. The physical layer determines the number of REs required and the corresponding resource k as previously described including any potential dropping of information based on the payload size of UCI and the payload size of UL-SCH, and using the determined code rate (from determined MCS) and the determined N_{L}.
In one example, the physical layer is presented UCI and/or UL-SCH as illustrated in FIG. 12, the size of the UL-SCH transport block(s) size is calculate a previously described based on a reference resource kᵣ, or the size of a previous transmission in case of retransmissions. The physical layer determines the number of REs required and the corresponding resource k as previously described including any potential dropping of information based on the payload size of UCI and the determined payload size of UL-SCH, and using the determined code rate (from determined MCS) and the determined N_{L}.

In a variant of the examples mentioned herein, the MCS determined by the UE doesn't exceed a maximum value MCSₘₐₓ, wherein MCSₘₐₓ is configured or indicated to the UE.

In a variant of the examples mentioned herein, the MCS determined by the UE isn't less than a minimum value MCSₘᵢₙ, wherein MCSₘᵢₙ is configured or indicated to the UE.

In a variant of the examples mentioned herein, the number of layers N_{L} determined by the UE doesn't exceed a maximum value N_{L-max}, wherein N_{L-max} is configured or indicated to the UE.

In a variant of the examples mentioned herein, the number of layers N_{L} determined by the UE isn't less than a minimum value N_{L-min}, wherein N_{L-min} is configured or indicated to the UE.

In one example, the UE signals information associated with the UL transmission to assisted the receiver to receive the UL transmission. In one example, this information is referred to as Information A. Information A is assistance information associated with an UL transmission that help the receiver receiving the UL transmission decode the UL transmission.

In one example, Information A is included in the resource elements of the UL transmission. In one example, information A is included resource elements of the UL transmission that are common across all K UL transmission resources from which the UE selects an UL transmission resource.

In one example, information A is included in a channel separate from the UL transmission. For example, Information A can be transmitted in a signal or channel before the UL transmission, e.g., a pre-notification signal or channel.

In one example, Information A can include or indicate one or more of the following:
Resource k of the K resources used for UL transmission. In one example, a resource field is included in Information A, with size [log₂ K] bits that indicates resource k used for the UL transmission. In one example, there are K DMRS sequences or a combination of K DMRS sequences and DMRS RE locations that the UE can select from to indicate a resource k. In one example, resource k is not signaled but determined from other parameters, such as UCI payload size and/or UL-SCH payload size and/or MCS and/or number of layers.
UCI payload size. In one example, the UE can signal a UCI payload size, for example, there are M quantized UCI payload sizes, and the UE can indicate UCI payload size m out of the M payload sizes using a field in Information A, with size [log₂ M] bits. In one example, one of the M payload sizes is no UCI. In one example, the UCI payload size is for all UCI information (e.g., ACK and/or CSI (single part or multiple (e.g., two) parts) and/or scheduling request (SR) and/or UE initiated report indicator (UEI-RI)). In one example, there could be multiple UCI streams, and a UCI payload size is provided for each UCI stream. In one example, a UCI stream can be one UCI type (e.g., ACK or CSI or SR or UEI-RI). In one example a UCI stream can multiplex multiple UCI types (e.g., ACK and CSI-part1). In one example, UCI payload size is not signaled but determined from other parameters, such as resource k and/or UL-SCH payload size and/or MCS and/or number of layers.
UL-SCH payload size. In one example, the UE can signal a UL-SCH payload size, for example, there are M quantized UL-SCH payload sizes, and the UE can indicate UL-SCH payload size m out of the M payload sizes using a field in Information A, with size [log₂ M] bits. In one example, one of the M payload sizes is no UL-SCH. In one example, the UL-SCH has multiple transport blocks, and Information A is multiplexed with each transport block (e.g., on the layers of that transport blocks) and indicates the size of the corresponding transport block. In one example, the UL-SCH has multiple transport blocks (e.g., N TBs), there are N fields in Information A, each conveying a size of a corresponding transport block. In one example, the UL-SCH payload size (or TB size) is not signaled in Information A. In one example, the UL-SCH payload size (or TB size) is determined from other parameters such reference resource used to determine the UL-SCH payload size (or TB size), as described herein, and/or UCI payload size and/or resource k and/or MCS and/or number of layers.
Modulation coding scheme (MCS) or code rate (CR). In one example, the UE determines and signals the MCS/CR in Information A, for example, there are M MCS/CR values, and the UE can indicate MCS/CR m out of the M MCS/CR values using a field in Information A, with size [log₂ M] bits. In one example, the MCS/CR is not signaled in Information A. In one example, the MCS/CR is signaled from the network (e.g., the network 130) (e.g., in an UL related DCI format scheduling the UL transmission, or is configured as part of semi-persistent UL transmission). In one example, MCS/CR is not signaled but determined from other parameters, such as resource k and/or UCI payload size and/or UL-SCH payload size and/or number of layers. In one example, the MCS/CR in Information A is for the UL-SCH or TB, and the CR for UCI is determined based on the beta offset and MCS/CR of the UL-SCH or TB. In one example, if there are multiples TB, each TB can have its own MCS/CR that is signaled in Information A. In one example, the UCI CR is signaled in Information A. In one example, there multiple UCI CRs signaled in Information A for multiple UCI Types.
Number of Layers or rank. In one example, the UE (e.g., the UE 116) determines and signals the number of layers in Information A, for example, there are N_{L} layers (or N_{L} possible rank values), and the UE can indicate number of layers n out of the N_{L} layers using a field in Information A, with size [log₂ N_{L}] bits. In one example, the number of layers is across all TBs. In one example, a number of layers is determined for each TB and is separately signaled in Information A. In one example, the number of layers (or rank) is not signaled in Information A. In one example, the number of layers (or rank) is signaled from the network (e.g., in an UL related DCI format scheduling the UL transmission, or is configured as part of semi-persistent UL transmission). In one example, number of layers (or rank) is not signaled but determined from other parameters, such as resource k and/or UCI payload size and/or UL-SCH payload size and/or MCS.

FIG. 38 illustrates an example method 3800 performed by a UE in a wireless communication system according to embodiments of the present disclosure. The method 3800 of FIG. 38 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 3800 is for illustration only and other embodiments can be used without departing from the scope of the present disclosure.

The method begins with the UE receiving first information for a list of UCI payload sizes and corresponding code points (3810). The UE then receives second information for a CG PUSCH (3820). The UE then receives third information for two DMRS sequences (3830). For example, in 3830, the CG PUSCH is based on a first DMRS sequence when there is no UCI multiplexed in the CG PUSCH and a second DMRS sequence when there is UCI multiplexed in the CG PUSCH. In various embodiments, the third information includes N resources for the CG PUSCH and the UE selects a resource from the N resources for the CG PUSCH based on the first UCI payload size.

The UE then determines, for the CG PUSCH, first UCI for transmission and a first UCI payload size and corresponding first code point (3840). The UE then transmits the CG PUSCH including a first DMRS based on the second DMRS sequence, information indicating the first code point, the first UCI, and a first transport block of an UL-SCH (3850). In various embodiments, the UE determines a payload size of the first transport block based on the first UCI payload size. In various embodiments, the first UCI includes a UCI header and the UCI header indicates one or more types of UCI reports and a size of each type of UCI report. In various embodiments, the first transport block includes N CBs, the N CBs are organized in to CBGs, and the CG PUSCH includes M1 CBGs, where M1<M. In some examples, the UE receives a DCI format that schedules retransmission of the CG PUSCH, the DCI format indicates M2 CBGs of the M CBGs that are not successfully received, and the UE transmits M3 of the M2 CBGs in a round-robin order across transmission and retransmissions of the CG PUSCH.

In various embodiments, the UE receives DCI that schedules a PUSCH with a second transport block and the PUSCH is based on a third DMRS sequence when there is no UCI multiplexed in the PUSCH and a fourth DMRS sequence when there is UCI multiplexed in the PUSCH. The UE further determines, for the PUSCH, a second UCI for transmission and a second UCI payload size and corresponding second code point and transmits the PUSCH including a second DMRS using the fourth DMRS sequence, information indicating the second code point, the second UCI, and the second transport block.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive first information for a list of uplink control information (UCI) payload sizes and corresponding code points,
receive second information for a configured grant (CG) physical uplink shared channel (PUSCH), and
receive third information for two demodulation reference signal (DMRS) sequences, wherein the CG PUSCH is based on:
a first DMRS sequence when there is no UCI multiplexed in the CG PUSCH, and
a second DMRS sequence when there is UCI multiplexed in the CG PUSCH; and
a processor operably coupled to the transceiver, the processor configured to determine, for the CG PUSCH:
first UCI for transmission, and
a first UCI payload size and corresponding first code point,
wherein the transceiver is further configured to transmit the CG PUSCH including:
a first DMRS based on the second DMRS sequence,
information indicating the first code point,
the first UCI, and
a first transport block of an uplink shared channel (UL-SCH).

2. The UE of claim 1, wherein:
the transceiver is further configured to receive downlink control information (DCI) that schedules a PUSCH with a second transport block,
the PUSCH is based on:
a third DMRS sequence when there is no UCI multiplexed in the PUSCH, and
a fourth DMRS sequence when there is UCI multiplexed in the PUSCH;
a processor is further configured to determine, for the PUSCH:
a second UCI for transmission, and
a second UCI payload size and corresponding second code point,
the transceiver is further configured to transmit the PUSCH including:
a second DMRS using the fourth DMRS sequence,
information indicating the second code point,
the second UCI, and
the second transport block.

3. The UE of claim 1, wherein the processor is configured to determine a payload size of the first transport block based on the first UCI payload size.

4. The UE of claim 1, wherein:
the first UCI includes a UCI header, and
the UCI header indicates (i) one or more types of UCI reports and (ii) a size of each type of UCI report.

5. The UE of claim 1, wherein:
the first transport block includes N code blocks (CBs),
the N CBs are organized in to M CB groups (CBGs), and
the CG PUSCH includes M1 CBGs, where M1<M.

6. The UE of claim 5, wherein:
the transceiver is further configured to receive a downlink control information (DCI) format that schedules retransmission of the CG PUSCH,
the DCI format indicates M2 CBGs of the M CBGs that are not successfully received, and
the transceiver is further configured to transmit M3 of the M2 CBGs in a round-robin order across transmission and retransmissions of the CG PUSCH.

7. The UE of claim 1, wherein:
the second information includes N resources for the CG PUSCH, and
the processor is further configured to select a resource from the N resources for the CG PUSCH based on the first UCI payload size.

8. A base station (BS), comprising:
a transceiver configured to:
transmit first information for a list of uplink control information (UCI) payload sizes and corresponding code points,
transmit second information for a configured grant (CG) physical uplink shared channel (PUSCH),
transmit third information for two demodulation reference signal (DMRS) sequences, wherein the CG PUSCH is based on:
a first DMRS sequence when there is no UCI multiplexed in the CG PUSCH, and
a second DMRS sequence when there is UCI multiplexed in the CG PUSCH, and
receive a CG PUSCH including:
a first DMRS based on the second DMRS sequence,
information indicating a first code point,
a first UCI, and
a first transport block of an uplink shared channel (UL-SCH); and
a processor operably coupled to the transceiver, the processor configured to, for the CG PUSCH:
determine a presence of the first UCI based on second DMRS sequence,
determine a first UCI payload size based on first code point, and
decode the first UCI based on the first UCI payload size.

9. The BS of claim 8, wherein:
the transceiver is further configured to:
transmit downlink control information (DCI) that schedules a PUSCH with a second transport block, wherein the PUSCH is based on:
a third DMRS sequence when there is no UCI multiplexed in the PUSCH, and
a fourth DMRS sequence when there is UCI multiplexed in the PUSCH; and
receive the PUSCH including:
a second DMRS using the fourth DMRS sequence,
information indicating a second code point,
a second UCI, and
a second transport block; and
the processor is further configured to, for the PUSCH:
determine a presence of the second UCI based on the fourth DMRS sequence,
determine a second UCI payload size based on the second code point, and
decode the second UCI based on the second UCI payload size.

10. The BS of claim 8, wherein the processor is configured to determine a payload size of the first transport block based on the first UCI payload size.

11. The BS of claim 8, wherein:
the first UCI includes a UCI header, and
the UCI header indicates (i) one or more types of UCI reports and (ii) a size of each type of UCI report.

12. The BS of claim 8, wherein:
the first transport block includes N code blocks (CBs),
the N CBs are organized in to M CB groups (CBGs), and
the CG PUSCH includes M1 CBGs, where M1<M.

13. The BS of claim 12, wherein:
the transceiver is further configured to transmit a downlink control information (DCI) format that schedules retransmission of the CG PUSCH,
the DCI format indicates M2 CBGs of the M CBGs that are not successfully received, and
the transceiver is further configured to receive M3 of the M2 CBGs in a round-robin order across transmission and retransmissions of the CG PUSCH.

14. A method of operating a user equipment (UE), the method comprising:
receiving first information for a list of uplink control information (UCI) payload sizes and corresponding code points;
receiving second information for a configured grant (CG) physical uplink shared channel (PUSCH);
receiving third information for two demodulation reference signal (DMRS) sequences, wherein the CG PUSCH is based on:
a first DMRS sequence when there is no UCI multiplexed in the CG PUSCH, and
a second DMRS sequence when there is UCI multiplexed in the CG PUSCH;
determining, for the CG PUSCH:
first UCI for transmission, and
a first UCI payload size and corresponding first code point; and
transmitting the CG PUSCH including:
a first DMRS based on the second DMRS sequence,
information indicating the first code point,
the first UCI, and
a first transport block of an uplink shared channel (UL-SCH).

15. The method of claim 14, further comprising:
receiving downlink control information (DCI) that schedules a PUSCH with a second transport block, wherein the PUSCH is based on:
a third DMRS sequence when there is no UCI multiplexed in the PUSCH, and
a fourth DMRS sequence when there is UCI multiplexed in the PUSCH;
determining, for the PUSCH:
a second UCI for transmission, and
a second UCI payload size and corresponding second code point; and
transmitting the PUSCH including:
a second DMRS using the fourth DMRS sequence,
information indicating the second code point,
the second UCI, and
the second transport block.

16. The method of claim 14, further comprising determining a payload size of the first transport block based on the first UCI payload size.

17. The method of claim 14, wherein:
the first UCI includes a UCI header, and
the UCI header indicates (i) one or more types of UCI reports and (ii) a size of each type of UCI report.

18. The method of claim 14, wherein:
the first transport block includes N code blocks (CBs),
the N CBs are organized in to M CB groups (CBGs), and
the CG PUSCH includes M1 CBGs, where M1<M.

19. The method of claim 18, further comprising:
receiving a downlink control information (DCI) format that schedules retransmission of the CG PUSCH, wherein the DCI format indicates M2 CBGs of the M CBGs that are not successfully received; and
transmitting M3 of the M2 CBGs in a round-robin order across transmission and retransmissions of the CG PUSCH.

20. The method of claim 14, wherein:
the second information includes N resources for the CG PUSCH, and
the method further comprises selecting a resource from the N resources for the CG PUSCH based on the first UCI payload size.
